(19) United States
(12) Patent Application Publication
(10) Pub. No.: US 2016/0188820 A1
(43) Pub. Date: Jun. 30, 2016

(54) METHOD, SYSTEM, AND APPARATUS FOR REAL TIME BENEFIT CHECK

(71) Applicant: Surescripts LLC, Arlington, VA (US)

(72) Inventors: Melissa M. Brown, Hastings, MN (US); Santosh N. Kalkar, Plymouth, MN (US); Shannon E. Olson, Edina, MN (US)

(21) Appl. No.: 14/986,064

(22) Filed: Dec. 31, 2015

Related U.S. Application Data
(60) Provisional application No. 62/098,869, filed on Dec. 31, 2014.

(51) Int. Cl. G06F 19/00

(52) U.S. Cl. CPC G06F 19/328

(57) ABSTRACT

Methods, systems, and apparatuses are described for real time benefit check (RTBC). Described method, system, and apparatus embodiments are provided to enable real-time request/response transactions initiated by a prescriber to a pharmacy benefits management (PBM). The described embodiments enable RTBC transactions that may be request/response transactions to provide the requester with formulary and coverage status and estimated patient cost for a patient and drug within a fulfillment method such as retail pharmacy, 90 day supply retail pharmacy, or mail order pharmacy.

### CROSS-REFERENCE TO RELATED APPLICATIONS

This application claims the benefit of U.S. Provisional Application No. 62/098,869, filed on Dec. 31, 2014, the entirety of which is incorporated by reference herein.

### BACKGROUND

1. Technical Field

The present subject matter relates to methods, systems, and apparatuses for real time benefit check (RTBC).

2. Background Art

Today's healthcare marketplace lacks methods, systems, and apparatuses for RTBC.

### BRIEF SUMMARY

Methods, systems, and apparatuses are described for real time benefit check (RTBC) which may also be referred to as patient medication benefit check (PMBC), substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a computer system that may be configured to perform techniques disclosed herein.

FIGS. 2A-2D show Transaction Processing Tables, according to an example embodiment.

FIGS. 3A-3D show PBM Certification Test Tables, according to an example embodiment.

FIG. 4 shows a Patient Information Table, according to an example embodiment.

FIGS. 5A-5J show Patient Test Tables, according to an example embodiment.

FIG. 6 shows a flowchart for RTBC, according to an example embodiment.

FIG. 7 shows a transaction flow diagram for RTBC, according to an example embodiment.

FIG. 8 shows a flowchart for RTBC, according to an example embodiment.

FIG. 9 shows a transaction flow diagram for RTBC, according to an example embodiment.

FIG. 10 shows a graphical user interface for RTBC, according to an example embodiment.

FIG. 11 shows a graphical user interface for RTBC, according to an example embodiment.

FIG. 12 shows a graphical user interface for RTBC, according to an example embodiment.

FIG. 13 shows a graphical user interface for RTBC, according to an example embodiment.

FIG. 14 is an error flow diagram for RTBC, according to an example embodiment.

FIG. 15 shows a graphical user interface for alternatives for RTBC, according to an example embodiment.

FIG. 16 shows a graphical user interface for alternatives for RTBC, according to an example embodiment.

FIG. 17 is an error flow diagram for RTBC, according to an example embodiment.

FIG. 18 is an error flow diagram for RTBC, according to an example embodiment.

Numerous additional figures are shown in the following pages.

Embodiments will now be described with reference to the accompanying drawings. In the drawings, like reference numbers indicate identical or functionally similar elements. Additionally, the left-most digit(s) of a reference number identifies the drawing in which the reference number first appears

### DETAILED DESCRIPTION

### Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, descriptive terms used herein such as “about,” “approximately,” and “substantially” have equivalent meanings and may be used interchangeably.

Still further yet, it should be noted that any drawings/figures are not drawn to scale unless otherwise noted herein.

Numerous embodiments are described in the detailed description and figures provided in the attachments and/or appendices following the Abstract page. It is noted that any section/subsection headings provided herein are not intended to be limiting and/or mutually exclusive. Embodiments are described throughout this document, and any type of embodiment may be included under any section/subsection. Furthermore, disclosed embodiments may be combined with each other in any manner.

### Example Embodiments

Embodiments are described herein for methods, systems, and apparatuses for real time benefit check (RTBC). That is, embodiments for methods, systems, and apparatuses are provided to enable real-time request/response transactions initiated by a prescriber to a pharmacy benefits management (PBM). Such embodiments may inform the prescriber of the benefits specific to a patient, based on drug, pharmacy and day supply combination, and may be tied to the act of prescribing, not a patient visit, and may be initiated based on a set of defined criteria (e.g., Non-Preferred and/or Refills greater than 0).

The described embodiments are valuable to the Prescriber, Pharmacy, PBM and Patient. For instance, embodiments may provide the PBM with the ability to share more nuanced, patient specific benefit information when non-preferred drugs are chosen, may provide the Retail and Mail Order Pharmacy with the opportunity to message 90 Day fill options based on the patients benefit along with accurate pricing information, and may allow the prescriber to find the most appropriate and cost-effective medication treatment options for patients based on their specific formulary and benefit coverage during the prescribing process.

The described embodiments enable Real Time Benefit Check (RTBC) transactions that may be request/response transactions to provide the requester with formulary and coverage status and estimated patient cost for a patient and drug within a fulfillment method (Retail Pharmacy, 90 Day Supply Retail Pharmacy, or Mail Order Pharmacy). The response may also contain alternative drugs with their associated formulary status.

An exemplary RTBC embodiment is described in Appendix A which follows the Abstract page.

Additional embodiments and embodiment features are provided in Appendix B through Appendix H.

The described embodiments may conform with The National Council for Prescription Drug Programs (NCPDP) (an American National Standards Institute accredited, standards development organization that promulgates standards for healthcare solutions).

The Real Time Benefit Check (RTBC) transaction is a request/response transaction that will provide the requester with formulary and coverage status and estimated patient cost for a patient and drug within a fulfillment method (Retail Pharmacy, 90 Day Supply Retail Pharmacy, or Mail Order Pharmacy). The response may also contain alternative drugs with their associated formulary status.

For this implementation, Surescripts assumes that the requester is a prescriber system vendor and the information source is a PBM.

Process Overview.

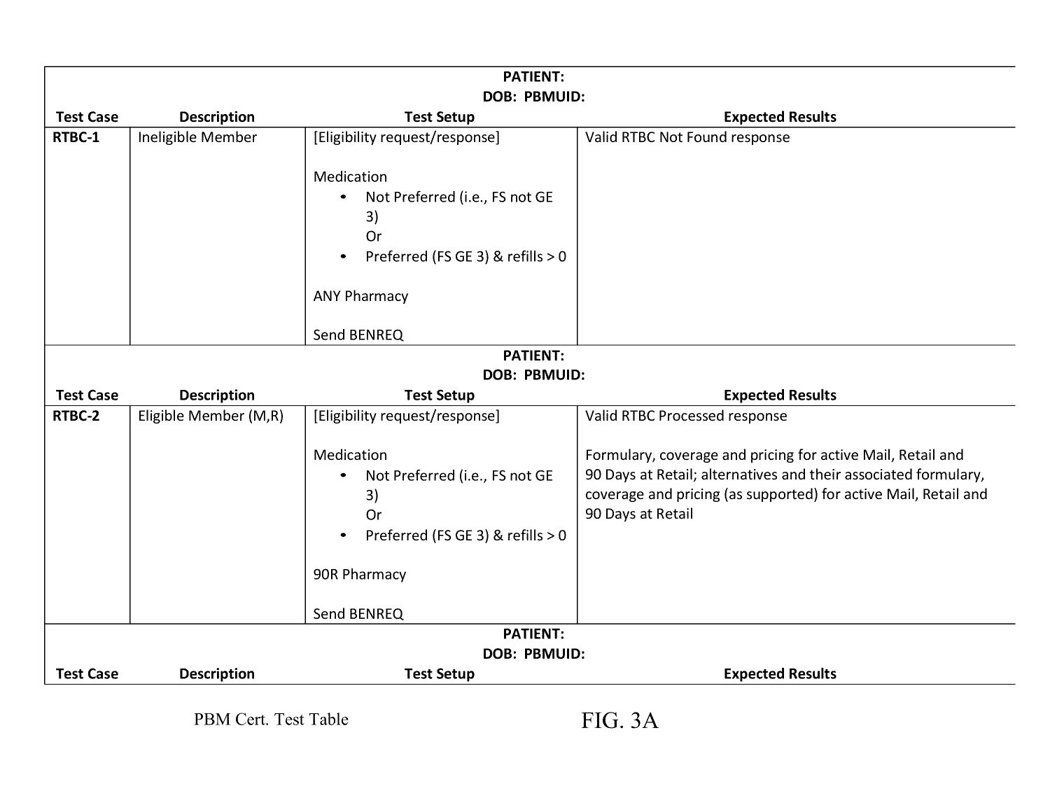

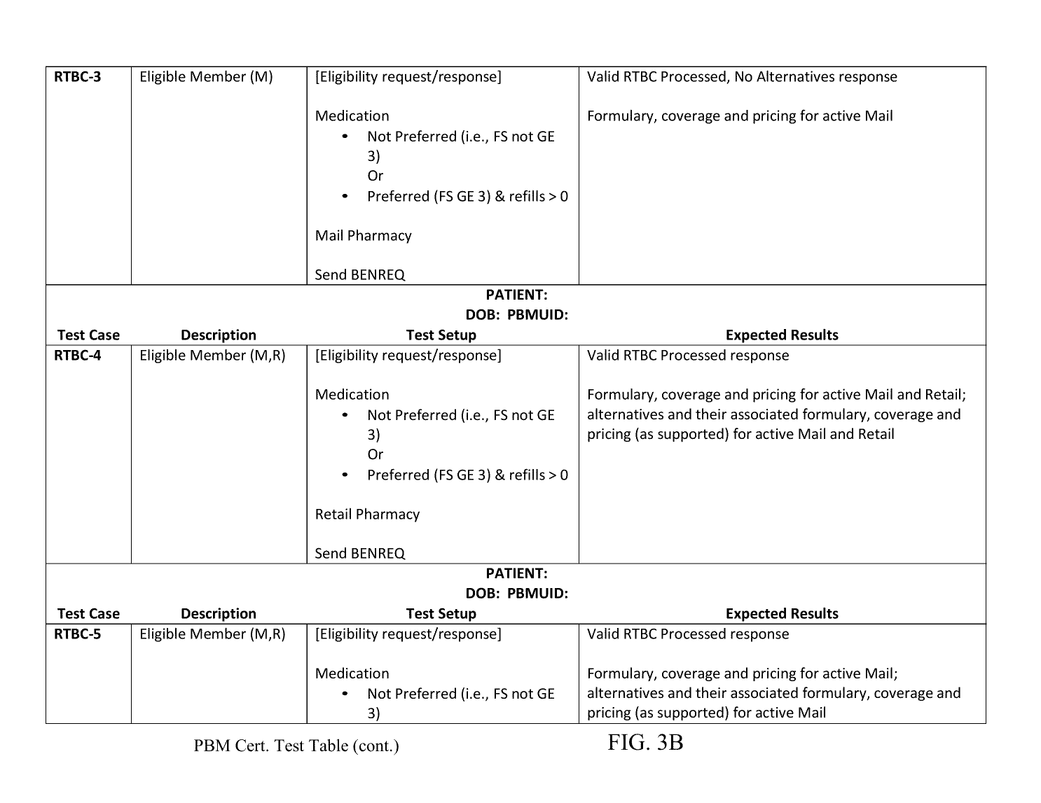

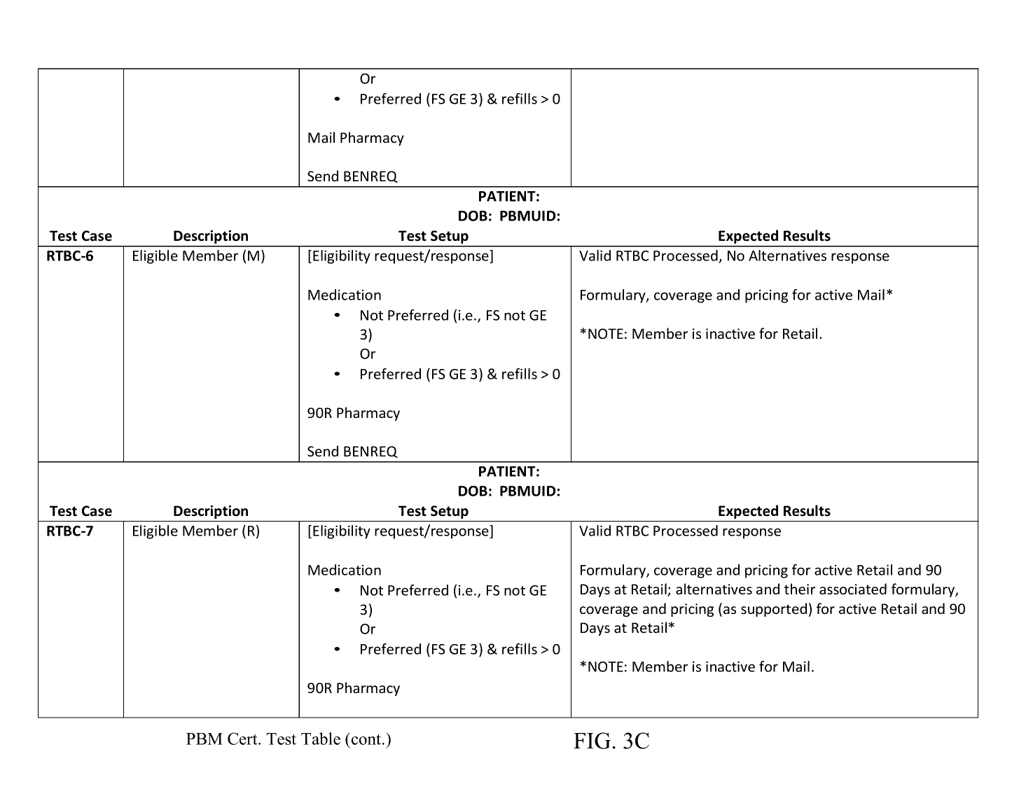

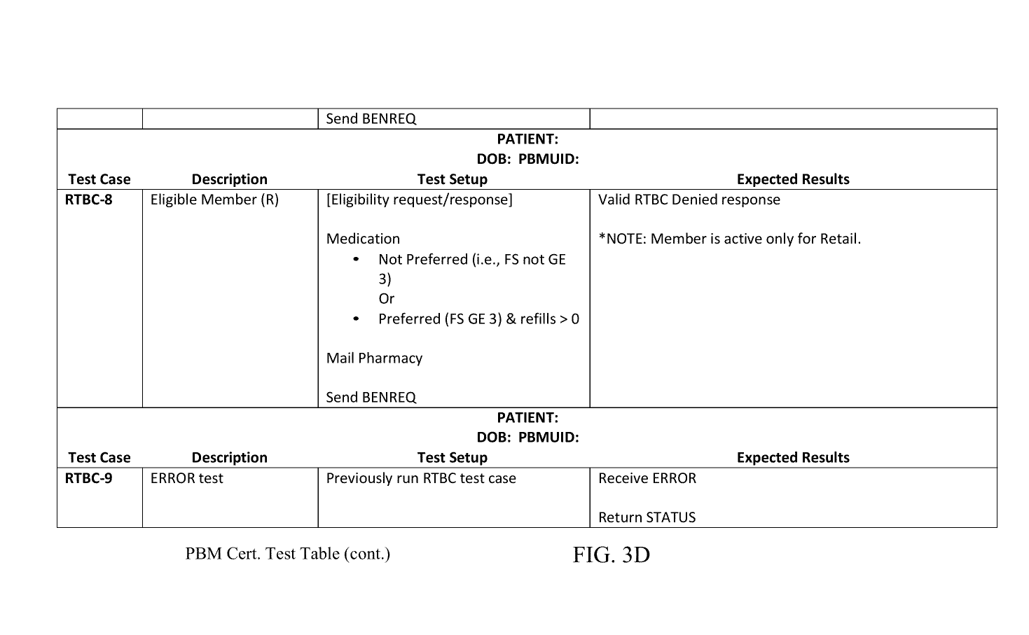

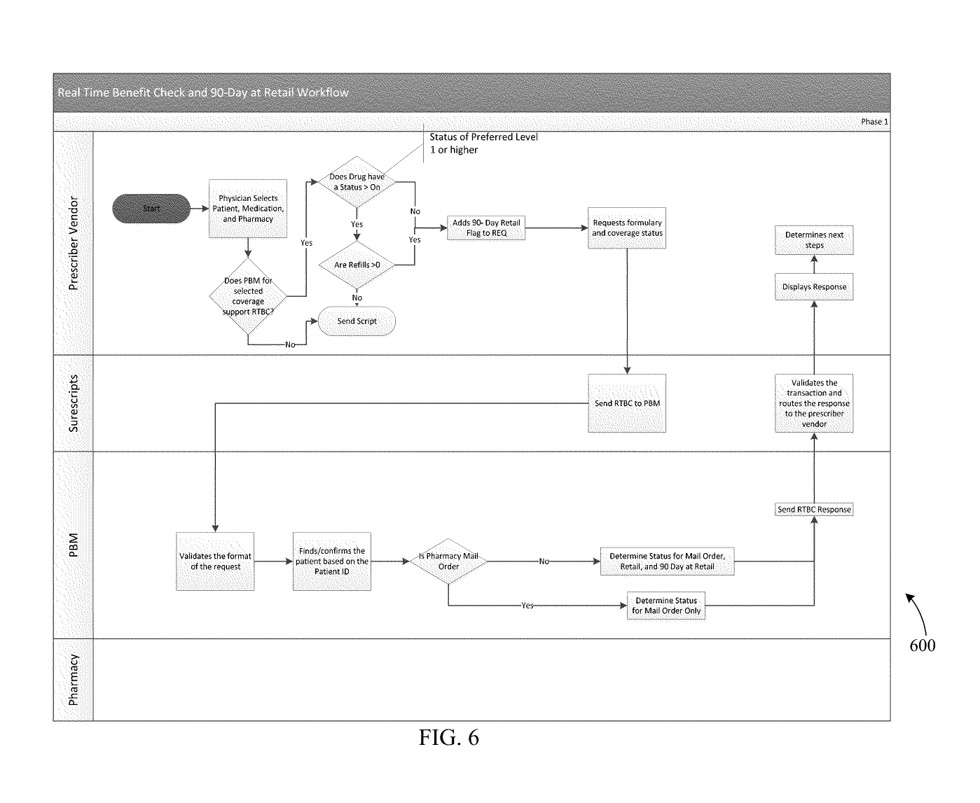

The RTBC is intended to assist the prescriber in the drug selection process, identifying a medication that is cost effective for the patient. The transaction fits into the prescriber workflow as described below. Note that certain steps are associated with Application Certification Requirements.
1) Surescripts registers participating PBMs with an RTBC use case in the Surescripts Directory indicating they have opted to participate in this message.
2) The prescribing vendor downloads the 4.6 Directory Organization list.
   a. The PBM is identified as RTBC in the Use Case field if they support RTBC (see FIG. 3 in the Directory Requirements section below).
   b. Note: This could be a manual lookup in Admin Console for Phase 1 if the vendor so chooses, to look up whether or not the PBM—is participating in RTBC. This manual process is the preferred method since there will be a small number of PBM's that support this product.
3) The prescriber system sends an eligibility request to Surescripts, ultimately getting to the patient's PBM, to obtain the PBM ID and the PBM unique member ID for the formulary and benefit lookup.
4) During the prescribing process, the prescriber is shown formulary and benefit information that was preloaded from the batch load process.
   a. This information assists the prescriber in directing them to medication options that may be cost effective with limited coverage factors. The data is generalized for this plan/group but may assist in narrowing down the appropriate choices.
5) The prescriber selects a medication, writes the script, and assigns a pharmacy.
6) The prescribing vendor determines that the patient's PBM participates in this transaction based on the information provided in the Directory Organization download.
7) An RTBC Request is generated based on the specified patient, pharmacy, and a drug identified in the request from the prescriber vendor. All required script information needs to be present in addition to the Days Supply. (Note: Days Supply is not required for Prescription Routing, but it is for RTBC.)
   a. The request is made if one of the following is true (refer to Appendix B below for further explanation when it is requested):
      i. Drug is Not Preferred.
      ii. Drug is Preferred, refills are greater than 0.
   b. The vendor sets the 90R flag in the RTBC request, indicating to the PBM that they need to return 90 day at retail information if it is available for that patient. In this release, this flag is set every time.
8) Surescripts processes the incoming RTBC Request.
9) PBM processes the request and sends back a response.
   a. The PBM validates the format of the request.
   b. The PBM finds/confirms the patient based on the requested data.
   c. (Optional) The PBM determines that the patient is still eligible. This step is optional because this transaction assumes that the eligibility transaction has been completed within the last 72 hours.
   d. PBM determines formulary status based off of the drug identifier given, the patient identifier, and the pharmacy provided.
   e. If the RTBC Request contains a retail pharmacy, the response must contain formulary information for Retail, Mail Order, and 90 Day at Retail
      i. The responder must return pricing for each coverage type returned if any pricing information is sent. Pricing information is calculated by the PBM and may not be the actual amount. The Vendor will display a disclaimer to that effect. All pricing information sent is subject to audit for completeness and accuracy. See Audit section for more details.
   f. If the RTBC Request contains only a Mail Order Pharmacy, the RTBC Response will only contain benefit information for that Mail Order Pharmacy.
      i. Refer to Appendix A for further explanation on what the PBM returns.
   g. The PBM may return alternatives with the associated formulary and coverage status included.
      i. The inclusion of alternatives is optional. If the PBM cannot return the information and still meet the SLA requirements, they may decide to limit the number of alternatives or not include them at all.
10) The Vendor must display the response to the prescriber, allowing them to make changes based on the response.
11) If the previously selected pharmacy, selected medication, or number of refills changes (to a number other than 0), a new RTBC request shall be generated. See flowchart 600 of FIG. 6.

Scenarios Table

| Successful | | | | Patient | | |
|---|---|---|---|---|---|---|
| Eligibility | Selected | | Refills | Has | | Coverage |
| with Active | Pharmacy | Drug Not | Allowed | 90-Day | RTBC | Information |
| Coverage(s)? | Type? | Preferred? | >0? | Benefit? | Run? | Returned |
| □ | Retail | □ | □ | □ | □ | Retail, 90-Day, Mail |
| □ | Retail | □ | □ | □ | □ | Retail, Mail |
| □ | Retail | □ | □ | □ | □ | Retail, 90-Day, Mail |
| □ | Retail | □ | □ | □ | □ | Retail, Mail |
| □ | Retail | □ | □ | □ | □ | Retail, 90-Day, Mail |
| □ | Retail | □ | □ | □ | □ | Retail, Mail |
| □ | Retail | □ | □ | □ | □ | N/A |
| □ | Retail | □ | □ | □ | □ | N/A |
| □ | Mail | □ | □ | N/A | □ | Mail Order |
| | Order | | | | | |
| □ | Mail | □ | □ | N/A | □ | Mail Order |
| | Order | | | | | |
| □ | Mail | □ | □ | N/A | □ | Mail Order |
| | Order | | | | | |
| □ | Mail | □ | □ | N/A | □ | N/A |
| | Order | | | | | |
| □ | Any | Any | Any | N/A | □ | N/A |

Directory Requirements.

This process requires that participants are aware of who can send/receive this. We need to convey:
1) Clinical Vendors that can SEND an RTBC Request
   a. For Phase 1, prescriber vendors are not required to register RTBC on the provider record. Permissions are driven by PMUI at the vendor level as opposed to at the Directory level in Admin Console.
2) PBMs that can receive an RTBC Request/Send Response
   a. For Phase 1, this information is conveyed via the 4.6 Organization download, which is the preferred method for prescriber vendors to obtain this information. This information could also be conveyed manually via Admin Console. Clinical vendors will need to track this per PBM to know WHEN to send an RTBC request.

Audit Process.

The RTBC response provides pricing information for different types of pharmacies. This information may be used to change a chosen pharmacy due to cost effectiveness for the patient. Due to the nature of this data, Surescripts will provide a process for auditing information that is sent on an RTBC response. This audit process will utilize the existing Surescripts support process. For this phase, this process will be:
1) A party makes a request for an ‘audit’ of a particular event. For instance, a pharmacy feels that a patient was misled regarding pricing at the prescriber office.
2) The party logs an audit request with Surescripts through a Salesforce support ticket.
3) The support ticket would need to contain the date of visit, prescriber NPI, patient name/DOB, and NDC of drug in question.
4) Support would query the data to pull the appropriate RTBC request/responses for that date/patient/prescriber.
5) The RTBC would be interrogated to determine what pricing was returned for the pharmacy in question.
   a. An RTBC transaction is linked to a NewRX through the Initiator Reference Identifier (aka RelatesToMessageID in XML). If desired, the resulting NewRX could also be pulled.
6) That information would be returned in the support ticket. Note: Support will utilize their current processes for reviewing the RTBC transactions.

Billing Process.

In many cases, the RTBC response is a billable transaction. The party receiving the benefit will be charged for the response. For Phase 1, we are implementing a simpler transaction-based approach.

Phase 1 focuses on what information is provided to the prescriber vendor for display.

Phase 2 will tie the actual RTBC Response to the NEWRX to determine if a destination pharmacy or prescribed drug changed due to the RTBC transaction

Billing Summary:

### For Phase 1:

1) If RTBC response exists, look at the transaction and see if patient has Mail Order Benefit. If so, PBM pays.
2) If RTBC response exists, look to see if patient has a 90 Day at Retail Benefit. If so, pharmacy pays.
3) If RTBC response exists, look to see if the response has an ALN segment. If it does, the PBM has provided alternatives. If so, PBM pays for this transaction.

### What is Needed:

1) Look inside the RTBC response.
2) Pull the FRM-010, FRM-020, PVD-020-01 (NCPDP ID), COO-010-01 (PBM ID)
   a. If it has FRM-010=M and FRM-020=CR or CV−Mail Order Pays
   b. If it has FRM-010=9 and FRM-020=CR or CV−Retail Pharmacy Pays
3) Pull the ALN segment. If it exists, count the transaction as a PBM provided alternatives transaction.

Reporting Needs.

For the purposes of invoicing, support and tracking, some reporting requirements have been identified.
1. Invoicing
   a. Report that counts all RTBC response transactions that have Mail Order Benefit indicated. Report is by Mail Order Pharmacy or PBM.

| Loop | Field | Description | Value |
|---|---|---|---|
| NA | COO-010-01 | Reference Number | PBM |
| | | | Participant ID |
| | COO-010-01 | Reference Qualifier | 2U |
| NA | COO-010-01 | Reference Number | Relates To |
| | | | Message ID |
| | COO-010-01 | Reference Qualifier | ZZ |
| Primary | FRM-010 | Pharmacy Type | M |
| Drug Loop | FRM-020 | Drug Status Code | CR or CV |
| Alternative | FRM-010 | Pharmacy Type | M |
| Drug Loop | FRM-020 | Drug Status Code | CR or CV |

b. Report that counts all RTBC response transactions that have a 90 Day at retail Benefit indicated. Report is by Pharmacy Chain.

| Loop | Field | Description | Value |
|---|---|---|---|
| NA | COO-010-01 | Reference Number | Relates To |
| | | | Message ID |
| | COO-010-01 | Reference Qualifier | ZZ |
| Pharmacy | PVD-010 | Provider Code | P2 |
| Segment | PVD-020-01 | Reference Number | NCPDP Id of |
| | | | Pharmacy |
| | PVD-020-01 | Reference Qualifier | D3 |
| Primary | FRM-010 | Pharmacy Type | 9 |
| Drug Loop | FRM-020 | Drug Status Code | CR or CV |
| Alternative | FRM-010 | Pharmacy Type | 9 |
| Drug Loop | FRM-020 | Drug Status Code | CR or CV |

c. Report that counts all RTBC response transactions that have PBM provided Alternative medications. Report is by PBM.

| Loop | Field | Description | Value |
|---|---|---|---|
| NA | COO-010-01 | Reference Number | PBM |
| | | | Participant ID |
| | COO-010-01 | Reference Qualifier | 2U |
| NA | COO-010-01 | Reference Number | Relates To |
| | | | Message ID |
| | COO-010-01 | Reference Qualifier | ZZ |
| Alternative | ALN-010-02 | Drug Description | Any |
| Drug Loop | ALN-010-03 | Item Number | NDC |

2. Adhoc
   a. Ability to handle audit requirements list in the ‘Audit Process’ section of this document.

Summary of Changes.

The RTBC transaction has previously been piloted at Surescripts. Based on pilot finding, a few changes have been identified that need to be implemented before this product is returned to production.
1) Transaction will be available in EDIFACT only and will be version BENCON 001001.
2) The Pharmacy segment is now required (BENREQ and BENRES).
3) The REQ segment will be used to indicate if the Retail Pharmacy supports 90 Day at Retail. (Always set in phase 1)
4) The PBM Patient Unique Member ID is now required in the COO-140 (BENREQ and BENRES)
5) The NDC is now required and must be 11 characters numeric (BENREQ and BENRES)
6) Added a Pharmacy type of 90 Day at Retail for the BENRES.
7) Days Supply is now required (BENREQ and BENRES).
8) The Pharmacy Directory has an RTBC use case that indicates if the retail pharmacy supports 90 Day at Retail.
9) Response segment added value of PNA in RES-010 (BENRES).
10) The REQ segment is required (BENREQ).
11) UIB-030-02 is required (BENREQ and BENRES).

RTBC Transaction

The Real Time Benefit Check (RTBC) transaction is a request/response transaction that will provide the requester with formulary and coverage status and estimated patient cost for a patient and drug within a fulfillment method (Retail Pharmacy, 90 Day Supply Retail Pharmacy, or Mail Order Pharmacy). The response may also contain alternative drugs with their associated formulary status.

For this implementation, Surescripts assumes that the requester is a prescriber system vendor and the information source is a PBM. Qualifying pharmacies that opt in for RTBC will support a true 90 Days at Retail product. This is a fill that will last the patient 90 days, not a fill for 30 days and 2 refills.

BENREQ

Real Time Benefit Check Request

This message is sent from the prescriber to the PBM to request real-time, patient-specific benefit information based on the selected pharmacy, drug, and days supply.

BENRES

Real Time Benefit Check Response

This message is sent from the PBM to the prescriber system in response to the request for benefit information and may include the formulary, pricing, and coverage information that is known for Mail Order Pharmacy, Retail Pharmacy, and/or 90 Days at Retail. The response may contain alternative drugs with the same information.

NCPDP ERROR

NCPDP STATUS

BENREQ & BENRES

Based on NCPDP BENCON 1.1 Standard

Directory 4.6

Will be used to convey information to prescribers about which pharmacy and PBM participants are participating in RTBC

Use Case=RTBC

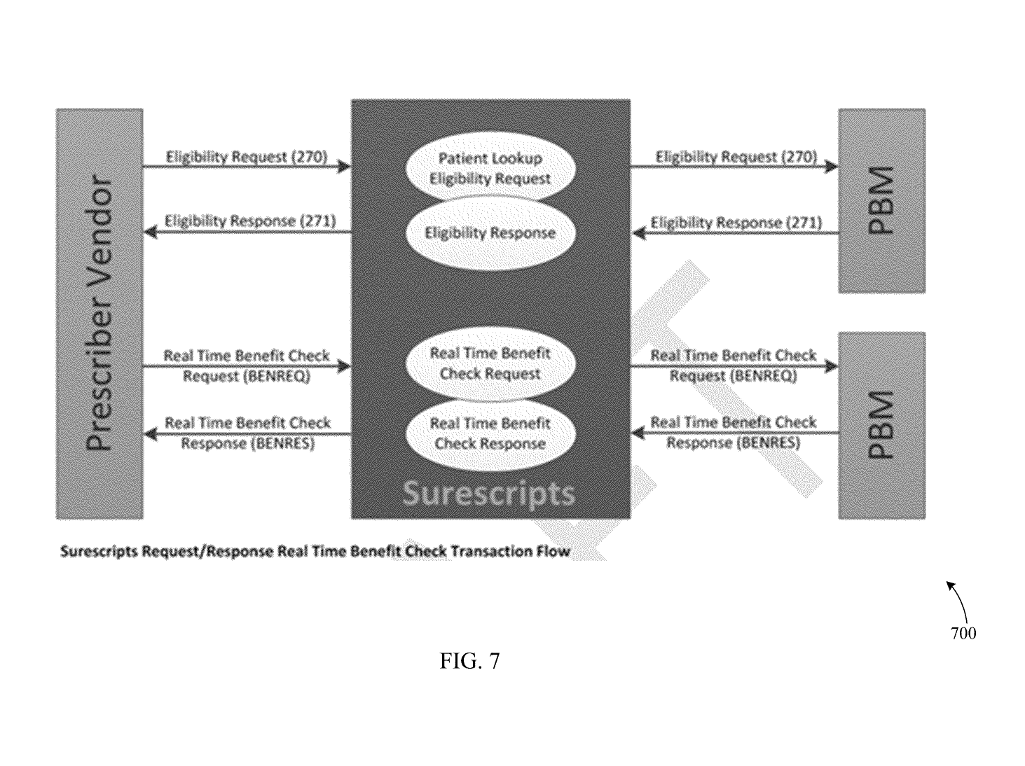

See diagram 700 of FIG. 7.

RTBC Request Process—BENREQ

Prescriber vendor identifies pharmacies and PBMs that participate in RTBC via Use Case in 4.6 Directory Organization download OR manually checking in Admin Console.

Eligibility request for patient is sent to Surescripts and a response is received from PBM.

Prescriber selects a medication, writes a script, selects a pharmacy (note days supply is required in this trx).

During the prescribing process, formulary and benefit info is displayed (from current WebDAV data).

Prescriber vendor determines if the patient's PBM returned in 271 participates in RTBC.

Prescriber vendor determines if the Pharmacy is a retail pharmacy that participates in 90 Day at retail, if so the 90R flag is sent in the BENREQ.

BENREQ is generated based on the specific patient, pharmacy and drug prescribed AND if one of the following is true: Medication is Not Preferred; Medication is Preferred, and refills are >0.

Surescripts processes the BENREQ and sends it to the appropriate PBM (by using the PBM Unique Member ID).

BENREQ Hierarchy Table

| | Segment | | Max | |
|---|---|---|---|---|
| Segment | Description | M/C | Repetitions | Description |
| UNA | Service String Advice | M | 1 | Must be present on all transactions in this |
| | | | | implementation usage. Is a fixed-length |
| | | | | segment |
| UIB | Interactive | M | 1 | Designates Requester and Responder IDs, |
| | Interchange Control | | | trace numbers, date, and time stamps at the |
| | Header | | | interchange level |
| UIH | Interactive Message | M | 1 | Designates the type of message. For RTBC |
| | Header | | | Request, message function = BENREQ. Also |
| | | | | indicates trace numbers at the message |
| | | | | level. |
| REQ | Request | M | 1 | Used to indicate if the chosen pharmacy |
| | | | | participates in 90 Days at Retail or not. |
| PVD | Provider Segment | M | 1 | One loop required for the prescriber. |
| | (Prescriber) | | | |
| PVD | Provider Segment | M | 1 | Pharmacy where the script is intended to be |
| | (Pharmacy) | | | filled. Request cannot be made until a |
| | | | | pharmacy is identified. |
| PTT | Patient Segment | M | 1 | Designates patient information. |
| COO | Coordination of | M | 1 | Benefit information required to help determine |
| | Benefits Segment | | | which formulary to check |
| DRU | Drug Segment | M | 1 | Used to indicate which drug benefit |
| | | | | information is being requested for. Only one |
| | | | | drug is allowed per request. |
| UIT | Interactive Message | M | 1 | Designates the message trace number and |
| | Trailer | | | number of segments in the message. |
| UIZ | Interactive | M | 1 | Designates the interchange trace number and |
| | Interchange Trailer | | | the number of messages in the transaction. |

BENREQ Example:

UNA:+./*′

UIB+UNOA:0++991+++POCID:ZZZ:PASSWORD+PBM123:ZZZ+20071001:081 322′

UIH+BENCON:001:001:BENREQ′

REQ+90R′

PVD+PC+123456789:HPI+++JONSON:TIM++++6518659191:TE′

PVD+P2+NCPDPID:D3+++++MCMOHR/'S CORNER PHARMACY+123

THIRD ST:ST PAUL:MN:55123+6518952323:TE′

PTT+1+19440605+JAMES:TINA+F+666886666:SY′

COO+123456789:ZZ+AMERICARE INSURANCE++MEMBERID+JAMES, TINA

+GROUPNUMBER++++++++PBM11356′

DRU+R:REGLAN 10 MG

### TABLETS:22123346763:ND::10:ME+EA:30:38+:TAKE 1 TABLET TWICE

### DAILY+ZDS:30:804′

UIT++8′

UIZ++1′

RTBC Request Process—BENRES.

PBM processes the BENREQ.

Validates format.

Finds patient and may re-check eligibility.

Determines formulary status based on drug identifier, patient identifier and pharmacy.

PBM generates BENRES.

If pharmacy sent supports 90 Day at Retail (90R flag sent), the response must contain benefit info for Retail, Mail Order and 90 Day at Retail.

If Mail Order Pharmacy sent, the response will contain formulary information for that Mail Order Pharmacy only.

If Retail pharmacy is sent without 90R flag OR does not support 90-Day at Retail, the response must contain benefit info for Retail and Mail Order only.

Alternatives are optional and may be sent in a response.

BENRES is sent to Surescripts, who validates and routes to the requestor.

Participant must display the response to the prescriber.

If changes are made to the selected pharmacy, medication or # refills changes to a number other than 0, a new BENREQ shall be generated.

BENRES Example:

UNA:+./*′

UIB+UNOA:0++123:991+++PBM123:ZZZ:PASSWORD+POCID:ZZZ+20071001:081342′

UIH+BENCON:001:001:BENRES′

RES+P′

PVD+PC+123456789:HPI+++JONSON:TIM++++6518659191:TE′

PVD+P2+NCPDPID:D3+++++MCMOHR/′S CORNER PHARMACY+123

### THIRD ST: ST PAUL:MN:55123+6518952323:TE′

PTT+1+19440605+JAMES:TINA+F+666886666:SY*PBM11356:2U′

COO+123456789:ZZ+AMERICARE INSURANCE++MEMBERID+JAMES, TINA

+GROUPNUMBER++++++++PBM11356′

DRU+R:REGLAN 10 MG

TABLETS:00031670163:ND::10:ME+EA:30:38+:TAKE 1 TABLET TWICE DAILY+ZDS:30:804′

FRM+R+CR+PA:PRIOR AUTH*QL:QUANTITY LIMITS+2++30:30′

FRM+M+CR+PA:PRIOR AUTH*QL:QUANTITY LIMITS+2++25:90′

FRM+9+CR+PA:PRIOR AUTH*QL:QUANTITY LIMITS+2++25:90′

ALN+:ALN DRUG NAME:12345678901:ND+ALN GENERIC NAME′

FRM+R+CV++3++25:30′

FRM+M+CV++3++20:90′

FRM+9+CV++3++20:90′

ALN+:ALN DRUG NAME2:34343678901:ND′

FRM+R+CR+PA:ASK THE DOCTOR+2++25:30′

FRM+M+CR+PA:ASK THE DOCTOR+2++20:90′

FRM+9+CR+PA:ASK THE DOCTOR+2++20:90′

UIT++19′

UIZ++1′

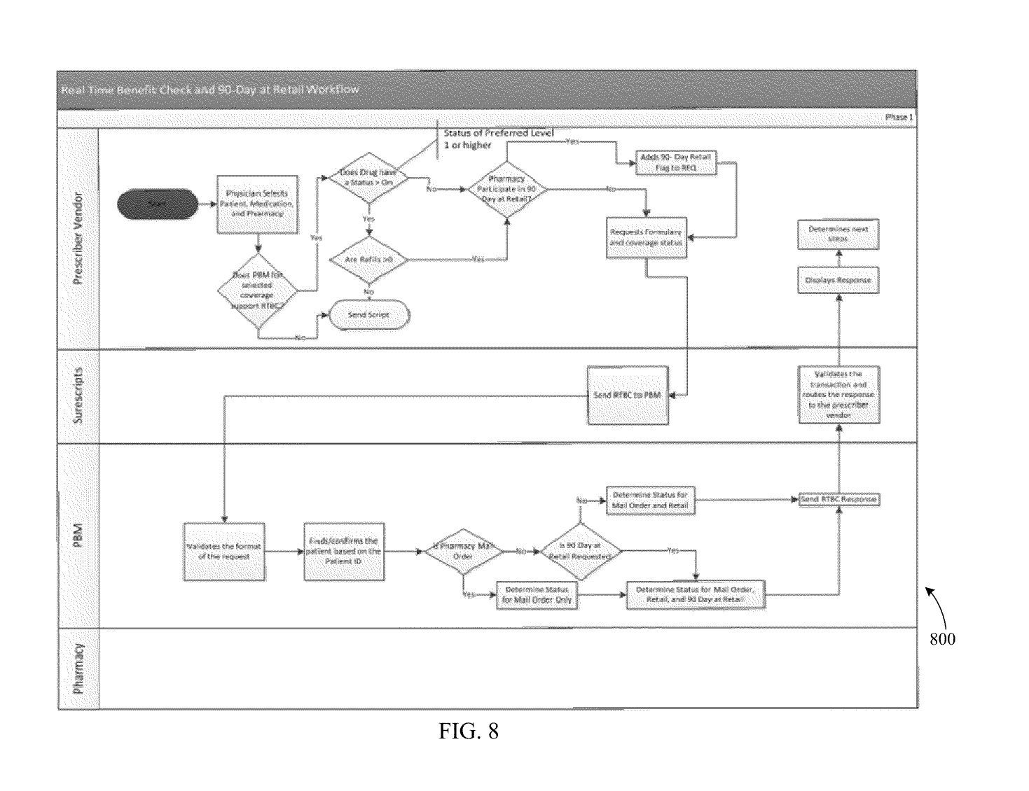

RTBC and 90-Day at Retail Process Flow: see flowchart 800 of FIG. 8.

RTBC Scenarios:

Scenarios Table

| | Selected | | | | Patient Has | Coverage |
|---|---|---|---|---|---|---|
| Successful Eligibility with | Pharmacy | Refills | Drug Not | | 90-Day | Information |
| Active Coverage(s)? | Type? | Allowed >0? | Preferred? | RTBC Run? | Benefit? | Returned |
| ✓ | Retail | ✓ | ✓ | ✓ | ✓ | Retail, 90-day, Mail |
| ✓ | Retail | ✓ | ✓ | ✓ | X | Retail, Mail |
| ✓ | Retail | ✓ | X | ✓ | ✓ | Retail, 90-Day, Mail |
| ✓ | Retail | ✓ | X | ✓ | X | Retail, Mail |
| ✓ | Retail | X | ✓ | ✓ | ✓ | Retail, 90-Day, Mail |
| ✓ | Retail | X | ✓ | ✓ | X | Retail, Mail |
| ✓ | Retail | X | X | X | N/A | N/A |
| ✓ | Mail Order | ✓ | ✓ | ✓ | N/A | Mail Order |
| ✓ | Mail Order | ✓ | ✓ | ✓ | N/A | Mail Order |
| ✓ | Mail Order | ✓ | X | X | N/A | Mail Order |
| ✓ | Mail Order | ✓ | X | X | N/A | Mail Order |
| ✓ | Mail Order | X | ✓ | ✓ | N/A | Mail Order |
| ✓ | Mail Order | X | ✓ | ✓ | N/A | Mail Order |
| ✓ | Mail Order | X | X | X | N/A | N/A |
| X | Any | Any | Any | X | N/A | N/A |

Directory Requirements

This process requires that participants are aware of who can send/receive the RTBC transaction AND what pharmacies are capable of administering a 90 Day supply. We need to convey:

Which Clinical Vendors can SEND a RTBC Request.

For Phase 1, this information does not need to be conveyed back out to participants.

It may only be a level that SS checks upon receiving a RTBC request.

Which PBMs can receive a RTBC Request/Send Response.

For Phase 1, this information could be conveyed manually due to the limited number of PBM participants. Clinical vendors will need to track this per PBM to know WHEN to send a RTBC request.

Which Pharmacies can fill a 90 Day supply of a Medication.

This needs to be tracked PER NCPCP ID for pharmacies. The Use Case will be set to RTBC for pharmacies that participate in 90 Day at Retail. This can be obtained via the pharmacy download.

Real Time Benefit Check

A real-time request/response transaction initiated by the prescriber to the PBM

Informs the prescriber of the benefits specific to a patient, based on drug, pharmacy and day supply combination.

Tied to the act of prescribing, not a patient visit and is initiated based on a set of defined criteria. (Non-Preferred and/or Refills greater than 0).

Valuable to the Prescriber, Pharmacy, PBM and Patient

Provides the PBM with the ability to share more nuanced, patient specific benefit information when non-preferred drugs are chosen.

Provides the Retail and Mail Order Pharmacy with the opportunity to message 90 Day fill options based on the patients benefit along with accurate pricing information.

Allows the prescriber to find the most appropriate and cost-effective medication treatment options for patients based on their specific formulary and benefit coverage during the prescribing process.

Current Formulary+Eligibility transactions and RTBC complement each other. Formulary batch files provide client level information while RTBC provides member specific details.

Why RTBC is Needed:

Our Observations:

Accuracy: As e-prescribing evolves and matures, patients and providers expect the information presented to be accurate, consistent and timely.

Consistency: Desire to communicate coverage and patient pay amount information consistently regardless of interface or technology (website, portals, e-prescribing and other tools).

Workflow: Receiving patient-specific benefit information must be integrated into the physicians workflow that is not disruptive to physician and provides a response in a timely manner.

While, also not putting undue processing or overhead onto the PBM.

Market Activity:

NCPDP:

ePA Task Group—Documents the need (long-term) for accurate patient specific real time coverage information to support a prospective ePA workflow.

Work Group 7 (Manufacturer Rebates) White paper (draft) calls for a need to communicate real-time patient specific formulary and coverage details within the eRx workflow.

When a prescriber selects a “non-preferred” drug and the RTBC transaction returns alternative therapy information.

If, based on the information provided by the RTBC transaction, prescriber changes the therapy to a preferred drug.

When a prescriber selects a maintenance drug with a 30 day fill at a retail pharmacy and the RTBC transaction returns 90 day at mail order benefit information.

If, based on the information provided by the RTBC transaction, prescriber changes the channel from 30 day at retail to 90 day at mail.

When a prescriber selects a maintenance drug with a 30 day fill at a retail pharmacy, and the RTBC transaction returns 90 day at retail benefit information.

If, based on the information provided by the RTBC transaction, prescriber changes the channel from 30 day at retail to 90 day at retail.

Thus in embodiments, a value-based model may be realized rather than a transactional model.

### Transaction Selection Examples

BENCON (EDIFACT) was selected.

Surescripts evaluated the various available transactions before deciding to use the RTBC Surescripts proprietary message (BENCON).

Other transactions that were evaluated:

X12 270/271.

NCPDP D1 TELECOMMUNICATIONS standard.

NCPDP SCRIPT-based standard.

Pro: Standard is already in use between participants.

Con: Limited drug specific information can be exchanged and no drug alternatives can be sent.

Transaction Selection D1:

Pro: “Pre-formatted” for a PBM claims engine to return results for single drug and channel

Con: Some fields can be populated or defaulted by the prescriber vendor or

Surescripts for the D1 request. But it could not be used “out of the box” because other fields are not available, such as these:

BIN, PCN (for PBM).

SOFTWARE VENDOR/CERTIFICATION ID.

IINSURANCE CARDHOLDER ID.

PRESCRIPTION/SERVICE REFERENCE NUMBER (Pharmacy's “Rx Number”).

FILL NUMBER (could be defaulted to first fill).

INGREDIENT COST SUBMITTED (and others as needed to account for Gross

Amount Due).

GROSS AMOUNT DUE.

Field level requirements for some fields such as Alternatives would require detailed conversations on usage, but workarounds and conventions for defaulting values could be agreed upon—Alternatives for.

Con: NCPDP Telecom Workgroup co-chairs confirmed very low utilization of this transaction.

Transaction Selection NCPCP SCRIPT-based:

PRO: Standard.

CON: Could not be used out of the box.

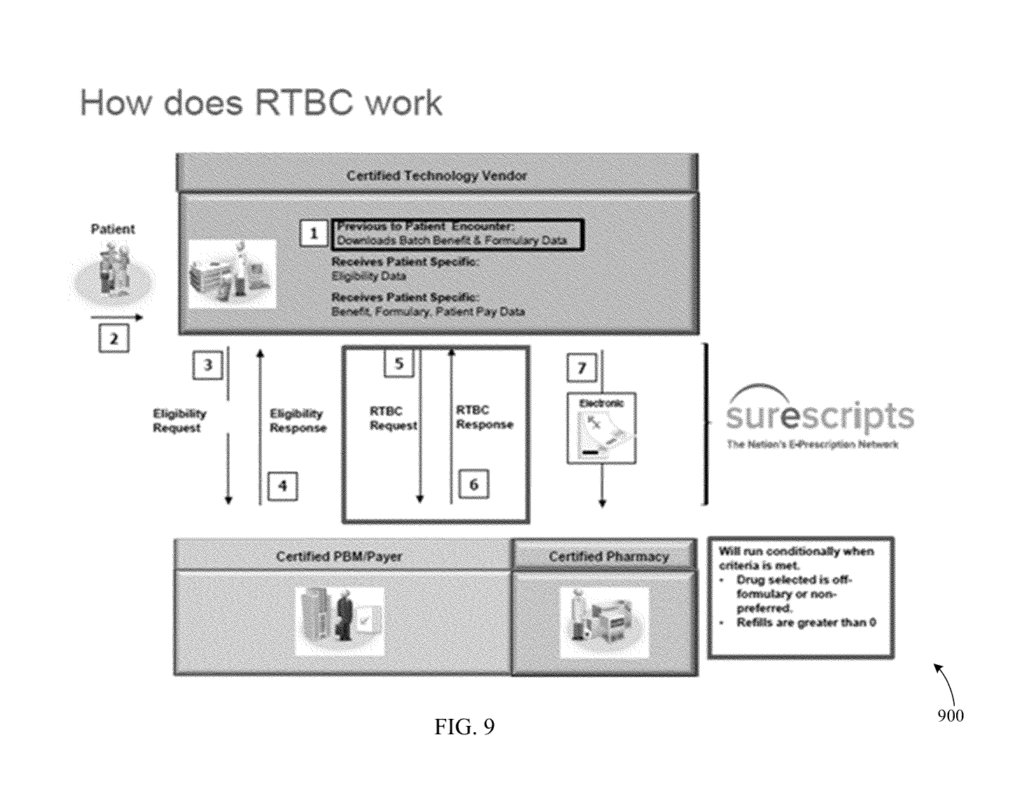

RTBC Workflow Diagram: see workflow diagram 900 of FIG. 9. See also FIG. 6.

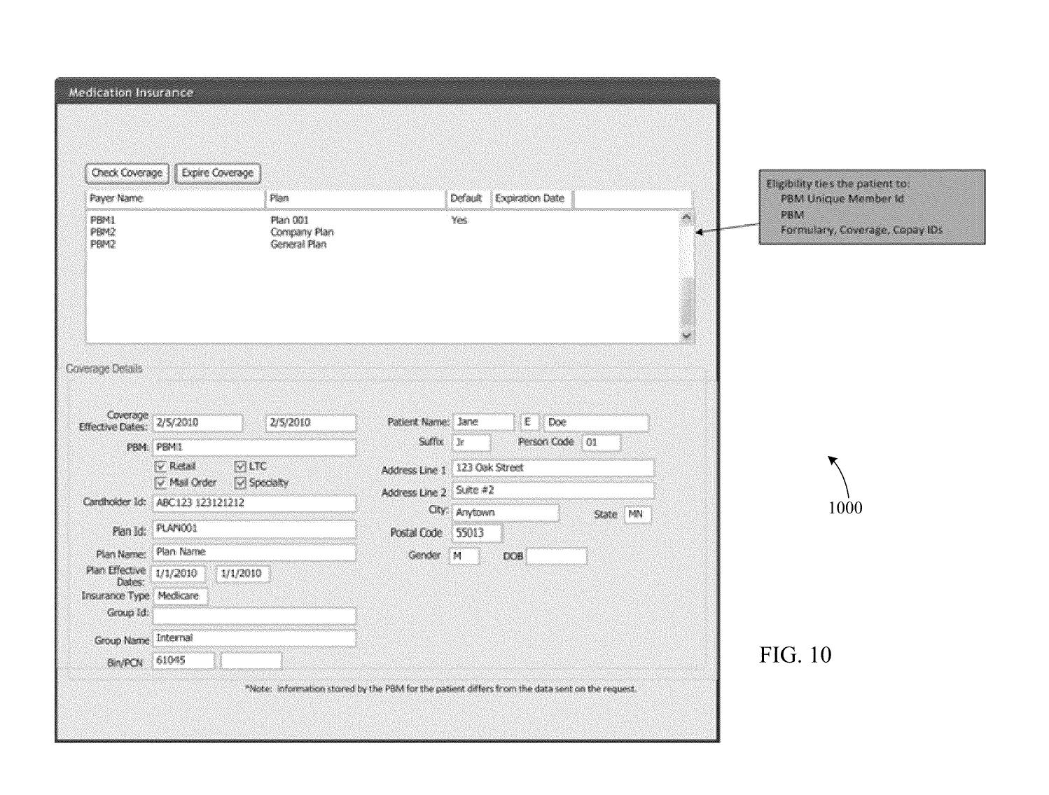

Mock up of Prescriber Vendor Application—Eligibility: See FIG. 10.

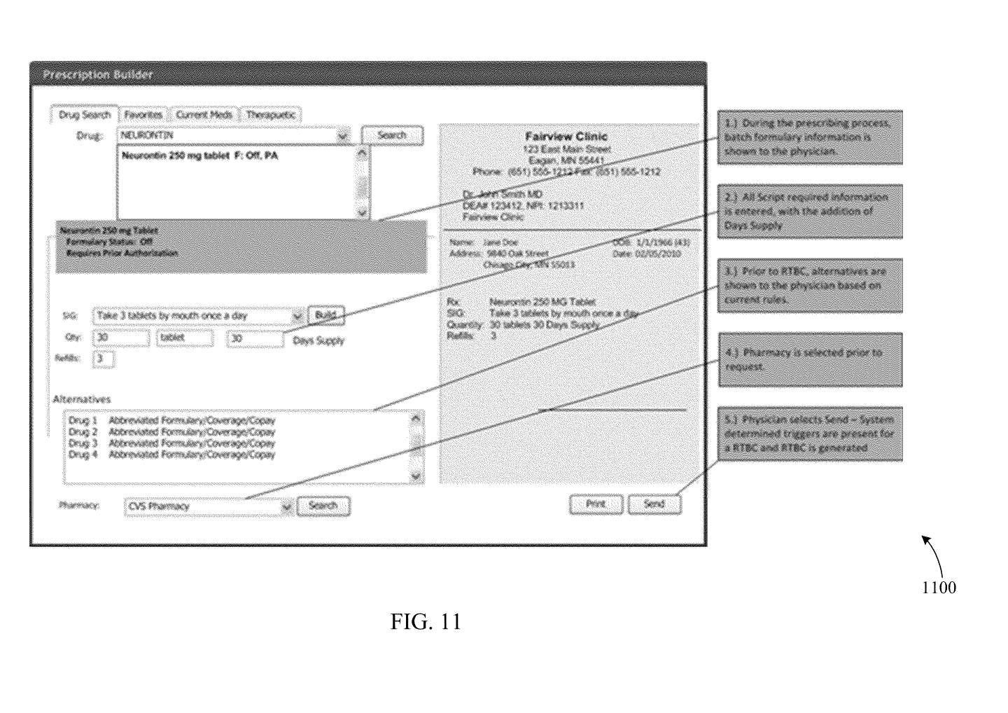

Mock up of Prescriber Vendor Application—NEWRX/RTBC: See FIG. 11.

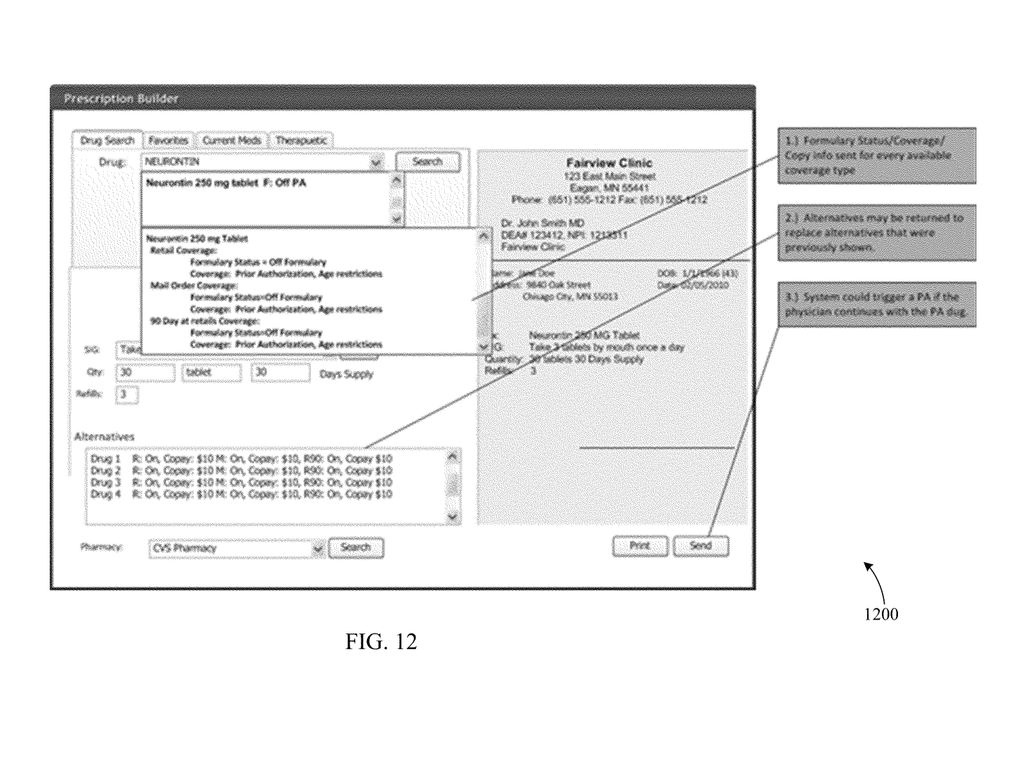

Mock up of Prescriber Vendor Application—RTBC results: see FIG. 12.

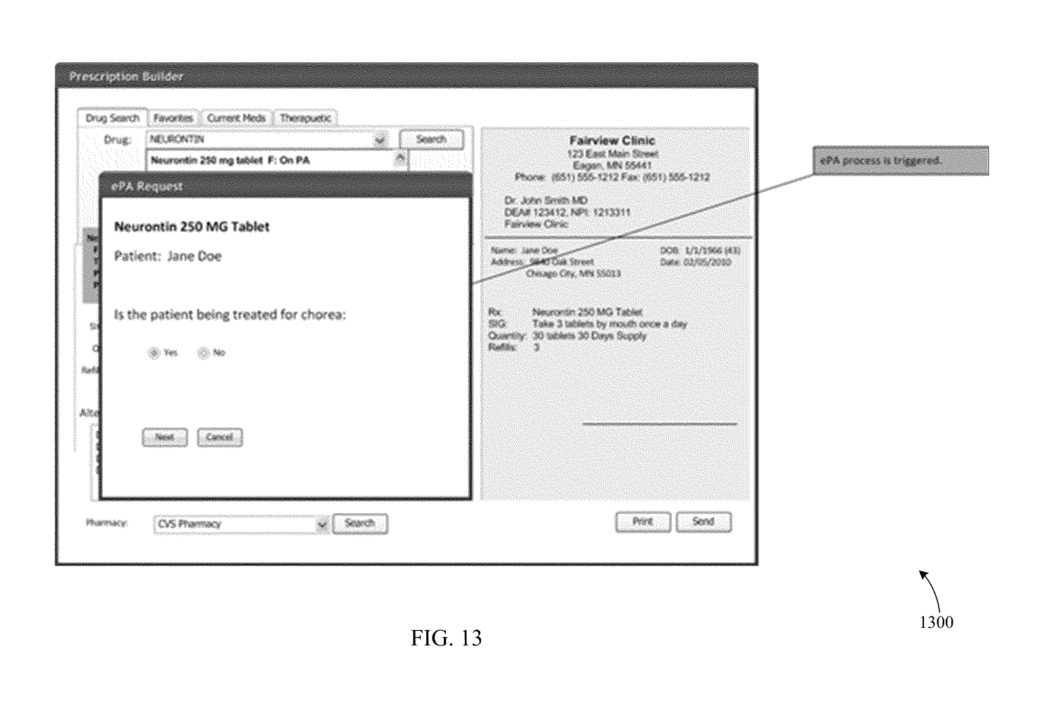

Mock up of Prescriber Vendor Application—ePA: see FIG. 13.

Application Certification Requirements

Applies to Prescriber Vendors

3.1 During the prescription writing process and prior to the summary screen, a Real

Time Benefit Check (RTBC) shall be requested when all the following criteria have been met:

An eligibility check has been successfully processed and returned an active coverage

The recipient PBM participant has a use case of “RTBC”

At least one of the following conditions are met:

The medication is not a preferred medication (i.e., Formulary Status 3 or greater) according to the pre-loaded formulary data.

The selected medication is preferred and the number of refills are greater than 0.

If the selected pharmacy supports 90 Days at Retail, then the request shall indicate in the REQ-010 field a value of “90R”.

When one or more of the following fields is modified after the initial RTBC response has been returned, and if the conditions in 3.1 still apply, an RTBC shall be requested again prior to the submission of a NEWRX: Drug Name/ID; Refills Allowed to a number greater than 0; Pharmacy.

The RTBC Request for a patient shall be tied to the most recent eligibility response for that patient by populating the ISA control number (ISA-13_{—} from the 271 Eligibility response in the COO-010-01 field on the RTBC Request).

Applies to PBMs

The responding participant shall return an RTBC response including formulary coverage information for each coverage type in accordance with the following conditions:

1. The responder shall include the formulary pricing, and coverage information that is known for the patient's active Mail Order Pharmacy, Retail Pharmacy, and 90 Days at Retail.

A. If the Request contains a Mail Order Pharmacy, then the responder shall return the formulary, coverage, and pricing information for the Mail Order Pharmacy only.

B. If the Request contains a Retail Pharmacy, and 90 Days at Retail is not requested, then the responder shall return the formulary coverage, and pricing information for Mail Order Pharmacy and Retail Pharmacy.

C. If the Request contains a retail Pharmacy, and 90 Days at Retail is requested, then the responder shall return the formulary, coverage, and pricing information for Mail Order Pharmacy, Retail Pharmacy, and 90 Days at Retail.

2. If the responder returns formulary, coverage, and pricing information for alternatives, it shall do so for all coverage types being requested.

Applies to Prescriber Vendors

The application shall make distinctions between all formulary statuses. (For example, Non Formulary, On Formulary/Preferred Level 1 and On Formulary/Preferred Level 3 must be distinctly identified).

During the prescription writing process and prior to the summary screen, the application shall display, without user action: formulary status, all coverage factors, and all copay factors for all pharmacy types provided for a drug at the drug name/strength/dosage form level.

These concessions are allowed:

1. An indicator that coverage factors apply. User action on this indicator presents all the coverage factors in their entirety

2. Abbreviated copay displayed. User action shall display all copay factors for all pharmacy types in their entirety. Note that copay must not be displayed for a drug that is not reimbursable (status zero). The abbreviated copay displays:

a. At least two pharmacy types in this precedence order: Any>Null>Retail>Mail Order>Specialty>LTC

b. Values and qualifiers to abbreviate all copay details. Examples include combinations of:

i. T1/3 (indicates Tier 1 of 3)

ii. $20+10% (indicates $ amount is first term, followed by %)

iii. 30D (indicates 30 days supply)

iv. “ . . . ” (indicates min/max copay amounts or more info available)

At a minimum, the application shall display the following, without user action:

a. All alternatives returned by the sender.

b. In the order supplied by the sender.

c. The application shall display formulary status and abbreviated copay data for all alternatives. Abbreviated copay data displayed shall be, at a minimum, the tier, flat amount or percent rate for each dispensing alternative (Mail, Retail, 90 Days at Retail).

Applies to Prescriber Vendors and to PBMS

Participants shall support the scenarios herein of the Real Time Benefit Check guide.

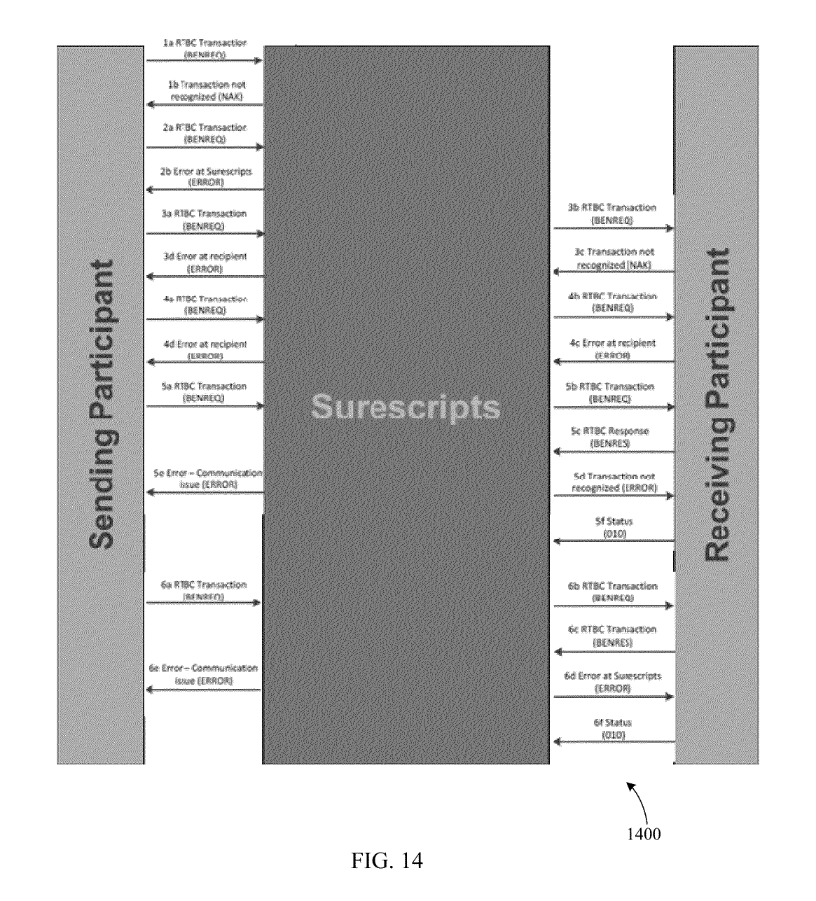

ACR. Error Transaction Workflow: see diagram 1400 of FIG. 14.

### 3.5 Error Transaction Workflow Table

BENREQ Transaction

Segment Notes: Request coming from a Physician System to PBM:

UIB Segment: 060-01 The Requester ID represents the Physician System. 070-01 The Responder ID represents the PBM.

UIH Segment: 010-04 Message Function has the value: BENREQ.

REQ segment: This segment is now required. Will be used to indicate whether the Pharmacy participates in 90 Day at Retail or not.

PVD segment (Pharmacy): This segment is now required. This will indicate the Pharmacy currently assigned is to the script.

BENREQ Segment Table

| | Segment | | Max | |
|---|---|---|---|---|
| Segment | Description | M/C | Repetitions | Description |
| UNA | Service String Advice | M | 1 | Must be present on all transactions in this |
| | | | | implementation usage. Is a fixed-length |
| | | | | segment. |
| UIB | Interactive | M | 1 | Designates Requester and Responder IDs, |
| | Interchange Control | | | trace numbers, date, and time stamps at the |
| | Header | | | interchange level. |
| UIH | Interactive Message | M | 1 | Designates the type of message. For RTBC |
| | Header | | | Request, message function = BENREQ. Also |
| | | | | indicates trace numbers at the message |
| | | | | level. |
| REQ | Request | M | 1 | Used to indicate if the chosen pharmacy |
| | | | | participates in 90 Days at Retail or not. |
| PVD | Provider Segment | M | 1 | One loop required for the prescriber. |
| | (Prescriber) | | | |
| PVD | Provider Segment | M | 1 | Pharmacy where the script is intended to be |
| | (Pharmacy) | | | filled. Request cannot be made until a |
| | | | | pharmacy is identified. |
| PTT | Patient Segment | M | 1 | Designates patient information. |
| COO | Coordination of | M | 1 | Benefit information required to help determine |
| | Benefits Segment | | | which formulary to check. |
| DRU | Drug Segment | M | 1 | Used to indicate which drug benefit |
| | | | | information is being requested for. Only one |
| | | | | drug is allowed per request. |
| UIT | Interactive Message | M | 1 | Designates the message trace number and |
| | Trailer | | | number of segments in the message. |
| UIZ | Interactive | M | 1 | Designates the interchange trace number and |
| | Interchange Trailer | | | the number of messages in the transaction. |

REQ—REQUEST SEGMENT (Required). The REQ Segment will indicate if the request includes a 90 Days of Retail request.

If the intended pharmacy participates in the 90 Day at Retail Program, the sender will put in 90R. The PBM will then determine the patients 90 Day at Retail coverage, along with the any other applicable coverage(s).

If NA is indicated, the PBM does not have to determine 90 Day at Retail Coverage.

REQ Segment Table

| | Element | | Data | |
|---|---|---|---|---|
| M/C | Number | Element Name | Type | Comments |
| M | REQ-000 | SEGMENT TAG | | |
| M | REQ-000-001 | Segment Code | an3 | Segment ID |
| | | | | Value: REQ |
| M | REQ-010 | Message Function, coded | an . . . 3 | Values: |
| | | | | 90R = 90 Days at Retail Requested |
| | | | | NA = No 90 Days at Retail |
| X | REQ-020 | Code List Qualifier | an . . . 3 | |
| X | REQ-030 | Reference Number | an . . . 35 | |
| X | REQ-040 | Sender Identification - Level 2 | an . . . 35 | |
| X | REQ-050 | Sender Identification - Level 2 | an . . . 35 | |

PVD—PRESCRIBER SEGMENT (Required). One Loop is REQUIRED for the Prescriber.

PVD Prescriber Segment Table

| | Element | | Data | |
|---|---|---|---|---|
| M/C | Number | Element Name | Type | Comments |
| M | PVD-000 | SEGMENT TAG | | |
| M | PVD-000-01 | Segment Code | an3 | Segment ID |
| | | | | Value: PVD |
| M | PVD-010 | PROVIDER CODE | an . . . 3 | Value: PC = Prescriber |
| M | PVD-020 | REFERENCE NUMBER | Repeats up to 3 times | |
| | | | M for BENREQ | |
| | | | C for BENRES | |
| | | | For the RTBC Request at least one occurrence | |
| | | | must contain the individual (not organizational) | |
| | | | NPI of the prescriber. | |
| | | | When present, the NPI will be validated against the | |
| | | | check digit routine for the requesting physician. | |
| | | | For specific information see | |
| | | | http://www.cms.gov/NationalProvidentStand/Downloads/NPIcheckdigit.pdf | |
| M | PVD-020-01 | Reference Number | an . . . 35 | Reference number of the prescriber. |
| M | PVD-020-02 | Reference Qualifier | an . . . 3 | Qualifier for reference number. A |
| | | | | complete list can be found in the NCPDP |
| | | | | External Code List (X12 DE 128). |
| X | PVD-030 | HEALTHCARE SERVICE LOCATION | | |
| C | PVD-040 | PROVIDER SPECIALTY | | |
| M | PVD-040-01 | Agency Qualifier, coded | an . . . 3 | Values: |
| | | | | AM = American Medical Association |
| | | | | DE = Drug Enforcement Agency |
| | | | | DR = National Wholesale Druggist |
| | | | | Association |
| | | | | HC = HCFA |
| M | PVD-040-02 | Provider Specialty, coded | an . . . 3 | If value of “AM” is used as the Agency |
| | | | | Qualifier, refer to NCPDP External Code |
| | | | | List (X12 DE 1222). |
| C | PVD-050 | NAME | Prescriber Name | |
| C | PVD-050-01 | Party Name | an . . . 35 | Last Name |
| C | PVD-050-02 | First Name | an . . . 35 | First Name |
| C | PVD-050-03 | Middle Name | an . . . 35 | Middle Name |
| C | PVD-050-04 | Suffix | an . . . 10 | Suffix |
| C | PVD-050-05 | Prefix | an . . . 10 | Prefix |
| X | PVD-060 | POSTCODE IDENTIFICATION | | |
| C | PVD-070 | PARTY NAME | an . . . 35 | Clinic Name |
| C | PVD-080 | ADDRESS | | |
| C | PVD-080-01 | Street and Number/PO Box | an . . . 35 | Address Line 1 |
| C | PVD-080-02 | City Name | an . . . 35 | |
| C | PVD-080-03 | State | an . . . 9 | |
| C | PVD-080-04 | Postal Code | an . . . 11 | |
| C | PVD-080-05 | Place/Location Qualifier | an . . . 3 | Agreement between trading partners |
| | | | | “AD2” should be used for address line 2. |
| C | PVD-080-06 | Place Location | an . . . 35 | Address Line 2 |
| C | PVD-090 | COMMUNICATION NUMBER | Repeats > 1 | |
| C | PVD-090-01 | Communication Number | an . . . 80 | |
| C | PVD-090-02 | Code List Qualifier | an . . . 3 | A complete list can be found in the |
| | | | | NCPDP External Code List (X12 DE |
| | | | | 365). |
| C | PVD-100 | NAME | This composite is used to identity the Designated | |
| | | | Agent - use for transmitters/submitter name (if | |
| | | | present, first name and last name are | |
| | | | recommended by Surescripts). | |
| C | PVD-100-01 | Party Name | an . . . 35 | Last Name |
| C | PVD-100-02 | First Name | an . . . 35 | First Name |
| C | PVD-100-03 | Middle Name | an . . . 35 | Middle Name |
| C | PVD-100-04 | Suffix | an . . . 10 | Suffix |
| C | PVD-100-05 | Prefix | an . . . 10 | Prefix |

PVD—PHARMACY SEGMENT (Required). One loop will be sent for the Pharmacy where the script is intended to be filled. One loop will be returned for the Pharmacy where the script is intended to be filled

PVD Pharmacy Segment Table

| | Element | | Data | |
|---|---|---|---|---|
| M/C | Number | Element Name | Type | Comments |
| M | PVD-000 | SEGMENT TAG | | |
| M | PVD-000-01 | Segment Code | an3 | Segment ID |
| | | | | Value: PVD |
| M | PVD-010 | PROVIDER CODE | an . . . 3 | Value: P2 = Pharmacy |
| M | PVD-020 | REFERENCE NUMBER | Repeats up to 3 times. | |
| M | PVD-020-01 | Reference Number | an . . . 35 | NCPDP Provider ID and or NPI. |
| M | PVD-020-02 | Reference Qualifier | an . . . 3 | D3 - Recommended by Surescripts |
| | | | | (NCPDP Provider, formerly known as |
| | | | | NABP) |
| | | | | Qualifier for reference number. A |
| | | | | complete list can be found in the NCPDP |
| | | | | External Code List (X12 DE 128). |
| X | PVD-030 | HEALTHCARE SERVICE LOCATION | | |
| X | PVD-040 | PROVIDER SPECIALTY | | Not used for Pharmacy segment. |
| C | PVD-050 | NAME | Pharmacist Name | |
| C | PVD-050-01 | Party Name | an . . . 35 | Last Name |
| C | PVD-050-02 | First Name | an . . . 35 | First Name |
| C | PVD-050-03 | Middle Name | an . . . 35 | Middle Name |
| C | PVD-050-04 | Suffix | an . . . 10 | Suffix |
| C | PVD-050-05 | Prefix | an . . . 10 | Prefix |
| X | PVD-060 | POSTCODE IDENTIFICATION | | |
| C | PVD-070 | PARTY NAME | an . . . 35 | Pharmacy Name |
| C | PVD-080 | ADDRESS | | |
| C | PVD-080-01 | Street and Number/PO Box | an . . . 35 | Address Line 1 |
| C | PVD-080-02 | City Name | an . . . 35 | |
| C | PVD-080-03 | State | an . . . 9 | |
| C | PVD-080-04 | Postal Code | an . . . 11 | |
| C | PVD-080-05 | Place/Location Qualifier | an . . . 3 | Agreement between trading partners |
| | | | | “AD2” should be used for address line 2. |
| C | PVD-080-06 | Place Location | an . . . 35 | Address Line 2 |
| C | PVD-090 | COMMUNICATION NUMBER | Repeats > 1 | |
| C | PVD-090-01 | Communication Number | an . . . 80 | |
| C | PVD-090-02 | Code List Qualifier | an . . . 3 | A complete list can be found in the |
| | | | | NCPDP External Code List (X12 DE |
| | | | | 365). |

| | | | |
|---|---|---|---|
| X | PVD-100 | NAME | Not used by NCPDP for Pharmacy segment |

PTT—PATIENT SEGMENT (Required). Designates Patient Information.

PTT Patient Segment Table

| | Element | | Data | |
|---|---|---|---|---|
| M/C | Number | Element Name | Type | Comments |
| M | PTT-000 | SEGMENT TAG | | |
| M | PTT-000-01 | Segment Code | a3 | Segment ID |
| | | | | Value: PTT |
| C | PTT-010 | RELATIONSHIP TO | an . . . 3 | Values: |
| | | CARDHOLDER | | 1 = Member |
| | | | | 2 = Spouse |
| | | | | 3 = Child/Dependent |
| | | | | 4 = Other |
| M | PTT-020 | DATE OF BIRTH | d8 | Birth date format is - CCYYMMDD. |
| M | PTT-030 | NAME | Patient Name | |
| M | PTT-030-01 | Party Name | an . . . 35 | Last Name |
| M | PTT-030-02 | First Name | an . . . 35 | First Name |
| C | PTT-030-03 | Middle Name | an . . . 35 | Middle Name |
| C | PTT-030-04 | Suffix | an . . . 10 | Suffix |
| C | PTT-030-05 | Prefix | an . . . 10 | Prefix |
| M | PTT-040 | GENDER | an . . . 3 | Values: |
| | | | | M = Male |
| | | | | F = Female |
| | | | | U = Unknown |
| C | PTT-050 | REFERENCE NUMBER | Repeats 2 | |
| M | PTT-050-01 | Reference Number | an . . . 35 | Patient ID |
| C | PTT-050-02 | Reference Qualifier | an . . . 3 | A complete list can be found in the |
| | | | | NCPDP External Code List (X12 DE |
| | | | | 128) |
| C | PTT-060 | ADDRESS | | Postal Code and City Code |
| | | | | recommended by Surescripts |
| C | PTT-060-01 | Street and Number/PO Box | an . . . 35 | Address Line 1 |
| C | PTT-060-02 | City Name | an . . . 35 | |
| C | PTT-060-03 | State | an . . . 9 | Recommend by Surescripts - Used |
| | | | | for sales tax |
| C | PTT-060-04 | Postal Code | an . . . 11 | Recommend by Surescripts - Used |
| | | | | for sales tax |
| C | PTT-060-05 | Place/Location Qualifier | an . . . 3 | Trading partner defined value |
| | | | | “AD2” should be used for address line 2 |
| C | PTT-060-06 | Place Location | an . . . 35 | Address Line 2 |
| C | PTT-070 | COMMUNICATION NUMBER | Repeats > 1 | |
| C | PTT-070-01 | Communication Number | an . . . 80 | Patient telephone number |
| C | PTT-070-02 | Code List Qualifier | an . . . 3 | A complete list can be found in the |
| | | | | NCPDP External Code List (X12 DE |
| | | | | 128). |

COO—COORDINATION OF BENEFITS SEGMENT (Required). Designates the Patients Prescription Coverage. Sender will place the value of the ISA13 field found in the 270 Eligibility Request in this field, tying the Eligibility to the RTBC transaction (BENREQ or BENRES). The PBM Unique Member ID is REQUIRED by Surescripts.

COO Coordination Segment Table

| | Element | | Data | |
|---|---|---|---|---|
| M/C | Number | Element Name | Type | Comments |
| M | COO-000 | SEGMENT TAG | | |
| M | COO-000-01 | Segment Code | a3 | Segment ID |
| | | | | Value: COO |
| C | COO-010 | REFERENCE NUMBER | | |
| M | COO-010-01 | Reference Number | an . . . 35 | ISA13 value from the most recent 271 |
| | | | | eligibility response for the patient |
| C | COO-010-02 | Reference Qualifier | an . . . 3 | Qualifier identifying the Reference |
| | | | | Number. |
| | | | | Value: |
| | | | | ZZ = Specify Mutually Defined when |
| | | | | identifying the ISA13 value. |
| C | COO-020 | PARTY NAME | an . . . 35 | Payer Name |
| X | COO-030 | SERVICE TYPE CODE | | |
| C | COO-040 | REFERENCE NUMBER | | |
| M | COO-040-01 | Reference Number | an . . . 35 | Cardholder ID |
| X | COO-040-02 | Reference Qualifier | an . . . 3 | |
| C | COO-050 | NAME | an . . . 35 | Cardholder Name (Last Name, First |
| | | | | Name) |
| C | COO-060 | REFERENCE NUMBER | an . . . 35 | Group Number/Carrier |
| X | COO-070 | PARTY NAME | an . . . 35 | Group Name |
| X | COO-080 | ADDRESS | | |
| X | COO-090 | DATE | | |
| X | COO-100 | INSURANCE TYPE, CODED | | |
| X | COO-110 | ADDRESS | | |
| X | COO-120 | REFERENCE NUMBER | | |
| X | COO-130 | CONDITION/RESPONSE | an . . . 3 | Patient Consent Indicator |
| | | CODED | | |
| M | COO-140 | PATIENT IDENTIFIER | an . . . 80 | PBM unique member ID |
| | | | | (Required by Surescripts) |

DRU—DRUG SEGMENT (Required). Only ONE Drug allowed per Request, in embodiments. NDC11 MUST be sent in the DRU segment, in embodiments. At least one ZDS for Days Supply must be present, in embodiments.

DRU Drug Segment Table

| | Element | | Data | |
|---|---|---|---|---|
| M/C | Number | Element Name | Type | Comments |
| M | DRU-000 | SEGMENT TAG | | |
| M | DRU-000-01 | Segment Code | a3 | Segment ID |
| | | | | Value: DRU |
| M | DRU-010 | DRUG | | |
| M | DRU-010-01 | Item Description identification | an . . . 7 | Value: |
| | | | | R = Requested |
| M | DRU-010-02 | Item Description | an . . . 35 | Drug Name. |
| | | | | The self-contained full drug name, |
| | | | | strength, and form. |
| | | | | May be abbreviated to fit the |
| | | | | information in 35 or less bytes. |
| M | DRU-010-03 | Item Number | an . . . 35 | Drug number (11 Digit Representative |
| | | | | NDC) |
| M | DRU-010-04 | Code List Responsibility Agency | an . . . 3 | Value: |
| | | | | ND = NDC11 |
| C | DRU-010-05 | Code List Qualifier | an . . . 3 | Drug Form. |
| | | | | A complete list can be found in the |
| | | | | NCPDP External Code List (X12 DE |
| | | | | 1330). |
| C | DRU-010-06 | Free Text | an . . . 70 | Drug Strength - Measurement Value |
| C | DRU-010-07 | Code List Qualifier | an . . . 3 | Unit or Basis for Measurement Code. |
| | | | | A complete list can be found in the |
| | | | | NCPDP External Code List (X12 DE |
| | | | | 355). |
| C | DRU-010-08 | Reference Number | an . . . 35 | Drug Database Code |
| C | DRU-010-09 | Reference Qualifier | an . . . 3 | Code value to define the reference |
| | | | | number. |
| | | | | Values: |
| | | | | E = Medical Economic GFC |
| | | | | G = Medical Economic GM |
| | | | | FG = First DataBank GCN Seq # |
| | | | | FS = First DataBank SmartKey |
| | | | | MC = Multum Drug ID |
| | | | | MD = Medi-Span DDID |
| | | | | MG = Medi-Span GPI |
| | | | | MM = Multum MMDC |
| C | DRU-010-10 | Item Description | an . . . 35 | Drug name |
| | | | | If the full drug name, strength, form |
| | | | | does not fit in 010-12 are to be |
| | | | | used for the full name, strength, form. |
| C | DRU-010-11 | Item Description | an . . . 35 | Drug name |
| C | DRU-010-12 | Item Description | an . . . 35 | Drug name |
| M | DRU-020 | QUANTITY | | |
| M | DRU-020-01 | Quantity Qualifier | an . . . 3 | Unit or Basis for Measurement Code. A |
| | | | | complete list can be found in the |
| | | | | NCPDP External Code List (X12 DE |
| | | | | 355). |
| M | DRU-020-02 | Quantity | an . . . 35 | |
| M | DRU-020-03 | Code List Qualifier | an . . . 3 | Value: |
| | | | | 38 = Original Qty |
| C | DRU-030 | DIRECTIONS | | |
| X | DRU-030-01 | Dosage ID | | Future use. Has not be codified yet. |
| C | DRU-030-02 | Dosage | an . . . 70 | SIG instructions. Dosage - Free Text |
| C | DRU-030-03 | Dosage | an . . . 70 | SIG instructions. Dosage - Free Text |
| C | DRU-040 | DATE | Repeats up to 5 times. | |
| M | DRU-040-01 | Date/time period qualifier | an . . . 3 | Qualification of Date/Time field 2380 |
| | | | | X-12 DE 432. |
| | | | | 85 = Date issued (Written Date) |
| | | | | 07 = Effective Date (Begin) |
| | | | | 36 = Expiration Date (End) |
| | | | | PE = Period End |
| | | | | LD = Last Demand (Last Fill) |
| | | | | ZDS = Days Supply (At least one |
| | | | | occurrence must be Days |
| | | | | Supply) |
| | | | | 35 = Delivered on This Date (Date |
| | | | | prescription received at facility) |
| | | | | BE = Validated (Date reviewed at |
| | | | | facility) |
| M | DRU-040-02 | Date or Quantity | an . . . 35 | Required if DRU-040-01 provided |
| M | DRU-040-03 | Date/Time Period format | an . . . 3 | Defines the date format used. |
| | | qualifier | | UN/EDIFACT element |
| | | | | Values: |
| | | | | 102 = Date CCYYMMDD |
| | | | | 203 = Date CCYYMMDDHHMM |
| | | | | 804 = Quantity of Days |
| C | DRU-050 | PRODUCT/SERVICE | an . . . 3 | Values: |
| | | SUBSTITUTION. CODED | | 0 = No product selection indicated |
| | | | | 1 = Substitution not allowed by |
| | | | | prescriber |
| | | | | 2 = Substitution allowed - patient |
| | | | | requested product dispensed |
| | | | | 3 = Substitution allowed - pharmacist |
| | | | | selected product dispensed |
| | | | | 4 = Substitution allowed - generic drug |
| | | | | not in stock |
| | | | | 5 = Substitution allowed - brand drug |
| | | | | dispensed as a generic |
| | | | | 7 = Substitution not allowed - brand |
| | | | | drug mandated by law |
| | | | | 8 = Substitution allowed - generic drug |
| | | | | not available in marketplace |
| | | | | (6 and (intentionally left off) |
| X | DRU-060 | QUANTITY | Repeats twice. | |
| C | DRU-070 | DIAGNOSIS | Repeats up to two times. | |
| M | DRU-070-01 | Clinical Information Qualifier | an . . . 3 | Values: |
| | | | | 1 = Prescriber |
| | | | | 2 = Pharmacy inferred |
| M | DRU-070-02 | Clinical Information - Primary | an . . . 17 | The prescriber supplied or pharmacy |
| | | | | inferred code for the diagnosis. |
| C | DRU-070-03 | Code List Qualifier | an . . . 3 | Qualifies the code list used for the |
| | | | | Diagnosis. |
| | | | | Values: |
| | | | | M = Medi-Span |
| | | | | F = First DataBank |
| | | | | E = Medical Economics |
| | | | | DX = ICD9 |
| | | | | ABF = ICD10 |
| C | DRU-070-04 | Clinical Information - Secondary | an . . . 17 | Diagnosis Code |
| C | DRU-070-05 | Code List Qualifier | an . . . 3 | Values: |
| | | | | DX = ICD9 |
| | | | | ABF = ICD10 |
| C | DRU-080 | REFERENCE NUMBER | | |
| M | DRU-080-01 | Reference Number | an . . . 35 | This number is used to store the |
| | | | | Prescription Number of the prescribing |
| | | | | system. |
| C | DRU-080-02 | Reference Qualifier | an . . . 3 | A complete list can be found in the |
| | | | | NCPDP External Code List (X12 DE |
| | | | | 128). |
| C | DRU-090 | FREE TEXT | an . . . 70 | Repeats up to 3 times. |
| | | | | Comment to Pharmacist. |
| C | DRU-100 | DRUG USE EVALUATION | Repeat up to 5 times. Conditional repeating | |
| | | | composite for further explanation, conflict, or | |
| | | | clarification of services related to drug use | |
| | | | evaluation. | |
| C | DRU-100-01 | DUE Reason for Service Code | an . . . 2 | Code identifying the type of conflict |
| | | | | detected. |
| | | | | When this composite is used, DUE |
| | | | | Reason For Service code is |
| | | | | mandatory. |
| | | | | When the DUE Reason For Service |
| | | | | Code is sent form the prescriber to the |
| | | | | pharmacist, the DUE Result Of |
| | | | | ServiceCode is mandatory. |
| | | | | When the DUE Reason For Service |
| | | | | Code is sent from the pharmacist to the |
| | | | | prescriber, the DUE Result Of Service |
| | | | | code is conditional. |
| | | | | This field uses the appropriate values |
| | | | | for the Reason For Service Code in |
| | | | | NCPDP |
| | | | | Data Dictionary. See NCPDP Data |
| | | | | Dictionary for values. |
| C | DRU-100-02 | DUE Professional Service Code | an . . . 2 | Code identifying intervention performed |
| | | | | when a conflict has been detected. |
| | | | | This field uses the appropriate values |
| | | | | from the Professional Service Code in |
| | | | | NCPDP |
| | | | | Data Dictionary. See NCPDP Data |
| | | | | Dictionary for values. |
| C | DRU-100-03 | DUE Result of Service Code | an . . . 2 | Action taken in response to a conflict. |
| | | | | This field uses the appropriate values |
| | | | | from the Result of Service Code in the |
| | | | | NCPDP Data Dictionary. See NCPDP |
| | | | | Data Dictionary for values. |
| C | DRU-100-04 | DUE Co-Agent ID | an . . . 19 | Identifies the co-existing agent |
| | | | | contributing to the DUR event (drug or |
| | | | | disease) conflicting with the prescribed |
| | | | | drug. |
| | | | | When DUE Co-Agent ID is used, the |
| | | | | DUE Co-Agent ID Qualifier must be |
| | | | | present. |
| C | DRU-100-05 | DUE Co-Agent ID Qualifier | an . . . 2 | Code qualifying the value in DUE Co- |
| | | | | Agent ID. |
| | | | | When DUE Co-Agent ID Qualifier is |
| | | | | sent, the DUE Co-Agent ID must be |
| | | | | present. |
| | | | | This field uses the appropriate values |
| | | | | from the DUR Co-Agent Qualifier in the |
| | | | | NCPDP |
| | | | | Data Dictionary. See NCPDP Data |
| | | | | Dictionary for values. |
| X | DRU-110 | DRUG COVERAGE STATUS | an2 | Not used for RTBC |
| | | CODE | | |

RTBC—BENRES Transaction

Segment Notes: Response coming from the PBM to Physician System.

UIB Segment: 060-01 The Requester ID represents the PBM. 070-01 The Responder ID represents the Physician System.

UIH Segment: 010-04 Message Function has the value: BENRES.

PVD segment (Pharmacy): This segment is now required. This will indicate the Pharmacy where the script is to be filled

FRM Segment: Notice that the Repetitions went from 1-2 to 1-3.

RTBC - BENRES Transaction Segments Table

| | Segment | | Max | |
|---|---|---|---|---|
| Segment | Description | M/C | Repetitions | Description |
| UNA | Service String Advice | M | 1 | Must be present on all transactions in |
| | | | | this implementation usage. Is a fixed- |
| | | | | length segment. |
| UIB | Interactive Interchange | M | 1 | Designates Requester and Responder |
| | Control Header | | | IDs, trace numbers, date, and time |
| | | | | stamps at the interchange level. |
| UIH | Interactive Message | M | 1 | Designates the type of message. For |
| | Header | | | RTBC Response, message function = |
| | | | | BENRES. Also indicates trace numbers |
| | | | | at the message level. |
| RES | Response Segment | M | 1 | This segment allows the PBM to indicate |
| | | | | to the prescriber system whether the |
| | | | | request was successfully processed or |
| | | | | denied. |
| PVD | Provider Segment | M | 1 | One loop required for the prescriber. |
| | (Prescriber) | | | |
| PVD | Provider Segment | M | 1 | Pharmacy where the script is intended to |
| | (Pharmacy) | | | be filled. |
| PTT | Patient Segment | M | 1 | Designates patient information. |
| COO | Coordination of | M | 1 | Benefit information required to help |
| | Benefits Segment | | | determine which formulary to check. |
| DRU | Drug Segment | M | 1 | Drug Requested. |
| FRM | Formulary Segment | C | 1 to 3 | Designates the formulary and pricing |
| | | | | information for the drug requested. At |
| | | | | least one FRM is required if response |
| | | | | code is P for Processed or PNA for |
| | | | | Processed, No Alternatives |

An optional alternative loop - Loops 0 to 10 times. Each loop has an ALN segment and
corresponding FRM segments. (Refer to SLA Requirements)

| | | | | |
|---|---|---|---|---|
| ALN | Alternative Drugs | M | 1 | An alternative drug for the drug |
| | | | | requested (with coverage info). |
| FRM | Formulary Segment | M | 1 to 3 | Designates the formulary and pricing |
| | | | | information for this alternative. If an ALN |
| | | | | is provided, at least one FRM is required. |
| UIT | Interactive Message | M | 1 | Designates the message trace number |
| | Trailer | | | and number of segments in the |
| | | | | message. |
| UIZ | Interactive Interchange | M | 1 | Designates the interchange trace number |
| | Trailer | | | and the number of messages in the |
| | | | | transaction. |

RES—RESPONSE SEGMENT (Required). This segment allows the PBM to indicate to the Prescriber System whether the request was successfully processed or denied.

RES Response Segment Table

| | Element | | Data | |
|---|---|---|---|---|
| M/C | Number | Element Name | Type | Comments |
| M | RES-000 | SEGMENT TAG | | |
| M | RES-000-01 | Segment Code | a3 | Segment ID |
| | | | | Value: RES |
| M | RES-010 | RESPONSE TYPE, CODED | an . . . 3 | Values: |
| | | | | P = Processed. Responder attempted to |
| | | | | find Alternatives. |
| | | | | PNA = Processed. No Alternatives. |
| | | | | Responder did not attempt to find |
| | | | | alternatives. |
| | | | | D = Denied |
| | | | | NF = Not Found |
| | | | | NP = Not Processed. Drug requested |
| | | | | was not processed. |
| X | RES-020 | Code List Qualifier | an . . . 3 | Not used for RTBC. |
| X | RES-030 | Reference Number | an . . . 35 | Not used for RTBC. |
| C | RES-040 | Free Text | an . . . 70 | Message for Requester. |

PVD—PRESCRIBER SEGMENT (Required). One Loop REQUIRED for Prescriber.

PVD Prescriber Segment Table

| | Element | | Data | |
|---|---|---|---|---|
| M/C | Number | Element Name | Type | Comments |
| M | PVD-000 | SEGMENT TAG | | |
| M | PVD-000-01 | Segment Code | a3 | Segmanet ID |
| | | | | Value: PVD |
| M | PVD-010 | PROVIDER CODE | an . . . 3 | Value: PC = Prescriber |
| M | PVD-020 | REFERENCE NUMBER | Repeats up to 3 times | |
| | | | M for BENREQ | |
| | | | C for BENRES | |
| | | | For the RTBC Request, at least one occurrence | |
| | | | must contain the individual (not organizational) NPI | |
| | | | of the prescriber. | |
| | | | When present, the NPI will be validated against the | |
| | | | check digit routine for the requesting physician. For | |
| | | | specific information see | |
| | | | http://www.cms.gov/NationalProvidentStand/Downloads/NPIcheckdigit.pdf | |
| M | PVD-020-01 | Reference Number | an . . . 35 | Reference number for the prescriber. |
| M | PVD-020-02 | Reference Qualifier | an . . . 3 | Qualifier for reference number. A |
| | | | | complete list can be found in the NCPDP |
| | | | | External Code List (X12 DE 128). |
| X | PVD-030 | HEALTHCARE SERVICE LOCATION | | |
| C | PVD-040 | PROVIDER SPECIALTY | | |
| M | PVD-040-01 | Agency Qualifier, coded | an . . . 3 | Values: |
| | | | | AM = American Medical Association |
| | | | | DE = Drug Enforecement Agency |
| | | | | DR = Nation Wholesale Druggist |
| | | | | Association |
| | | | | HC = HCFA |
| M | PVD-040-02 | Provider Specialty, coded | an . . . 3 | If value of “AM” is used as the Agency |
| | | | | Qualifier, refer to NCPDP External Code |
| | | | | List (X12 DE 1222). |
| C | PVD-050 | NAME | Prescriber Name | |
| C | PVD-050-01 | Party Name | an . . . 35 | Last Name |
| C | PVD-050-02 | First Name | an . . . 35 | First Name |
| C | PVD-050-03 | Middle Name | an . . . 35 | Middle Name |
| C | PVD-050-04 | Suffix | an . . . 10 | Suffix |
| C | PVD-050-05 | Prefix | an . . . 10 | Prefix |
| X | PVD-060 | POSTCODE IDENTIFICATION | | |
| C | PVD-070 | PARTY NAME | an . . . 35 | Clinic Name |
| C | PVD-080 | ADDRESS | | |
| C | PVD-080-01 | Street and Number/PO Box | an . . . 35 | Address Line 1 |
| C | PVD-080-02 | City Name | an . . . 35 | |
| C | PVD-080-03 | State | an . . . 9 | |
| C | PVD-080-04 | Postal Code | an . . . 11 | |
| C | PVD-080-05 | Place/Location Qualifier | an . . . 3 | Agreement between trading partners |
| | | | | ”AD2” should be used for address line 2. |
| C | PVD-080-06 | Place Location | an . . . 35 | Address Line 2 |
| C | PVD-090 | COMMUNICATION NUMBER | Repeats > 1 | |
| C | PVD-090-01 | Communication Number | an . . . 80 | |
| C | PVD-090-02 | Code List Qualifier | an . . . 3 | A complete list can be found in the |
| | | | | NCPDP External Code List (X12 DE |
| | | | | 365). |
| C | PVD-100 | NAME | This composite is used to identify the Designated | |
| | | | Agent - use for transmitter/submitter name (if | |
| | | | present, first name and last name are | |
| | | | recommended by Surescripts). | |
| C | PVD-100-01 | Party Name | an . . . 35 | Last Name |
| C | PVD-100-02 | First Name | an . . . 35 | First Name |
| C | PVD-100-03 | Middle Name | an . . . 35 | Middle Name |
| C | PVD-100-04 | Suffix | an . . . 10 | Suffix |
| C | PVD-100-05 | Prefix | an . . . 10 | Prefix |

PVD—PHARMACY SEGMENT (Required). One loop will be sent for the Pharmacy where the script is intended to be filled. One loop will be returned for the Pharmacy where the script is intended to be filled.

PVD Pharmacy Segment Table

| | Element | | Data | |
|---|---|---|---|---|
| M/C | Number | Element Name | Type | Comments |
| M | PVD-000 | SEGMENT TAG | | |
| M | PVD-000-01 | Segment Code | a3 | Segment ID |
| | | | an . . . 3 | Value: PVD |
| M | PVD-010 | PROVIDER CODE | | Value: P2 = Pharmacy |
| M | PVD-020 | REFERENCE NUMBER | Repeats up to 3 times. | |
| M | PVD-020-01 | Reference Number | an . . . 35 | NCPDP Provider ID and or NPI. |
| M | PVD-020-02 | Reference Qualifier | an . . . 3 | D3 - Recommended by Surescripts |
| | | | | (NCPDP Provider, formerly known as |
| | | | | (NABP) |
| | | | | Qualifier for reference number. A |
| | | | | complete list can be found in the NCPDP |
| | | | | External Code List (X12 DE 128). |
| X | PVD-030 | HEALTHCARE SERVICE LOCATION | | |
| X | PVD-040 | PROVIDER SPECIALTY | | Not used for Parmacy segment. |
| C | PVD-050 | NAME | Pharmacist Name | |
| C | PVD-050-01 | Party Name | an . . . 35 | Last Name |
| C | PVD-050-02 | First Name | an . . . 35 | First Name |
| C | PVD-050-03 | Middle Name | an . . . 35 | Middle Name |
| C | PVD-050-04 | Suffix | an . . . 10 | Suffix |
| C | PVD-050-05 | Prefix | an . . . 10 | Prefix |
| X | PVD-060 | POSTCODE IDENTIFICATION | | |
| C | PVD-070 | PARTY NAME | an . . . 35 | Pharmacy Name |
| C | PVD-080 | ADDRESS | | |
| C | PVD-080-01 | Street and Number/PO Box | an . . . 35 | Address Line 1 |
| C | PVD-080-02 | City Name | an . . . 35 | |
| C | PVD-080-03 | State | an . . . 9 | |
| C | PVD-080-04 | Postal Code | an . . . 11 | |
| C | PVD-080-05 | Place/Location Qualifier | an . . . 3 | Agreement between trading partners |
| | | | | ”AD2” should be ised for address line 2 |
| C | PVD-080-06 | Place Location | an . . . 35 | Address Line 2 |
| C | PVD-090 | COMMUNICATION NUMBER | Repeats > 1 | |
| C | PVD-090-01 | Communication Number | an . . . 80 | |
| C | PVD-090-02 | Code List Qualifier | an . . . 3 | A complete list can be found in the |
| | | | | NCPDP External Code List (X12 DE |
| | | | | 365). |

| | | | |
|---|---|---|---|
| X | PVD-100 | NAME | Not used by NCPDP for Pharmacy segment. |

PTT—PATIENT SEGMENT (Required). Designates Patient Information.

PTT Patient Segment Table

| | Element | | Data | |
|---|---|---|---|---|
| M/C | Number | Element Name | Type | Comments |
| M | PTT-000 | SEGMENT TAG | | |
| M | PTT-000-001 | Segment Code | a3 | Segment ID |
| | | RELATIONSHIP TO | an . . . 3 | Value: PTT |
| C | PTT-010 | CARDHOLDER | | Values: |
| | | | | 1 = Member |
| | | | | 2 = Spouse |
| | | | | 3 = Child/Dependent |
| | | | | 4 = Other |
| M | PTT-020 | DATE OF BIRTH | d8 | Birth date Format is - CCYYMMDD. |
| M | PTT-030 | NAME | Patient Name | |
| M | PTT-030-01 | Party Name | an . . . 35 | Last Name |
| M | PTT-030-02 | First Name | an . . . 35 | First Name |
| C | PTT-030-03 | Middle Name | an . . . 35 | Middle Name |
| C | PTT-030-04 | Suffix | an . . . 10 | Suffix |
| C | PTT-030-05 | Prefix | an . . . 10 | Prefix |
| M | PTT-040 | GENDER | an . . . 3 | Values: |
| | | | | M = Male |
| | | | | F = Female |
| | | | | U = Unknown |
| C | PTT-050 | REFERENCE NUMBER | Repeats 2 | |
| M | PTT-050-01 | Reference Number | an . . . 35 | Patient ID |
| C | PTT-050-02 | Reference Qualifier | an . . . 3 | A complete list can be found in the |
| | | | | NCPDP External Code List (X12 DE |
| | | | | 128). |
| C | PTT-060 | ADDRESS | | Postal Code and City Code |
| | | | | recommended by Surescripts |
| C | PTT-060-01 | Street and Number/PO Box | an . . . 35 | Address Line 1 |
| C | PTT-060-02 | City Name | an . . . 35 | |
| C | PTT-060-03 | State | an . . . 9 | Recommended by Surescripts - Used |
| | | | | for sales tax |
| C | PTT-060-04 | Postal Code | an . . . 11 | Recommended by Surescripts - Used |
| | | | | for sales tax |
| C | PTT-060-05 | Place/Location Qualifier | an . . . 3 | Trading partner defined value |
| | | | | “AD2” should be used for address line 2 |
| C | PTT-060-06 | Place Location | an . . . 35 | Address Line 2 |
| C | PTT-070 | COMMUNICATION NUMBER | Repeats > 1 | |
| C | PTT-070-01 | Communication Number | an . . . 80 | Patient telephone number |
| C | PTT-070-02 | Code List Qualifier | an . . . 3 | A complete list can be found in the |
| | | | | NCPDP External Code List (X12 DE |
| | | | | 128). |

COO—COORDINATION OF BENEFITS SEGMENT (Required). Denotes the Patients Prescription Coverage. Sender will place the value of the ISA13 field found in the 270 Eligibility Request in this field, tying the Eligibility to the RTBC transaction (BENREQ or BENRES). The PBM Unique Member ID is REQUIRED by Surescripts.

COO Coordination Segment Table

| | Element | | Data | |
|---|---|---|---|---|
| M/C | Number | Element Name | Type | Comments |
| M | COO-000 | SEGMENT TAG | | |
| M | COO-000-01 | Segment Code | a3 | Segment ID |
| | | | | Value: COO |
| C | COO-010 | REFERENCE NUMBER | | |
| M | COO-010-01 | Reference Number | an . . . 35 | IAS13 value from the most recent 271 |
| | | | | eligibility response for the patient |
| C | COO-010-02 | Reference Qualifier | an . . . 3 | Qualifier identifying the Reference |
| | | | | Number. |
| | | | | Value: |
| | | | | ZZ = Specify Mutually Defined when |
| | | | | identifying the ISA13 value. |
| C | COO-020 | PARTY NAME | an . . . 35 | Payer Name |
| X | COO-030 | SERVICE TYPE CODE | | |
| C | COO-040 | REFERNCE NUMBER | | |
| M | COO-040-01 | Reference Number | an . . . 35 | Cardholder ID |
| X | COO-040-02 | Reference Qualifier | an . . . 3 | |
| C | COO-050 | NAME | an . . . 35 | Cardholder Name (Last Name, First |
| | | | | Name) |
| C | COO-060 | REFERENCE NUMBER | an . . . 35 | Group Number/Carrier |
| X | COO-070 | PARTY NAME | an . . . 35 | Group Name |
| X | COO-080 | ADDRESS | | |
| X | COO-090 | DATE | | |
| X | COO-100 | INSURANCE TYPE, CODED | | |
| X | COO-110 | ADDRESS | | |
| X | COO-120 | REFERENCE NUMBER | | |
| X | COO-130 | CONDITION/RESPONSE | an . . . 3 | Patient Consent Indicator |
| | | CODED | | |
| M | COO-140 | PATIENT IDENTIFIER | an . . . 60 | PBM unique member ID |
| | | | | (Required by Surescripts) |

DRU—DRUG SEGMENT (Required). Only ONE Drug allowed per Request, in embodiments. NDC11 MUST be sent in the DRU segment, in embodiments. At least one ZDS for Days Supply must be present, in embodiments.

DRU Drug Segment Table

| | Element | | Data | |
|---|---|---|---|---|
| M/C | Number | Element Name | Type | Comments |
| M | DRU-000 | SEGMENT TAG | | |
| M | DRU-000-01 | Segment Code | a3 | Segment ID |
| | | | | Value: DRU |
| M | DRU-010 | DRUG | | |
| M | DRU-010-01 | Item Description identification | an . . . 7 | Value: |
| | | | | R = Requested |
| M | DRU-010-02 | Item Description | an . . . 35 | Drug Name. |
| | | | | The self-contained full drug name, |
| | | | | strength, and form |
| | | | | May be abbreviated to fit the |
| | | | | information in 35 or less bytes. |
| M | DRU-010-03 | Item Number | an . . . 35 | Drug number (11 Digit Representative |
| | | | | NDC) |
| M | DRU-010-04 | Code List Responsibility Agency | an . . . 3 | Value: |
| | | | | ND = NDC11 |
| C | DRU-010-05 | Code List Qualifier | an . . . 3 | Drug form. |
| | | | | A complete list can be found in the |
| | | | | NCPDP External Code List (X12 DE |
| | | | | 1330). |
| C | DRU-010-06 | Free Text | an . . . 70 | Drug Strength - Measurement Value |
| C | DRU-010-07 | Code List Qualifier | an . . . 3 | Unit or Basis for Measurement Code. |
| | | | | A complete list can be found in the |
| | | | | NCPDP External Code List (X12 DE |
| | | | | 355). |
| C | DRU-010-08 | Reference Number | an . . . 35 | Drug Database Code |
| C | DRU-010-09 | Reference Qualifier | an . . . 3 | Code value to define the reference |
| | | | | number. |
| | | | | Values: |
| | | | | E = Medical Economic GFC |
| | | | | G = Medical Economic GM |
| | | | | FG = First DataBank GCN Seq # |
| | | | | FS = First DataBank SmartKey |
| | | | | MC = Multum Drug ID |
| | | | | MD = Medi-Span DDID |
| | | | | MG = Medi-Span GPI |
| | | | | MM = Multum MMDC |
| C | DRU-010-10 | Item Description | an . . . 35 | Drug name |
| | | | | If the full drug name, strength, form |
| | | | | does not fit in 010-02 without |
| | | | | abbreviation, level 10-12 are to be |
| | | | | used for the full name, strength, form. |
| C | DRU-010-11 | Item Description | an . . . 35 | Drug name |
| C | DRU-010-12 | Item Description | an . . . 35 | Drug name |
| M | DRU-020 | QUANTITY | | |
| M | DRU-020-01 | Quantity Qualifier | an . . . 3 | Unit or Basis for Measurement Code. A |
| | | | | complete list can be found in the |
| | | | | NCPDP External Code List (X12 DE |
| | | | | 355). |
| M | DRU-020-02 | Quantity | an . . . 35 | |
| M | DRU-020-03 | Code List Qualifier | an . . . 3 | Value: |
| | | | | 38 = Original Qty |
| C | DRU-030 | DIRECTIONS | | |
| X | DRU-030-01 | Dosage ID | | Future use. Has not been codified yet. |
| C | DRU-030-02 | Dosage | an . . . 70 | SIG instructions. Dosage - Free Text |
| C | DRU-030-03 | Dosage | an . . . 70 | SIG instructions. Dosage - Free Text |
| C | DRU-040 | DATE | Repeats up to 5 times. | |
| M | DRU-040-01 | Date/time period qualifier | an . . . 3 | Qualification of Date/Time field 2380. |
| | | | | X-12 DE 432 |
| | | | | 85 = Date issued (Written Date) |
| | | | | 07 = Effective Date (Begin) |
| | | | | 36 = Expiration Date (End) |
| | | | | PE = Period End |
| | | | | LD = Last Demand (Last Fill) |
| | | | | ZDS = Days Supply (At least one |
| | | | | occurance must be Days |
| | | | | Supply) |
| | | | | 35 = Delivered on This Date (Date |
| | | | | prescription received at facility) |
| | | | | BE = Validated (Date reviewed at |
| | | | | facility) |
| M | DRU-040-02 | Date or Quantity | an . . . 35 | Required if DRU-040-01 provided |
| M | DRU-040-03 | Date/Time Period format | an . . . 3 | Defines the date format used. |
| | | qualifier | | UN/EDIFACT element |
| | | | | Values: |
| | | | | 102 = Date CCYYMMDD |
| | | | | 203 = Date CCYYMMDDHHMM |
| | | | | 804 = Quantity of Days |
| C | DRU-050 | PRODUCT/SERVICE | an . . . 3 | Values: |
| | | SUBSTITUTED, CODED | | 0 = No product selection indicated |
| | | | | 1 = Substitution not allowed by |
| | | | | prescriber |
| | | | | 2 = Substitution allowed - patient |
| | | | | requested product dispensed |
| | | | | 3 = Substitution allowed - pharmacist |
| | | | | selected product despensed |
| | | | | 4 = Substitution allowed - generic drug |
| | | | | not in stock |
| | | | | 5 = Substitution allowed - brand drug |
| | | | | dispensed as a generic |
| | | | | 7 = Substitution not allowed - brand |
| | | | | drug mandated by law |
| | | | | 8 = Substitution allowed - generic drug |
| | | | | not available in marketplace |
| | | | | (6 and 9 intentionally left off) |
| X | DRU-060 | QUANTITY | Repeats twice | |
| C | DRU-070 | DIAGNOSIS | Repeats up to two times. | |
| M | DRU-070-01 | Clinical Information Qualifier | an . . . 3 | Values: |
| | | | | 1 = Prescriber |
| | | | | 2 = Pharmacy inferred |
| M | DRU-070-02 | Clinical Information - Primary | an . . . 17 | The prescriber supplied or pharmacy |
| | | | | inferred code for the diagnosis. |
| C | DRU-070-03 | Code List Qualifier | an . . . 3 | Qualifies the code list used for the |
| | | | | Diagnosis. |
| | | | | Values: |
| | | | | M = Medi-Span |
| | | | | F = First DataBank |
| | | | | E = Medical Economics |
| | | | | DX = ICD9 |
| | | | | ABF = ICD10 |
| | | | | Diagnosis Code |
| | | | | Values: |
| | | | | DX = ICD9 |
| | | | | ABF = ICD10 |
| C | DRU-070-04 | Clinical Information - Secondary | an . . . 17 | Diagnosis Code |
| C | DRU-070-05 | Code List Qualifier | an . . . 3 | Values: |
| | | | | DX = ICD9 |
| | | | | ABF = ICD10 |
| C | DRU-080 | REFERENCE NUMBER | | |
| M | DRU-080-01 | Reference Number | an . . . 35 | This number is used to store the |
| | | | | Prescription Number of the prescribing |
| | | | | system. |
| C | DRU-080-02 | Reference Qualifier | an . . . 3 | A complete list can be found in the |
| | | | | NCPDP External Code List (X12 DE |
| | | | | 128). |
| C | DRU-090 | FREE TEXT | an . . . 70 | Repeats up to 3 times. |
| | | | | Comments to Pharmacist. |
| C | DRU-100 | DRUG USE EVALUATION | Repeat up to 5 times. Conditional repeating | |
| | | | composite for further explanation, conflict, or | |
| | | | clarification of services related to drug use | |
| | | | evaluation. | |
| C | DRU-100-01 | DUE Reason for Service Code | an . . . 2 | Code identifying the type of conflict |
| | | | | detected. |
| | | | | When this composite is used, DUE |
| | | | | Reason For Service Code is |
| | | | | mandatory. |
| | | | | When the DUE Reason For Service |
| | | | | Code is sent from the prescriber to the |
| | | | | pharmacist, the DUE Result Of |
| | | | | ServiceCode is mandatory. |
| | | | | When the DUE Reason For Service |
| | | | | Code is sent from the pharmacist to the |
| | | | | prescriber, the DUE Result Of Service |
| | | | | code is conditional. |
| | | | | This field uses the appropriate values |
| | | | | from the Reason For Service Code in |
| | | | | NCPDP |
| | | | | Data Ductuibary. See NCPDP Data |
| | | | | Dictionary for values. |
| C | DRU-100-02 | DUE Professional Service Code | an . . . 2 | Code identifying intervention performed |
| | | | | when a conflict has been detected. |
| | | | | This field uses the appropriate values |
| | | | | from the Professional Service Code in |
| | | | | NCPDP |
| | | | | Data Dictionary. See NCPDP Data |
| | | | | Dictionary for values. |
| C | DRU-100-03 | DUE Result of Service Code | an . . . 2 | Action taken in respnse to a conflict. |
| | | | | This field uses the appropriate values |
| | | | | from the Result of Service Code in the |
| | | | | NCPDP Data Dictionary. See NCPDP |
| | | | | Data Dictionary for values. |
| C | DRU-100-04 | DUE Co-Agent ID | an . . . 19 | Identifies the co-existing agent |
| | | | | contributing to the DUR event (drug or |
| | | | | disease) conflicting with the prescribed |
| | | | | drug. |
| | | | | When DUE Co-Agent ID is used, the |
| | | | | DUE Co-Agent ID Qualifier must be |
| | | | | present. |
| C | DRU-100-05 | DUE Co-Agent ID Qualifier | an . . . 2 | Code qualifying the value in DUE Co- |
| | | | | Agent ID |
| | | | | When DUE Co-Agent ID Qualifier is |
| | | | | sent, the DUE Co-Agent ID must be |
| | | | | present. |
| | | | | This field uses the appropriate values |
| | | | | from the DUR Co-Agent Qualifier in the |
| | | | | NCPDP |
| | | | | Data Dictionary. See NCPDP DAta |
| | | | | Dictionary for values. |
| X | DRU-110 | DRUG COVERAGE STATUS | an2 | Not used for RTBC. |
| | | CODE | | |

FRM—FORMULARY SEGMENT (NOT Required). Formulary and pricing information for the drug requested. One loop is required if response code is P for processed or PNA for Process, No Alternatives. This FRM Table is for both occurrences of the FRM Segment and Response.

FRM Formulary Segment Table

| | Element | | Data | |
|---|---|---|---|---|
| M/C | Number | Element Name | Type | Comments |
| M | FRM-000 | SEGMENT TAG | | |
| M | FRM-000-01 | Segment Code | a3 | Segment ID |
| | | | | Value = FRM |
| M | FRM-010 | PHARMACY TYPE | an1 | Values: |
| | | | | M = Mail Order |
| | | | | R = retail |
| | | | | 9 - Retail 90 Days |
| M | FRM-020 | DRUG STATUS CODE | an . . . 2 | Values: |
| | | | | NC = Not Covered (Not Reimbursable) |
| | | | | Note: Not used for the FRM segment |
| | | | | following the ALN segment. |
| | | | | CR = Covered with Restrictions |
| | | | | CV = Covered |
| C | FRM-030 | COVERAGE | | Repeats up to five times. |
| C | FRM-030-01 | Coverage Reference Code | an . . . 2 | Must be used if Coverage Status = CR |
| | | | | Must be used if Coverage Status = CR |
| | | | | Values: |
| | | | | AL = Age Limits |
| | | | | DE = Drug Exclusion |
| | | | | GL = Gender Limits |
| | | | | MN = Medical Necessity (for |
| | | | | Formulary 1.0 only) |
| | | | | PA = Prior Authorization |
| | | | | QL = Quantity Limits |
| | | | | RD = Resource Link - Drug Specific |
| | | | | Level |
| | | | | ST = Step Therapy |
| | | | | TM = Text Message |
| C | FRM-030-02 | Coverage Reference Text | an . . . 200 | Instructions around the coverage |
| | | | | reference code FRM-030-01 |
| C | FRM-040 | FORMULARY STATUS | an . . . 2 | Values: |
| | | | | U = Unknown |
| | | | | 0 = Not Reimbursable |
| | | | | 1 = Non Formulary |
| | | | | 2 = On Formulary (Not Preferred) |
| | | | | 3 = Preferred Level 1 |
| | | | | 4 = Preferred Level 2 |
| | | | | 5 = Preferred Level 3 |
| | | | | Preferred Levels up to 99 are allowed. |
| C | FRM-050 | COPAY | | This field is required if FRM-020 Drug |
| | | | | Status Code is CV for covered and |
| | | | | FRM-060 Patient Pat Amount is blank. |
| | | | | If using the FRM-050 CoPay then one |
| | | | | of the following fields must be sent: |
| | | | | FRM-050-01 & 02 CoPay Tier, FRM- |
| | | | | 050-03 Percent CoPay Rate, or FRM- |
| | | | | 050-04 Flat CoPay Amount. |
| C | FRM-050-01 | CoPay Tier | n . . . 2 | This medication’s Tier; an indication of |
| | | | | the cost to the patient Lower values |
| | | | | represent lower cost to the patient |
| | | | | (e.g., Tier 1 is less costly to the patient |
| | | | | than Tier 2) |
| | | | | This field is required if FRM-050-03 |
| | | | | Percent CoPay Rate and FRM-050-04 |
| | | | | Flat CoPay Amount are blank or if |
| | | | | FRM-050-02 Maximum CoPay Tier is |
| | | | | used. |
| C | FRM-050-02 | Maximum CoPay Tier | n . . . 2 | Provides the range within which the |
| | | | | CoPay Tier is stated. The highest |
| | | | | CoPay tier within that range. |
| | | | | This field is required if FRM-050-03 |
| | | | | Percent CoPay Rate and FRM-050-04 |
| | | | | Flat CoPay Amount are blank or if |
| | | | | FRM-050-01 CoPay Tier is used. |
| C | FRM-050-03 | Percent CoPay Rate | n . . . 10 | Percentage expressed as a decimal |
| | | | | (e.g., 0.0 through 1.0 represents 0% |
| | | | | through 100%) |
| | | | | The length includes the decimal point. |
| | | | | This field is required if FRM-050-01 |
| | | | | CoPay Tier and FRM-050-04 Flat |
| | | | | CoPay Amount are blank. |
| C | FRM-050-04 | Flat CoPay Amount | n . . . 10 | No dollar sign. Decimal required if |
| | | | | value includes cents. Currency: USD |
| | | | | The length includes the decimal point. |
| | | | | This field is required if FRM-050-03 |
| | | | | Percent CoPay Rate and FRM-050-01 |
| | | | | CoPay Tier are blank. |
| C | FRM-060 | PATIENT PAY AMOUNT | This field is required if FRM-020 Drug Status | |
| | | | Code is CV for Covered or CT for Covered with | |
| | | | Restrictions, and FRM-050 CoPay is blank. | |
| M | FRM-060-01 | Pay Amount | n . . . 10 | Dollar amount |
| C | FRM-060-02 | Amount - Days supply | n . . . 10 | This field is required if FRM-060-03 |
| | | | | Amount Quantity is blank. |
| C | FRM-060-03 | Amount - Quantity | n . . . 10 | This field is required if FRM-060-02 |
| | | | | Amount Days Supply is blank. |

ALN—ALTERNATIVE DRUG SEGMENT (Required ONLY when Alternatives are sent). An Alternative Drug for the Drug Requested. PBM/Payers should send alternative drug requests back in the order in which they would like them displayed to the Prescriber.

ALN Alternative Drug Segment Table

| | Element | | Data | |
|---|---|---|---|---|
| M/C | Number | Element Name | Type | Comments |
| M | ALN-000 | SEGMENT TAG | | |
| M | ALN-000-01 | Segment Code | a3 | Segment ID |
| | | | | Value = ALN |
| M | ALN-010 | DRUG | | |
| X | ALN-010-01 | Item Description Identification | an . . . 7 | |
| M | ALN-010-02 | Item Description | an . . . 35 | Drug Name |
| | | | | Is the self-contained full drug name, |
| | | | | strength, and form. May be |
| | | | | abbreviated to fit the information in 35 |
| | | | | or less bytes. |
| M | ALN-010-03 | Item Number | an . . . 35 | Drug number (11 Digit Representative |
| | | | | NDC) |
| M | ALN-010-04 | Code List Responsibility Agency | an . . . 3 | Value: |
| | | | | ND = NDC11 |
| C | ALN-010-05 | Code List Qualifier | an . . . 3 | Drug Form. A complete list can be |
| | | | | found in the NCDP External Code |
| | | | | List (X12 DE 1330). |
| C | ALN-010-06 | Free Text | an . . . 70 | Drug Strength - Measurement Value |
| C | ALN-010-07 | Code List Qualifier | an . . . 3 | Unit or Basis for Measurement Code. |
| | | | | A complete list can be found in the |
| | | | | NCPDP External Code List (X12 DE |
| | | | | 365). |
| C | ALN-010-08 | Reference Number | an . . . 35 | Drug Database Code |
| C | ALN-010-09 | Reference Qualifier | an . . . 3 | Code value to define the reference |
| | | | | number |
| | | | | Values: |
| | | | | E = Medical Economic GFC |
| | | | | G = Medical Economic GM |
| | | | | FG = First DataBank GCN Seq # |
| | | | | FS = First DataBank SmartKey |
| | | | | MC = Multum Drug ID |
| | | | | MD = Medi-Span DDID |
| | | | | MG = Medi-Span GPI |
| | | | | MM = Multum MMDC |
| C | ALN-010-10 | Item Description | an . . . 35 | Drug name |
| | | | | If the full drug name, strength, form |
| | | | | does not fit in 010-02 without |
| | | | | abbreviation, level 10-12 are to be |
| | | | | used for the full name, strength, form. |
| C | ALN-010-11 | Item Description | an . . . 35 | Drug name |
| C | ALN-010-12 | Item Description | an . . . 35 | Drug name |
| C | ALN-020 | Alternative Generic Name | an . . . 35 | |

FRM—FORMULARY SEGMENT (Required ONLY when Alternatives are sent). Formulary and pricing information for the drug requested. One loop is required if response code is P for processed or PNA for Process, No Alternatives. This FRM Table is for both occurrences of the FRM Segment and Response.

FRM Formulary Segment Table

| | Element | | Data | |
|---|---|---|---|---|
| M/C | Number | Element Name | Type | Comments |
| M | FRM-000 | SEGMENT TAG | | |
| M | FRM-000-01 | Segment Code | a3 | Segment ID |
| | | | | Value = FRM |
| M | FRM-010 | PHARMACY TYPE | an1 | Values: |
| | | | | M = Mail Order |
| | | | | R = retail |
| | | | | 9 - Retail 90 Days |
| M | FRM-020 | DRUG STATUS CODE | an . . . 2 | Values: |
| | | | | NC = Not Covered (Not Reimbursable) |
| | | | | Note: Not used for the FRM segment |
| | | | | following the ALN segment. |
| | | | | CR = Covered with Restrictions |
| | | | | CV = Covered |
| C | FRM-030 | COVERAGE | | Repeats up to five times. |
| C | FRM-030-01 | Coverage Reference Code | an . . . 2 | Must be used if Coverage Status = CR |
| | | | | Must be used if Coverage Status = CR |
| | | | | Values: |
| | | | | AL = Age Limits |
| | | | | DE = Drug Exclusion |
| | | | | GL = Gender Limits |
| | | | | MN = Medical Necessity (for |
| | | | | Formulary 1.0 only) |
| | | | | PA = Prior Authorization |
| | | | | QL = Quantity Limits |
| | | | | RD = Resource Link - Drug Specific |
| | | | | Level |
| | | | | ST = Step Therapy |
| | | | | TM = Text Message |
| C | FRM-030-02 | Coverage Reference Text | an . . . 200 | Instructions around the coverage |
| | | | | reference code FRM-030-01 |
| C | FRM-040 | FORMULARY STATUS | an . . . 2 | Values: |
| | | | | U = Unknown |
| | | | | 0 = Not Reimbursable |
| | | | | 1 = Non Formulary |
| | | | | 2 = On Formulary (Not Preferred) |
| | | | | 3 = Preferred Level 1 |
| | | | | 4 = Preferred Level 2 |
| | | | | 5 = Preferred Level 3 |
| | | | | Preferred Levels up to 99 are allowed. |
| C | FRM-050 | COPAY | | This field is required if FRM-020 Drug |
| | | | | Status Code is CV for covered and |
| | | | | FRM-060 Patient Pat Amount is blank. |
| | | | | If using the FRM-050 CoPay then one |
| | | | | of the following fields must be sent: |
| | | | | FRM-050-01 & 02 CoPay Tier, FRM- |
| | | | | 050-03 Percent CoPay Rate, or FRM- |
| | | | | 050-04 Flat CoPay Amount. |
| C | FRM-050-01 | CoPay Tier | n . . . 2 | This medication’s Tier; an indication of |
| | | | | the cost to the patient Lower values |
| | | | | represent lower cost to the patient |
| | | | | (e.g., Tier 1 is less costly to the patient |
| | | | | than Tier 2) |
| | | | | This field is required if FRM-050-03 |
| | | | | Percent CoPay Rate and FRM-050-04 |
| | | | | Flat CoPay Amount are blank or if |
| | | | | FRM-050-02 Maximum CoPay Tier is |
| | | | | used. |
| C | FRM-050-02 | Maximum CoPay Tier | n . . . 2 | Provides the range within which the |
| | | | | CoPay Tier is stated. The highest |
| | | | | CoPay tier within that range. |
| | | | | This field is required if FRM-050-03 |
| | | | | Percent CoPay Rate and FRM-050-04 |
| | | | | Flat CoPay Amount are blank or if |
| | | | | FRM-050-01 CoPay Tier is used. |
| C | FRM-050-03 | Percent CoPay Rate | n . . . 10 | Percentage expressed as a decimal |
| | | | | (e.g., 0.0 through 1.0 represents 0% |
| | | | | through 100%) |
| | | | | The length includes the decimal point. |
| | | | | This field is required if FRM-050-01 |
| | | | | CoPay Tier and FRM-050-04 Flat |
| | | | | CoPay Amount are blank. |
| C | FRM-050-04 | Flat CoPay Amount | n . . . 10 | No dollar sign. Decimal required if |
| | | | | value includes cents. Currency: USD |
| | | | | The length includes the decimal point. |
| | | | | This field is required if FRM-050-03 |
| | | | | Percent CoPay Rate and FRM-050-01 |
| | | | | CoPay Tier are blank. |
| C | FRM-060 | PATIENT PAY AMOUNT | This Field is required if FRM-020 Drug Status | |
| | | | Code is CV for Covered or CT for Covered with | |
| | | | Restrictions, and FRM-050 CoPay is blank. | |
| M | FRM-060-01 | Pay Amount | n . . . 10 | Dollar amount |
| C | FRM-060-02 | Amount - Days supply | n . . . 10 | This field is required if FRM-060-03 |
| | | | | Amount Quantity is blank. |
| C | FRM-060-03 | Amount - Quantity | n . . . 10 | This field is required if FRM-060-02 |
| | | | | Amount Days Supply is blank. |

RTBC—Transaction examples.

RTBC—Request:

UNA:+./*′

### UIB+UNOA:0++991+++POCID:ZZZ:PASSWORD+PBM123:ZZZ+20071001:081322′

UIH+BENCON:001:001:BENREQ′

REQ+90R′

PVD+PC+123456789:HPI+++JONSON:TIM++++6518659191:TE′

PVD+P2+NCPDPID:D3+++++MCMOHR/′S CORNER PHARMACY+123 THIRD ST:ST PAUL:MN:55123+6518952323:TE′

PTT+1+19440605+JAMES:TINA+F+666886666: SY′

COO+123456789:ZZ+AMERICARE INSURANCE++MEMBERID+JAMES, TINA

+GROUPNUMBER++++++++PBM11356′

DRU+R:REGLAN 10 MG

### TABLETS:22123346763:ND::10:ME+EA:30:38+:TAKE 1 TABLET TWICE DAILY+ZDS:30:804′

UIT++8′

UIZ++1′

RTBC—Response:

UNA:+./*′

### UIB+UNOA:0++123+++PBM123:ZZZ:PASSWORD+POCID:ZZZ+20071001:081342′

UIH+BENCON:001:001:BENRES++991′

RES+P′

PVD+PC+123456789:HPI+++JONSON:TIM++++6518659191:TE′

PVD+P2+NCPDPID:D3+++++MCMOHR/′S CORNER PHARMACY+123 THIRD ST:ST PAUL:MN:55123+6518952323:TE′

PTT+1+19440605+JAMES:TINA+F+666886666:SY*PBM11356:2U′

COO+123456789:ZZ+AMERICARE INSURANCE++MEMBERID+JAMES, TINA

+GROUPNUMBER++++++++PBM11356′

DRU+R:REGLAN 10 MG

TABLETS:00031670163:ND::10:ME+EA:30:38+:TAKE 1 TABLET TWICE DAILY+ZDS:30:804′

FRM+R+CR+PA:PRIOR AUTH*QL: QUANTITY LIMITS+2++30:30′

FRM+M+CR+PA: PRIOR AUTH*QL: QUANTITY LIMITS+2++25:90′

FRM+9+CR+PA:PRIOR AUTH*QL: QUANTITY LIMITS+2++25:90′

ALN+:ALN DRUG NAME:12345678901:ND+ALN GENERIC NAME′

FRM+R+CV++3++25:30′

FRM+M+CV++3++20:90′

FRM+9+CV++3++20:90′.

ALN+:ALN DRUG NAME2:34343678901:ND′

FRM+R+CR+PA:ASK THE DOCTOR+2++25:30′

FRM+M+CR+PA:ASK THE DOCTOR+2++20:90′

FRM+9+CR+PA:ASK THE DOCTOR+2++20:90′

UIT++19′

UIZ++1′

RTBC—Error Processing. The Responder Participant will return an error whenever the transaction request has failed validation during processing of a formulary coverage status request. The error will be in the form of the NCPDP Error Message (STS segment). For some errors the RES segment can be utilized in the BENRES message. The table lists a subset of errors a Requester Participant may expect

Error Processing Table

| | STS-010/RES-010 | | STS-030/RES-040 | |
|---|---|---|---|---|
| Event | Status Type Code | STS-020 Code | Free Text | Note |
| Poorly formatted | STS-010 = 900 | Appropriate | Appropriate | Responder |
| Message | Transaction | Error | Error | Participant will |
| | Rejected | | | identify any problems |
| | | | | they have with the |
| | | | | physical structure of |
| | | | | the message. |
| Drug not Found | RES-010 = NF | N/A | DRUG NOT | Responder |
| | Not found | | FOUND | Participant will |
| | | | | respond with this |
| | | | | error when the drug |
| | | | | is not identified |
| | | | | properly, cannot be |
| | | | | found. |
| Cannot find patient | RES-010 = NF | N/A | Patient Not | Responder |
| identified | Not found | | Found | Participant utilizes |
| | | | | value in the COO- |
| | | | | 140 Patient Identifier |
| | | | | Field to validate if it is |
| | | | | missing not found, or |
| | | | | is invalid. |
| Patient not eligible | RES-010 = NF | N/A | Patient Not | Responder |
| | Not found | | Eligible | Participant verifies |
| | | | | that the patient is still |
| | | | | eligible for pharmacy |
| | | | | benefits. |
| System | RES-010 = NP | N/A | SYSTEM | This code is used |
| Unavailable | Not Processed | | UNAVAILABLE | when some system |
| | | | | components are not |
| | | | | available. Depending |
| | | | | on your system |
| | | | | configuration you |
| | | | | may or may not have |
| | | | | a case to use this code. |

RTBC—Scenarios.

Real Time Benefit Check Scenarios

Scenarios Table

| Successful | | | | Retail | Patient | | |
|---|---|---|---|---|---|---|---|
| Eligibility | Selected | | Refills | pharmacy | Has 90- | | Coverage |
| with Active | Pharmacy | Drug Not | Allowed | Utilizes | Day | RTBC | Information |
| Coverage(s)? | Type? | Preferred? | >0? | RTBC? | Benefit? | Run? | Returned |
| ✓ | Retail | ✓ | ✓ | ✓ | ✓ | ✓ | Retail, 90- |
| | | | | | | | Day, Mail |
| ✓ | Retail | ✓ | ✓ | X | ✓ | ✓ | Retail, Mail |
| ✓ | Retail | ✓ | ✓ | ✓ | X | ✓ | Retail, Mail |
| ✓ | Retail | ✓ | ✓ | X | X | ✓ | Retail, Mail |
| ✓ | Retail | X | ✓ | ✓ | ✓ | ✓ | Retail, 90- |
| | | | | | | | Day, Mail |
| ✓ | Retail | X | ✓ | X | ✓ | ✓ | Retail, Mail |
| ✓ | Retail | X | ✓ | ✓ | X | ✓ | Retail, Mail |
| ✓ | Retail | X | ✓ | X | X | ✓ | Retail, Mail |
| ✓ | Retail | ✓ | X | ✓ | ✓ | ✓ | Retail, 90- |
| | | | | | | | Day, Mail |
| ✓ | Retail | ✓ | X | X | ✓ | ✓ | Retail, Mail |
| ✓ | Retail | ✓ | X | ✓ | X | ✓ | Retail, Mail |
| ✓ | Retail | ✓ | X | X | X | ✓ | Retail, Mail |
| ✓ | Retail | X | X | ✓ | ✓ | X | N/A |
| ✓ | Retail | X | X | X | ✓ | X | N/A |
| ✓ | Retail | X | X | ✓ | X | X | N/A |
| ✓ | Retail | X | X | X | X | X | N/A |
| ✓ | Mail Order | ✓ | ✓ | N/A | N/A | ✓ | Mail Order |
| ✓ | Mail Order | X | ✓ | N/A | N/A | ✓ | Mail Order |
| ✓ | Mail Order | X | ✓ | N/A | N/A | ✓ | Mail Order |
| ✓ | Mail Order | ✓ | X | N/A | N/A | ✓ | Mail Order |
| ✓ | Mail Order | ✓ | X | N/A | N/A | ✓ | Mail Order |
| ✓ | Mail Order | X | X | N/A | N/A | X | N/A |
| X | Any | Any | Any | N/A | N/A | X | N/A |

Retail, 90 Day, Mail Scenario: Successful Eligibility with Active Coverage(s)—YES; Selected Pharmacy Type—Retail; Drug Not Preferred—YES; Refills Allowed is Greater Than 0—YES; Retail Pharmacy Utilizes RTBC—YES; Patient has 90-Day Benefit—YES; RTBC Run—YES; Coverage Information to be Returned—Retail, 90-Day, and Mail.

Retail, Mail Scenario: Successful Eligibility with Active Coverage(s)—YES; elected Pharmacy Type—Retail; Drug Not Preferred—YES; Refills Allowed is Greater Than 0—YES; Retail Pharmacy Utilizes RTBC—NO; Patient has 90-Day Benefit—NO; RTBC Run—YES; Coverage Information to be Returned—Retail and Mail.

Mail Only Scenario: Successful Eligibility with Active Coverage(s)—YES; Selected Pharmacy Type—Mail Order; Drug Not Preferred—NO; Refills Allowed is Greater Than 0—YES; Retail Pharmacy Utilizes RTBC—N/A; Patient has 90-Day Benefit

N/A; RTBC Run—YES; Coverage Information to be Returned—Mail Order. N/A Scenario: Successful Eligibility with Active Coverage(s)—YES; Selected

Pharmacy Type—Retail; Drug Not Preferred—NO; Refills Allowed is Greater Than 0—NO; Retail Pharmacy Utilizes RTBC—NO; Patient has 90-Day Benefit—YES; RTBC Run—NO; Coverage Information to be Returned—N/A—RTBC request is not sent.

Performance.

The responding participant shall return an RTBC response including formulary coverage information for each coverage type in accordance with the following conditions:

1. The responder shall include the formulary pricing, and coverage information that is known for the patient's active Mail Order Pharmacy, Retail Pharmacy, and 90 Days at Retail.

A. f the Request contains a Mail Order Pharmacy, then the responder shall return the formulary, coverage, and pricing information for the Mail Order Pharmacy only.

V. If the Request contains a Retail Pharmacy, and 90 Days at Retail is not requested, then the responder shall return the formulary coverage, and pricing information for Mail Order Pharmacy and Retail Pharmacy.

C. If the Request contains a retail Pharmacy, and 90 Days at Retail is requested, then the responder shall return the formulary, coverage, and pricing information for Mail Order Pharmacy, Retail Pharmacy, and 90 Days at Retail.

2. If the responder returns formulary, coverage, and pricing information for alternatives, it shall do so for all coverage types being requested.

Copay versus patient pay.

At a minimum, the application shall display the following, without user action:

a. All alternatives returned by the sender.

b. In the order supplied by the sender.

c. The application shall display formulary status and abbreviated copay data for all alternatives. Abbreviated copay data displayed shall be, at a minimum, the tier, flat amount or percent rate for each dispensing alternative (Mail, Retail, 90 Days at Retail).

Certification Requirements:

Days supply. Days supply may be required to be sent on the RTBC request. It may not be required in NEWRX messages for ePrescribing.

Triggers for sending RTBC.

During the prescription writing process and prior to the summary screen, a Real

Time Benefit Check (RTBC) shall be requested when all the following criteria have been met:
1) An eligibility check has been successfully processed and returned an active coverage
2) The recipient PBM participant has a use case of “RTBC”
3) At least one of the following conditions are met:
   a) The medication is not a preferred medication (i.e., Formulary Status 3 or greater) according to the pre-loaded formulary data.
   b) The selected medication is preferred and the number of refills are greater than 0.

Triggers for sending another RTBC.

When one or more of the following fields is modified after the initial RTBC response has been returned, and if the conditions herein still apply, an RTBC shall be requested again prior to the submission of a NEWRX:
1) Drug Name/ID.
2) Refills Allowed to a number greater than 0.
3) Pharmacy.

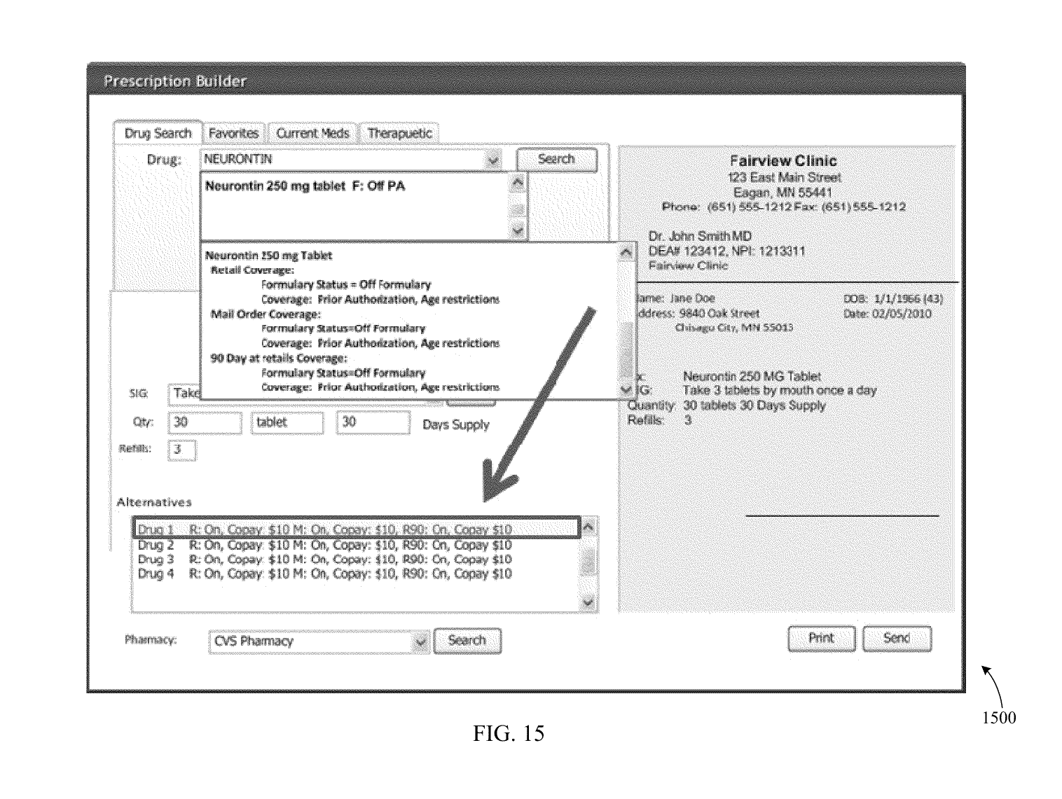

RTBC Results—What should happen when prescriber selects one of the alternatives? See FIG. 15.

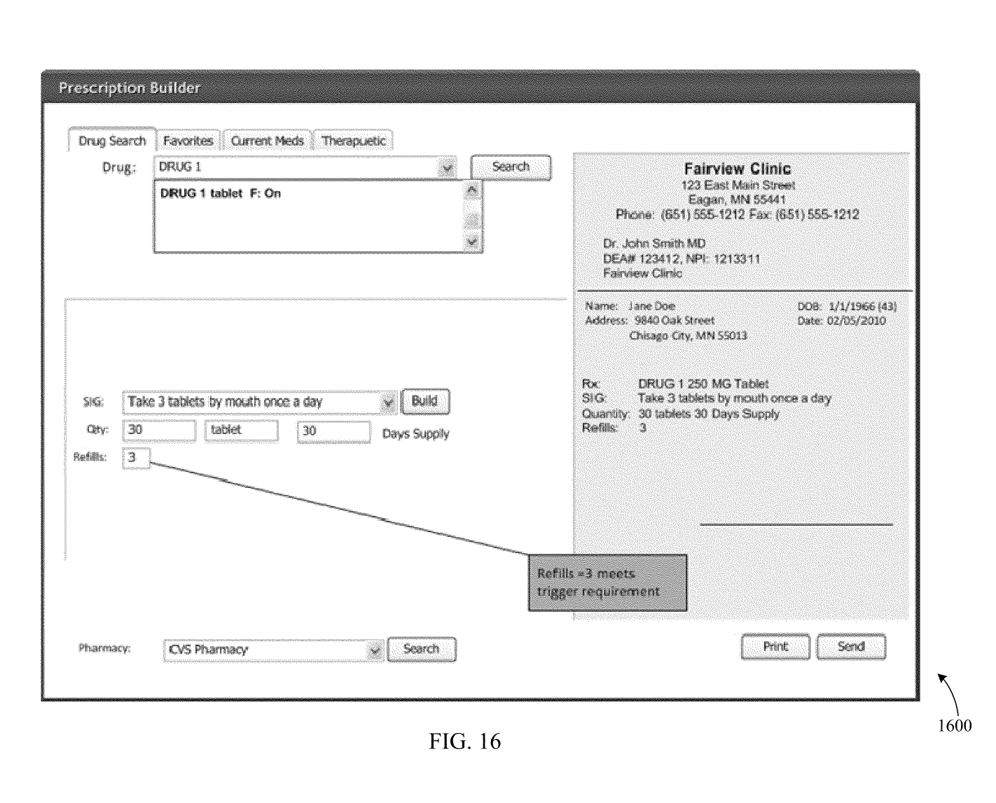

When the prescriber changes the NEWRX to a suggested alternative, should a new RTBC be sent when criteria is met? See FIG. 16.

In embodiments, the ACR process may be followed.

Reporting.

PBM RTBC Report: This report counts all RTBC response transactions that have PBM provided Alternative medications.

PBM RTBC Table

| | | PBM PBM A | | |
|---|---|---|---|---|
| | | Date 8/1/2013-8/31/2013 | | |
| Clinical | Provided | Mail Order | 90 Day Retail | Total |
| Vendor | Alternatives | Active | Active | Requests |
| Vender 1 | 321 | 222 | 32 | 601 |
| Vendor 2 | 232 | 131 | 42 | 288 |
| Vendor 3 | 131 | 98 | 54 | 150 |
| Vendor 4 | 34 | 12 | 3 | 42 |
| | 718 | 463 | 131 | 1081 |

Retail Pharmacy RTBC Report: This report counts all RTBC response transactions that have a 90 Day at retail Benefit indicated.

Retail Pharmacy RTBC Report Table

Pharmacy Chain Pharmacy ABC
Date 8/1/2014-8/31/2014

| PBM | Vendor | Transactions | 90 Day Benefit |
|---|---|---|---|
| PBM1 | Vendor A | 456 | 201 |
| | Vendor B | 314 | 145 |
| | Vendor C | 543 | 321 |
| | Vendor D | 231 | 234 |
| PBM2 | Vendor A | 678 | 455 |
| | Vendor B | 876 | 432 |
| | Vendor C | 654 | 643 |
| | Vendor D | 234 | 12 |
| Totals | | 2442 | 1542 |

Clinical Vendor RTBC Report: This report counts all RTBC requests/responses that a clinical vendor submits.

Clinical Vendor RTBC Report Table

Clinical Vendor Vendor A
Date 8/1/2013-8/31/2013

| Week | Requests | Response | Errors |
|---|---|---|---|
| 8/1-8/3 | 45 | 45 | 0 |
| 8/4-8/10 | 32 | 30 | 2 |
| 8/11-8/17 | 24 | 23 | 1 |
| 8/18-8/24 | 53 | 50 | 3 |
| 8/25-8/31 | 23 | 22 | 1 |

Reporting Determining value: see RTBC Workflow Table Diagram herein.

High Level Reporting: Number of RTBC with no subsequent NEWRX; Number of RTBC where coverage rules such as PA were returned; Number of RTBC where NEWRX did not differ from RTBC; and Number of RTBC where value was accrued.

Detailed Reporting. Value-based reporting to identify changes from RTBC to NEWRX: Drug changed from non-preferred on RTBC to preferred on NEWRX (value to PBM); Pharmacy changed from retail on RTBC to mail order on NEWRX (value to PBM/mail order pharmacy); and Days supply changed from less than 90 on the RTBC to 90 on the NEWRX (value to the retail pharmacy).

### Example Transaction Formats

In XML. Using current NCPDP SCRIPT standard, configured to bring to NCPDP as a new message.

Develop in EDIFACT. Easier for those who are still on EDIFACT standard, may not be supported by NCPDP SCRIPT.

D1 Telecom standard with support for alternatives. Includes modification to D1 transaction.

The Application Certification Requirements (ACR) are a set of additional requirements above those mandated in by Real Time Benefit Check (RTBC) or Patient Medication Benefit Check (PMBC).

General Data Format Requirements for ACR.

Numeric representation: The decimal point is represented by a period and shall be used as follows: only when there are significant digits to the right of the decimal; when there is a digit before and after the decimal point; not with whole numbers; and not to be counted towards the length total of a data element.

EDIFACT Trimming.

All non-essential characters shall be suppressed from the message where permissible (see EDIFACT Representation section in the Real Time Benefit Check Implementation Guide). Non-essential characters include leading spaces, trailing spaces, leading zeros, and trailing zeros where permissible (see Numeric Representation section herein).

The length of RTBC SCRIPT messages can be optimized in several ways. Empty segments should not be transmitted. Depending on the trading partner and the message, not all data elements will be utilized. All data elements within a segment after the last data element used may be dropped.

Although RTBC SCRIPT messages can be trimmed in several ways, software systems shall not assume that a trading partner would always trim their messages.

The systems shall be capable of properly interpreting a full-length message. If a data element is unused, it may be omitted. However, the data element separator character must be used to “hold the place” of the data element. RTBC SCRIPT messages do not contain field identifiers; therefore, all data elements (up to segment trim point) must be accounted for with separator characters.

Handling optional fields. The participant shall be able to process any valid incoming transaction request or response, including syntactically valid maximum population messages. Optional data elements (and values therein) shall not cause message failure.

Message Requirements.

RTBC Request. During the prescription writing process and prior to the summary screen, a Real Time Benefit Check (RTBC) shall be requested when all the following criteria have been met: An eligibility check has been successfully processed and returned an active coverage; The recipient PBM participant has a use case of “RTBC”; and At least one of the following conditions are met: The medication is not a preferred medication (i.e. Formulary Status 3 or greater) according to the pre-loaded formulary data; and The selected medication is preferred and the number of refills are greater than 0.

All Requests shall indicate in the REQ-010 field a value of “90R”.

When one or more of the following fields is modified after the initial RTBC response has been returned, and if the conditions in 3.1 still apply, an RTBC shall be requested again prior to the submission of a NewRx: Drug Name/ID; Refills Allowed from 0 to a non-0 number; Pharmacy.

The RTBC Request for a patient shall be tied to the most recent eligibility response for that patient by populating the ISA control number (ISA-13) from the 271 Eligibility Response in the COO-010-01 field on the RTBC Request.

RTBC Response. The responding participant shall return an RTBC Response including formulary coverage information for each coverage type in accordance with the following conditions:

1. The responder shall include the formulary, pricing, and coverage information that is known for the patient's active Mail Order Pharmacy, Retail Pharmacy, and 90 Days at Retail.
a. If the Request contains a Mail Order Pharmacy, then the responder shall return the formulary, coverage, and pricing information for the Mail Order Pharmacy only.
b. If the Request contains a Retail Pharmacy, then the responder shall return the formulary, coverage, and pricing information for Mail Order Pharmacy, Retail Pharmacy, and 90 Days at Retail.

2. If the responder returns formulary, coverage, and pricing information for alternatives, it shall do so for all coverage types being requested.

The application shall make distinctions between all formulary statuses. (For example, Non Formulary, On Formulary/Preferred Level 1 and On Formulary/Preferred Level 3 must be distinctly identified.)

Presentation of RTBC Response. During the prescription writing process and prior to the summary screen, the application shall display, without user action: formulary status, all coverage factors, and all copay factors for all pharmacy types provided for a drug at the drug name/strength/dosage form level. These concessions are allowed:

1. An indicator that coverage factors apply. User action on this indicator presents all the coverage factors in their entirety.

2. Abbreviated copay displayed. User action shall display all copay factors for all pharmacy types in their entirety. Note that copay must not be displayed for a drug that is not reimbursable (status zero). The abbreviated copay displays:

a. At least two pharmacy types in this precedence order: Any>Null>Retail>Mail Order>Specialty>LTC

b. Values and qualifiers to abbreviate all copay details. Examples include combinations of:

i. T1/3 (indicates Tier 1 of 3)

ii. $20+10% (indicates $ amount is first term, followed by %)

iii. 30D (indicates 30 days supply)

iv. “ . . . ” (indicates min/max copay amounts or more info available).

Vendor shall display a disclaimer that the pricing/coverage data is calculated and may not be an actual value. Actual values may vary once the prescription is filled at the dispensing pharmacy.

At a minimum, the application shall display the following, without user action: a. All alternatives returned by the sender; b. In the order supplied by the sender; c. The application shall display formulary status and abbreviated copay data for all alternatives. Abbreviated copay data displayed shall be, at a minimum, the tier, flat amount or percent rate for each dispensing alternative (Mail, Retail, 90 Days at Retail). To view the complete list of alternatives, the application may allow the user to scroll.

Detailed RTBC Transaction Workflow. Participants shall support the scenarios herein of the Real Time Benefit Check. Where the Status transaction is used, the 010 indicates that no further transactions will follow. An Error or Status (code 010) shall always be sent to close the transaction workflow. If a transaction workflow has already been closed and an error occurs, a message should not be sent, rather a manual process should be followed. An Error message shall never be responded to with an Error message; to prevent creation of an endless loop. A Status message with a code of ‘010’ may not be responded to; it shall be considered the final message.

UIB-Interactive Interchange Control Header Segment and UIH-Interactive Message Header Segment.

UIB-030-01 Transaction Control Reference. Each message sent from a participant shall have a unique MessageID. MessageIDs should not be reused for 18 months. A minimum set of standards/algorithms should be used when generating MessageIDs to ensure uniqueness. If possible, participants should utilize Global Unique Identifiers (GUIDs).

UIB-030-02 Initiator Reference Identifier & UIH-030-01 Initiator Control Reference. The Message ID of the Request shall be echoed back in the UIH-030-01 Initiator Control Reference of the BENRES. For a STATUS or ERROR response, the Message ID of the request shall be echoed back in the UIH-030-01 Initiator Control Reference for an 8.1 version setup or in the UIB-030-02 Initiator Reference Identifier for a 10.6 version setup.

PVD—Prescriber, Pharmacy, and PTT Segments.

PVD-090-01 and PTT-070-01 Communication Number. Phone Number shall be in the format 5552223333X4444—where 555 is the area code, 2223333 is the main number and X4444 is the extension (Please note the extension X4444 is just an example. Less/more than four digits are allowed). Phone number shall not be populated with all zeros or other default values. This field is 80 characters long to handle email addresses.

DRU—Drug Segment.

DRU-010-02 Item Description. The item or drug description field shall include the full drug name, strength and form (in that exact sequence). When sending, the NDC must be an 11 digit NDC in the 5-4-2 format. Dashes shall not be used and leading zeros shall not be suppressed.

Real Time Benefit Check Implementation Guide

Section 1 Overview

1.2 ABOUT THIS GUIDE. Real Time Benefit Check Implementation Guide (This Guide).

The Surescripts Real Time Benefit Check Guide was created to assist Pharmacy

Benefit Managers (PBMs) in developing and transferring messages needed to provide Real Time Benefit Check information to prescriber vendors. This document represents the EDIFACT implementation.

Once a patient has been determined to have eligibility and the prescriber has selected a drug, the prescriber sends a Real Time Benefit Check (RTBC) transaction to the PBM to provide real-time, patient-specific benefit information at the point of care, inside the electronic prescription workflow. The RTBC transaction is a request/response transaction that will provide the requester with formulary and coverage status, and the estimated patient cost for a particular patient and drug based on the pharmacy selected. The response may also contain alternative drugs with their associated formulary status. Only one drug and pharmacy can be requested per transaction.

For this implementation, Surescripts assumes that the requester is a prescriber system vendor and the information source is a PBM.

1.3 RELATED GUIDES. Prescription Benefit Implementation Guide.

The Surescripts Prescription Benefit Implementation Guide was created to assist

Pharmacy Benefit Managers (PBMs) and prescriber vendors in developing and transferring messages needed to provide prescription benefit data (eligibility information, pharmacy benefit coverage, and group-specific formulary information) to physicians in an ambulatory setting.

1.4 DOCUMENT REFERENCES. Please reference the following documents when reading this Implementation Guide: NCPDP's SCRIPT Standard Format Implementation Guide (Version 8, Release 1); NCPDP's EXTERNAL CODE LIST, Published July 2007; Real Time Benefit Check Application Certification Requirements herein.

The Guide utilizes the NCPDP (National Council for Prescription Drug Programs) messaging standard “Prescriber/Pharmacist Interface SCRIPT version 8.1” as a baseline.

In conjunction with this Surescripts Implementation Guide, participants should have a copy of these documents readily available for use with the transactions. Documentation can be obtained through National Council for Prescription Drugs as referenced below:

NCPDP is an American National Standards Institute (ANSI) accredited Standard Development Organization. The NCPDP “SCRIPT” standard is a copyrighted document and may be obtained by contacting:

NCPDP—9240 E. Raintree Drive—Scottsdale, Ariz. 85260-7518.

Phone: (480) 477-1000; Fax: (480) 767-1042; http://www.ncpdp.org. Some copyrighted materials in this guide are reproduced with the consent of the National Council for Prescription Drug Programs, Inc.

Section 2 Implementation, Certification, & Production

2.1 Implementation Process

You will be invited to a Surescripts education session, receive Surescripts network guides/requirement documentation, and your account will be set up to access the Surescripts staging/certification environment. The timeframe of the Implementation Phase can vary depending on your resource allocation for the project.

2.2 Certification Process

The Certification Phase includes more detailed testing of the transactions through your user interface to ensure that it meets all Surescripts' requirements. Surescripts assigns your organization a Certification Project Manager for working through the completion of certification testing. Surescripts provides more detail surrounding the necessary milestones for certification and moving into production. Once a participant passes certification, they are ready for transitioning to production.

2.3 Transition to Production

Once Certification is complete, you are ready to move into production. Surescripts will schedule a hand-off meeting for your business and technical staff and Surescripts to discuss the following:
Production support contacts (Surescripts' and those from your organization)
Support process
Support hours

2.4 Certification Requirements

The Surescripts certification process ensures that participant software can send and receive electronic messages in accordance with industry standards and that it provides open choice for medication selection and dispensing location. In addition, Surescripts certification focuses on patient safety, efficiency of the electronic prescribing process and ease of use by end-users.

Surescripts' certification testing focuses on message format, application workflow, and display in accordance with Surescripts' Implementation Guides and the associated Application Certification Requirements document noted in Document References, above. By holding all participants equally accountable for meeting the application certification requirements, our participants can send and receive the highest quality transactions as e-prescribing and clinical messaging continues to progress overall as an industry.

Requirements that are enforced as part of the production code are denoted as “must” and will need to be met in order to successfully complete certification. “Should” is used for guidance or best practices. See the following chart for terminology usage in this implementation guide.

Term Chart

| Term | Term usage |
|---|---|
| must | Requirements that are enforced as part of the production code. |
| should | Used for guidance and best practices. Best practices can also be |
| | found in Best Practice sections. Participants are encouraged, but |
| | not required, to meet best practices in order to be certified on |
| | the Surescripts network. |

2.5 Connectivity HTTPS

The Surescripts network uses the HTTPS protocol for the transport of messages between network participants. HTTPS is a secure, reliable, and widely used protocol for the exchange of information over TCP/IP. With HTTPS, participants act as the client and send transactions to the server on the Surescripts system. With certain transactions, Surescripts also acts as the client by sending HTTPS requests to servers on participants' systems.

The preferred connectivity method is HTTPS with the following specifications:
TCP/IP is the communication protocol utilized between the participant and Surescripts.
HTTPS (Version 3) is the preferred application protocol.
A static, registered IP address is required of the participant.
Participants use the standard HTTPS post method to connect and send transactions to Surescripts.
Surescripts uses the standard HTTPS post method to connect and send transactions to participants.
The URLs are supplied at the point of integration.
Server certificates with 128-bit encryption are utilized at Surescripts. The participant is responsible for providing its own 128-bit (server) digital certificate.
Separate test and production instances are created for Surescripts and the participant's systems.
A participant receiving Point-to-Point messages via SSL from Surescripts will need to identify the Certificate Authority associated with the participant's certificate. Surescripts needs to check for the participants' certificate from that Certificate Authority. If the participant is using a self-signed certificate, Surescripts will need the participant's Certificate Authority certificate.
Outbound HTTP Basic Authentication is an option for participants. If Basic Authentication is selected for RTBC it will also be used for Eligibility since they share the same connection.

2.5.1 HTTPS Post

This section contains supplemental information on the usage of HTTPS connectivity. The flow of a HTTPS transaction requires the following generic steps:

1). Format the transaction (sending transaction in body). a). Setting the HTTP content-type to text/plain, b). Write the transaction to the body.

2). Send the transaction using the POST method.

2.5.1.1 HTTP-Level Authentication

If a participant's infrastructure requires that incoming HTTP communication must be authenticated using basic HTTP authentication before being passed along to a business system for processing, Surescripts will format the Authorization property in the HTTP header. Participants that are in need of this feature must notify their Surescripts Implementation Manager during the implementation process.

An example of the HTTP Authorization header formatted by Surescripts for authentication on the participant's system follows:

Authorization: Basic U1VSRVNDUk1QVFM6Tk9QQVNT where U1VSRVNDUk1QVFM6Tk9QQVNT is the result of base64 encoding “SURESCRIPTS:NOPASS” (NOPASS was Surescripts' password for the receiving participant system in this example.)

2.5.1.2 Post Method Snippets

The following Java Code is an example of how to POST to Surescipts:

```
/**
* Send a transaction to the Surescripts Network.
* @param urlString - The url to use.
* @param transaction - The transaction.
* @return - The response from Surescripts' Network.
* @throws Exception On any unhandled error.
*/
public static String sendTransaction(String urlString, String transaction)
    throws Exception
{
OutputStream out;
BufferedReader in;
HttpURLConnection con;
String response = “”;
int BUFFER_SIZE = 500;
URL url = new URL(urlString);
con = (HttpURLConnection) url.openConnection( );
con.setDoOutput(true);
con.setDoInput(true);
con.setRequestMethod(“POST”);
con.setRequestProperty(“Content-length”,
String.valueOf(transaction.length( )));
out = con.getOutputStream( );
// Send the transaction
out.write(transaction.getBytes( ));
out.flush( );
// The InputStreamReader cannot be created until after the write and
// flush have occurred. If it is, the write fails.
in = new BufferedReader(new
InputStreamReader(con.getInputStream( )));
char[ ] cbuf = new char[BUFFER_SIZE + 1];
// Read the response
while (true) {
//String line = in.readLine( );
int numCharRead = in.read(cbuf, 0, BUFFER_SIZE);
// If −1, it is the end of the file/stream
if (numCharRead == −1) {
break;
}
// Null terminate the final position of the string read into cbuf
String line = new String(cbuf, 0, numCharRead);
response += line;
}
//close the streams in.close( ); out.close( ); con.disconnect( );
return response;
}
The following .NET Code gives an example of how to POST to
Surescipts:
/**
* Sends a transaction to the Surescripts Network.
* Parameters:
* urlString -- The URL to send to.
* transaction -- The transaction to submit.
* Returns the response from the Surescripts Network.
* Throws System.Net.WebException if it doesn't get a good response.
*/
public static string sendTransaction(string urlString, string transaction) {
  ASCIIEncoding encoding=new ASCIIEncoding( );
  byte[ ] data = encoding.GetBytes(transaction);
HttpWebRequest req = (HttpWebRequest)WebRequest.Create(urlString);
req.Method = “POST”;
req.ContentLength = data.Length;
Stream newStream=req.GetRequestStream( );
newStream.Write(data,0,data.Length);
newStream.Close( );
HttpWebResponse res = (HttpWebResponse)req.GetResponse( );
Stream receiveStream = res.GetResponseStream ( );
// Pipes the stream to a higher level stream reader with the
// required encoding format.
StreamReader readStream = new StreamReader (receiveStream,
Encoding.UTF8);
string response = readStream.ReadToEnd( );
res.Close ( );
readStream.Close ( );
return response;
}
```

2.5.1.3 SSL Information

Surescripts expects SSL (HTTPS) traffic on the standard SSL port, 443.

2.5.1.4 Server Certificates

When setting up a Web server to accept SSL, it is necessary to use a digital certificate. The certificate that is used in the production environment must be signed by an established certificate authority, such as VeriSign. In the certification environment, the certificate can be self-signed. In the case of a self-signed cert, it will be necessary to send a copy of the cert to Surescripts so it can be recognized as a valid certificate when Surescripts connects to the site.

2.5.1.5 Supported Network Connections for Https

Participants may use one of the following network connectivity methods with HTTPS.
Internet:
   Address filtering will be done in the Surescripts firewall.
   Surescripts will work with participants to review their current connection speed and bandwidth to ensure they are adequate for anticipated transaction volumes.
Frame Relay:
   128 kbps minimum bandwidth over a frame relay circuit between Surescripts and the participant.
   The line must be encrypted with 3DES.
   The participant must allow Surescripts to install and manage two routers in their data center that connect to their extranet environment.
   The participant must have a dual network connection through two different telecommunications providers.

2.6 Timeouts

Each transaction that Surescripts submits to a participant has a time-out parameter.

If Surescripts does not get a response from the participant within the specified time period, the transaction times out. Surescripts will then respond to the original sender in the appropriate manner. The Surescripts default time-out period is 10 seconds.

For round-trip transactions, the initiator of a transaction can expect Surescripts to time out after 30 seconds of attempting to respond to the request. Therefore, the initiator should set their time-out to a value at least two seconds greater, or 32 seconds.

For a transaction being sent from Surescripts to a participant, Surescripts utilizes the participant specific time-out to determine when the transactions will time out. For instance, if a participant has set their Surescripts specific time-out to 10 seconds, Surescripts will time out after waiting for an acknowledgment for 10 seconds. Therefore, the recipient should set their time-out to two seconds less than the set 10 seconds.

2.7 Compliance

Surescripts' goal is efficiency and consistency across the network so that all participants can meet the highest measures of patient safety, end-to-end reliability, and quality. To ensure that participants comply with, and adhere to, the approved certification requirements, Surescripts:
Initiates a remediation process for identified compliance issues,
Conducts scheduled and ad-hoc compliance checks of all participants transacting on the network, and
Monitors participants in production to ensure all network participants remain in compliance with certification requirements and contractual terms.

Participants agree to notify Surescripts when they have altered, reconfigured or disabled any portion of a Surescripts certified software product or module, before moving such changes into production, as they may create a circumstance of non-compliance with the Surescripts certification issued. In those instances, Surescripts will work with the participant to perform a timely re-certification, if required, to ensure network compliance and safety.

The guide is intended for certification on our network only and is not intended to ensure compliance with state and federal law. In accordance with participant's legal agreement with Surescripts, each participant is responsible for conducting its own due diligence to ensure compliance with all applicable laws including, but not limited to, local and state laws and regulations in which the participant's application is deployed.

Section 3 Transactions Overview

3.1 Message Format

Surescripts is only supporting the EDIFACT format of this standard for this initial release.

EDIFACT—Also known as UN/EDIFACT, EDIFACT is an acronym for “EDI for Administration, Commerce, and Transport”. EDIFACT is the international message standard for the exchange of electronic data, developed and managed through the cooperation of the United Nations and the Economic Commission for Europe (UN/ECE). For more details, please see the EDIFACT Website at: http://www.unedifact.org. The NCPDP SCRIPT standard was originally based on the EDIFACT standard.

3.2 Transaction Descriptions

BENREQ—Real Time Benefit Check Request

This message is sent from the prescriber to the PBM to request real-time, patient-specific benefit information based on the selected pharmacy, drug, and days supply.

BENRES—Real Time Benefit Check Response

This message is sent from the PBM to the prescriber system in response to the request for benefit information and may include the formulary, pricing, and coverage information that is known for Mail Order Pharmacy, Retail Pharmacy, and/or 90 Days at Retail. The response may contain alternative drugs with the same information.

3.2.1 Acknowledgement Transactions

Error Message

This NCPDP SCRIPT transaction transmits that an error has occurred, indicating the request was terminated. An error can be generated when there is a communication problem or when the transaction actually had an error (e.g. a formatting problem).

Status

This NCPDP SCRIPT transaction is used to communicate an acceptance message.

Status messages will be sent to indicate receipt of a valid transaction.

3.3 Real Time Benefit Check Transaction Flow

See 3.3 Transaction Flow Table herein.

3.4 Real Time Benefit Check Detailed Transaction Flow

Directories Setup

1). Surescripts registers participating PBMs with an RTBC use case in the Surescripts Directory indicating that they opted to participate in this message (for more information on this process, see the Directories section in this guide).

2). The prescribing system vendor downloads the 4.6 Directory Organization list.

a). The PBM is identified as “RTBC” in the Use Case field if they support RTBC.

Request/Response

1). The prescriber system sends an eligibility request to Surescripts, ultimately getting to the patient's PBM, to obtain the PBM ID and the PBM unique member ID for the formulary and benefit lookup.

2). During the prescribing process, the prescriber reviews formulary and benefit information preloaded from the bulk load process.

a). This information assists the prescriber in directing them to medication options that may be cost effective and contain limited coverage factors. The data is generalized for the particular plan/group but may assist in narrowing down the appropriate choices.

3). The prescriber selects a medication, writes the script, and assigns a pharmacy.

4). The prescriber system determines that the patient's PBM participates in RTBC based on the information provided in the Directory Organization download.

5). The vendor sets the RTBC (90R) flag in the RTBC request indicating to the PBM that they need to return 90 Days at Retail information.

6). The prescriber sends an RTBC request (supplying the PBM unique member ID) based on a specific patient, pharmacy, and drug when one or more of the following conditions are met:

a). The medication is not a preferred medication (i.e. Formulary Status 3 or greater) according to the pre-loaded formulary data.

b). The selected medication is preferred and the number of refills are greater than 0.

7). Surescripts validates the message and routes the request to the appropriate PBM.

8). The PBM processes the request. The processing steps include the following:

a). The PBM validates the format of the request.

b). The PBM finds/confirms the patient based on the requested data.

c). (Optional) The PBM determines that the patient is still eligible. This step is optional because this transaction assumes that the eligibility transaction has been completed within the last 72 hours.

d). The PBM determines formulary status based off of the drug identifier given, the patient identifier, and the pharmacy provided.

9). The PBM creates the RTBC response transaction and sends it back to Surescripts.

10). Surescripts validates the message and routes the response transaction back to the requester.

3.5 Real Time Benefit Check Error Transaction Workflow

See 3.5 Error Transaction Workflow Table herein.

The 3.5 Error Transaction Workflow Table depicts various scenarios where Error and Status messages are sent in response to an RTBC transaction. Note that this applies to any of the RTBC transactions for all of these scenarios.

Scenario 1: 1a) A participant sends an RTBC transaction to Surescripts.

1b) Surescripts cannot recognize the transaction or can't recognize (identify) and sends an NAK back to the sending participant.

Scenario 2: 2a) A participant sends an RTBC transaction to Surescripts.

2b) Surescripts recognizes the format as NCPDP but finds errors in the transaction.

Surescripts returns an Error transaction.

Scenario 3: 3a) A participant sends an RTBC transaction to Surescripts.

3b) Surescripts forwards the transaction on to the receiving participant.

3c) Surescripts cannot recognize the transaction or can't recognize (identify) and sends an NAK back to the sending participant.

3d) Surescripts creates an Error transaction and returns it to the sending participant.

Scenario 4: 4a) A participant sends an RTBC transaction to Surescripts.

4b) Surescripts forwards the message on to the receiving participant.

4c) The receiving participant validates the transaction, finds errors in the transaction, and returns an Error transaction to Surescripts.

4d) Surescripts forwards the Error transaction back to the sending participant.

Scenario 5: 5a) A participant sends an RTBC transaction to Surescripts.

5b) Surescripts forwards the message on to the receiving participant.

5c) The participant sends a response that Surescripts does not recognize.

5d) Surescripts cannot recognize the transaction or can't recognize (identify) and sends a Syntax Validation Error (code 900) transaction back to the receiving participant.

5e) Surescripts sends an Error transaction to the sending participant indicating that there was a communication issue (602-007).

5f) The receiving participant responds with a Status (code 010) transaction.

Scenario 6: 6a) A participant sends an RTBC transaction to Surescripts.

6b) Surescripts forwards the message on to the receiving participant.

6c) The participant sends an RTBC transaction to Surescripts.

6d) Surescripts recognized the transaction, but the transaction fails validation.

Surescripts sends an Error transaction to the receiving participant.

6e) Surescripts sends an Error transaction indicating that there was a communication issue (602-007).

6f) The receiving participant responds with a Status (code 010) transaction.

Note: Where the Status transaction is used, the 010 indicates that no further transactions will follow.

3.6 Directories

The Directory registration for this product will utilize the use case functionality as defined in the Surescripts Directory 4.6 Implementation Guide. The identification in the download for payer organizations will be “RTBC” in the Use Case field.

3.6.1 PBM/Payer Directory Records

Surescripts adds PBM/payers implementing RTBC to the directory and assigns an RTBC use case indicating their ability to receive and respond to RTBC requests. Surescripts staff performs the initial setup of each PBM/payer's directory record during their RTBC implementation process. Surescripts performs ongoing management after implementation.

Surescripts assigns each PBM/payer the same routing identifier for RTBC messaging as it uses for eligibility, medication history, electronic prior authorization and other benefit messaging (its “PID”, the 15-character identifier that starts with “P” in the production environment).

If a PBM/payer has signed up for the RTBC product, then Surescripts will assign a use case to them.

3.6.2 PBM/Payer Directory Access

PBM/payers do not retrieve information from the directory in conjunction with RTBC messaging. Each step of the RTBC workflow begins with the prescriber system sending an RTBC message to a PBM/payer and the PBM/payer's response is always addressed back to that initiating prescriber. There are no points in the current RTBC workflow where a PBM/payer must “look up” the routing information or use case of an RTBC message recipient.

3.6.3 Prescriber Directory Access

Prescriber systems will need to retrieve the current list of PBM/payers that support RTBC messaging by downloading the 4.6 version of the Surescripts directory download process. The prescriber system's existing organization directory download configuration can coexist with a separate 4.6 download process to retrieve organizations.

3.7 General Interface Description

Use of the data transfer specifications below will result in a simple and efficient message.

3.7.1 EDIFACT Dynamic Delimiters

NCPDP SCRIPT utilizes delimiters to separate component, segments, elements, etc., or as indicators (i.e. for segment repetition). These delimiters are defined within specified segments of the transactions. Participants' systems need to be able to dynamically set and handle these delimiters. Surescripts recommends the use of unprintable characters as delimiters rather than the entire full set of character set (refer to Dynamic Delimiters Table below for an example list of acceptable characters).

For NCPDP transactions, the delimiter set is defined within the UNA segment. The UNA segment is a fixed width segment where the creator can define single character segment delimiters based off the location in the segment. The following is an example:

UNA:+./*′

Based on the position in this segment, the receiver knows the defined delimiters for the current transaction. The delimiters in this example are defined as:

: Component Data Element separator,

+ Data Element Separator,

. Decimal Notation,

/ Release Indicator,

′ Repetition Separator,

Segment Separator.

3.7.1.1 Choosing a Delimiter

Surescripts has published a list of allowed delimiters for the NCPDP SCRIPT transactions (refer to Appendix A: Dynamic Delimiters for a full list of acceptable characters). The participants may choose any allowed delimiter desired for the transactions that they create. However, it is important that participants communicate which delimiters they are using to ensure they will not cause issues with their trading partners' transactions.

3.7.1.2 Using Dynamic Delimiters

A Surescripts participant can expect to receive delimiters that are different than the set they define for their transactions. The participant needs to determine the delimiters dynamically when the transaction is processed according to the rules listed in the above section. Refer to Dynamic Delimiters for an example list of acceptable characters.

3.7.2 EDIFACT Delimiter Examples

The delimiters used in the examples below are the ˜ for segment separation and the + for element separation.

### Example 1

PTT++19440605+JAMES:TINA+F˜

Element 1 is not included; therefore, the plus signs (+) act as placeholders for the omitted elements. When data elements are omitted from the end of a segment, the data element delimiters do not need to be used. The segment is ended with a segment terminator.

### Example 2

Elements 5 and 6 can be omitted in the same segment as Example 1 The new segment would become:

PTT++19440605+JAMES:TINA+F˜ This is the incorrect representation:

PTT++19440605+JAMES:TINA+F+++˜

### Example 3

ABC+ABC01+ABC02+ABC03+ABC04+ABC05+ABC06˜

If elements ABC02 and ABC03 are not used then no value should be sent.

However, the elements must be represented with a place holder because there are used elements (ABC04, 05 and 06) after them.

This is the correct representation: ABC+ABC01+++ABC04+ABC05+ABC06˜

ABC02 and ABC03 must be represented so that it is known that the next data value is ABC04. This is the incorrect representation: ABC+ABC01+ABC04+ABC05+ABC06˜

If the placeholders for ABC02 and ABC03 are removed, ABC04 would be mistaken for ABC02.

### Example 4

ABC+ABC01+ABC02+ABC03+ABC04+ABC05+ABC06˜

If elements ABC05 and ABC06 are not used then no value should be sent. When element 05 and 06 are located at the end of the segment there is no need to represent them.

This is the correct representation: ABC+ABC01+ABC02+ABC03+ABC04˜

This is the incorrect representation: ABC+ABC01+ABC02+ABC03+ABC04++˜

3.7.3 EDIFACT Representation

The following table lists the Field Type Notation used within the transactions:

Field Type Notation Table

| Type | NCPDP Notation |
|---|---|
| Alphanumeric | An |
| Numeric | N |

Note: Two periods (“..”) after the Field Type Notation are used to indicate a range.

If no periods are present, the number following the Field Type Notation signifies a mandatory length. For example: “an..3” means an alphanumeric with range from zero to three characters, “an3” means an alphanumeric with three characters required.

3.7.3.1 Character Set

The character set contains ASCII values 32—126, which include: Letters, upper and lower case (A to Z, a to z), Numerals Ø to 9, and Symbols ! ″ # $ % & ′ ( )* +, - . / : ; <=>?@[\] ̂ _ ′ {|}˜.

Unprintable characters, such as control characters, are not used within the field sets.

Defined unprintable characters are used as delimiters.

3.7.3.2 Requirement Designation

Segment Attributes

Segment Attributes Table

| Code | Description |
|---|---|
| M | Required/Mandatory - the segment must be used. |
| C | Situational/Conditional - the segment must be used if |
| | conditions are met. |

Element Attributes

Element Attributes Table

| Code | Description |
|---|---|
| M | Required/Mandatory - the element must be used. |
| C | Situational/Conditional - the element must be used if conditions are met. Some |
| | fields do not have specific conditions. Data should be sent if available. |
| | Where comments are “Not used by Surescripts”/“Not used for RTBC”, |
| | information will be passed on, but not used, by Surescripts for processing. |
| D | Dependent -the element is required or conditional based on the message type. |
| X | Not used, will be rejected if sent. |

Elements that are not used by NCPDP have been grayed out or removed from the transaction specifications. Note: Elements that are grouped together in a composite may be marked as mandatory; however, if the group itself is marked as conditional, then these are only required if you use the group.

In the example below, the Patient ID and qualifier are mandatory only if the Reference Number is sent.

Attributes Example Table

| | Element | | Data | |
|---|---|---|---|---|
| M/C | Number | Element Name | Type | Comments |
| C | PTT-050 | REFERENCE NUMBER | Repeats twice. | |
| M | PTT-050-01 | Reference Number | an . . . 35 | Patient ID |
| M | PTT-050-02 | Reference Qualifier | an . . . 3 | Qualifier for reference number. |
| | | | | For values, see the NCPDP External |
| | | | | Code List (X12 DE 128) |

3.8 Transaction Validation

Surescripts will certify that participants are in compliance with the transaction specifications outlined in this guide during implementation and will continue to validate once in production. To validate a transaction, Surescripts:
Validates the sender identification and password.
Validates the recipient identification.
Verifies that the sender and recipient are in agreement contractually to exchange information.
Validates the syntax of the transaction including field lengths, data types, number of repeats, required fields, and code values.

3.9 Failure Mode/Response Approach

Surescripts has identified different levels of failure for NCPDP-based transactions:
In instances where the sending participant sends to Surescripts a transaction that is unrecognizable, Surescripts will return an XML formatted NAK.
If an error occurs after the sender has been identified and validated, and the message has been determined to be an NCPDP message, an NCPDP ERROR message is returned.
If the recipient identifies an error, an ERROR message is created and passed through Surescripts.

Section 4 Message Definition

4.1 BENREQ—Real Time Benefit Check Request

This message is sent from the prescriber to the PBM to determine whether a specified drug is on formulary, what coverage factors apply, and the estimated patient costs. The response is the message BENRES. Segments used for BENREQ include the following:

4.1.1 BENREQ—see BENREQ Segment Table. Request from a prescriber system to PBM.

4.2 BENRES—Real Time Benefit Check Response

This message is sent from the PBM to the prescriber system in response to the request for benefit information.

4.2.1 BENRES—See BENRES Transaction Segment Table. Response Coming from the PBM to Prescriber System.

Example Layout: RES, PVD Requesting Prescriber, PVD Pharmacy, PTT

Patient, COO Coordination of Benefits, DRU Requested Drug, FRM Formulary and Pricing Information for Requested Drug, ALN Alternative Drug #1 for Requested Drug, FRM Formulary and Pricing Information for Alternative Drug #1, ALN

Alternative Drug #2 for Requested Drug, FRM Formulary and Pricing Information for Alternative Drug #2.

4.3 Error Message

The Error message is sent to indicate an error has occurred. A synchronous error is sent in response to a message before breaking the communication connection.

4.3.1 Error

Error Table

| | | | Max | |
|---|---|---|---|---|
| Segment | Segment Description | M/C | Repeats | Description |
| UNA | Service String Advice | M | 1 | Must be present on all transactions in this |
| | | | | implementation usage. Is a fixed-length |
| | | | | segment. |
| UIB | Interactive Interchange | M | 1 | Designates sender and receiver IDs, trace |
| | Control Header | | | numbers, date, time stamps at the interchange |
| | | | | level. |
| UIH | Interactive Message | M | 1 | Designates the type of message. For an |
| | Header | | | Error, Message function = ERROR. Also |
| | | | | indicates trace numbers at the message level. |
| STS | Status Segment | M | 1 | Indicates the error message of an earlier |
| | | | | transaction. |
| UIT | Interactive Message | M | 1 | Designates the message trace number and |
| | Trailer | | | number of segments in the message. |
| UIZ | Interactive Interchange | M | 1 | Designates the interchange trace number and |
| | Trailer | | | the number of messages in the transaction. |

4.4 Status Message

The Status message is an NCPDP transaction that indicates the acceptance of the request. In the RTBC transaction flow a Status message is used in the case of an error in the response from the PBM. Because the PBM is responding with an invalid message a new Error message is initiated to the PBM. The PBM will then need to respond to the Error message with a Status message. This message is used to communicate the data content status of a transaction. Segments used for Status include:

4.4.1 STATUS

Status Segment Table

| | | | Max | |
|---|---|---|---|---|
| Segment | Segment Description | M/C | Repeats | Description |
| UNA | Service String Advice | M | 1 | Must be present on all transactions in this |
| | | | | implementation usage. Is a fixed-length |
| | | | | segment. |
| UIB | Interactive Interchange | M | 1 | Designates sender and receiver IDs, trace |
| | Control Header | | | numbers, date, time stamps at the interchange |
| | | | | level. |
| UIH | Interactive Message | M | 1 | Designates the type of message. |
| | Header | | | For Status, Message function = STATUS. |
| | | | | Also indicates trace numbers at the message |
| | | | | level. |
| STS | Status Segment | M | 1 | Indicates the status of an earlier message. |
| UIT | Interactive Message | M | 1 | Designates the message trace number and |
| | Trailer | | | number of segments in the message. |
| UIZ | Interactive Interchange | M | 1 | Designates the interchange trace number and the |
| | Trailer | | | number of messages in the transaction. |

Section 5 Segment Details

Please refer to Section 3.7.3.2 for Requirement Designation.

5.1 UNA—Service String Advice Segment

The UNA EDIFACT segment is a fixed-length segment. This segment determines the delimiters for the transaction which follows. The participant should use the values of each separator as defined below. The values defined below are in decimal representation with the Hex value in parenthesis. Please refer to section 3.7.1 for EDIFACT Dynamic Delimiters.

Service String Advice Segment Table

| | Element | | Data | |
|---|---|---|---|---|
| M/C | Number | Element Name | Type | Comments |
| M | UNA-000 | SEGMENT TAG | | |
| M | UNA-000-01 | Segment Code | a3 | Segment ID |
| | | | | Recommended Value: UNA |
| M | UNA-010 | DELIMITERS | | |
| M | UNA-010-01 | Component Data Element | an1 | Recommended Values: |
| | | Separator | | Dec (28) |
| | | | | Hex (1C) |
| M | UNA-010-02 | Data Element Separator | an1 | Recommended Values: |
| | | | | Dec(29) |
| | | | | Hex (1D) |
| M | UNA-010-03 | Decimal Notation | an1 | Decimal Point |
| | | | | Recommended Values: |
| | | | | Dec (46) |
| | | | | Char (.) |
| | | | | Hex (2E) |
| M | UNA-010-04 | Release Indicator | an1 | Space |
| | | | | Recommended Values: |
| | | | | Dec (32) |
| | | | | Hex (20) |
| M | UNA-010-05 | Repetition Separator | an1 | Recommended Values: |
| | | | | Dec (31) |
| | | | | Hex (1F) |
| M | UNA-010-06 | Segment Separator | an1 | Recommended Values: |
| | | | | Dec (30) |
| | | | | Hex (1E) |

5.2 UIB—Interactive Interchange Control Header Segment

The UIB EDIFACT segment designates sender and receiver identifiers, trace numbers, dates and timestamps at the interchange level.

Interactive Interchange Control Header Segment Table

| | Element | | Data | |
|---|---|---|---|---|
| M/C | Number | Element Name | Type | Comments |
| M | UIB-000 | SEGMENT TAG | | |
| M | UIB-000-01 | Segment Code | a3 | Segment ID |
| | | | | Value: UIB |
| M | UIB-010 | SYNTAX IDENTIFIER | | |
| M | UIB-010-01 | Syntax Identifier | a4 | Value: UNOA |
| M | UIB-010-02 | Syntax Version Number | an1 | Value: 0 |
| X | UIB-010-03 | Service Code Directory Version Number | | |
| X | UIB-010-04 | Service Code Directory Controlling | | |
| | | Agency | | |
| X | UIB-020 | DIALOGUE REFERENCE | | |
| M | UIB-030 | TRANSACTION REFERENCE | | |
| M | UIB-030-01 | Transaction Control Reference | an . . . 35 | A minimum set of standards/algorithms |
| | | | | should be used when generating |
| | | | | MessageIDs to ensure uniqueness. If |
| | | | | possible, participants should utilize Global |
| | | | | Unique Identifiers (GUIDs). |
| D | UIB-030-02 | Initiator Reference Identifier | an . . . 35 | For STATUS and ERROR if the version |
| | | | | setup is for 10.6 then this field is mandatory |
| | | | | and used to link the original message (value |
| | | | | in UIB-030-01) to the response. If the |
| | | | | version setup is for 8.1 then use the UIH- |
| | | | | 030-01 instead. |
| | | | | For BENRES refer to field UIH-030-01. |
| C | UIB-030-03 | Controlling Agency, Coded | an . . . 3 | |
| X | UIB-040 | SCENARIO IDENTIFIER | | |
| X | UIB-050 | DIALOGUE IDENTIFIER | | |
| M | UIB-060 | INTERCHANGE SENDER | | |
| M | UIB-060-01 | Sender ID - Level One | an . . . 35 | This field contains the identification |
| | | | | number of the sender. This field is used in |
| | | | | conjunction with UIB-060-02 Level One |
| | | | | Code Qualifier, which qualifies which ID |
| | | | | was used. |
| | | | | Will contain the Participant ID assigned by |
| | | | | Surescripts. |
| | | | | For request transactions this will contain |
| | | | | Prescriber Vendor ID assigned by |
| | | | | Surescripts. |
| | | | | For response transactions this will contain, |
| | | | | the PBM/payer ID assigned by Surescripts. |
| M | UIB-060-02 | Level One ID Code Qualifier | an . . . 4 | Values: |
| | | | | ZZZ = Mutually defined (Participant ID) |
| M | UIB-060-03 | Sender ID - Level Two | an . . . 35 | Sender Password |
| C | UIB-060-04 | Sender ID - Level Three | an . . . 35 | Not used for RTBC. |
| M | UIB-070 | INTERCHANGE RECIPIENT | | |
| M | UIB-070-01 | Recipient ID - Level One | an . . . 35 | This field contains the identification |
| | | | | number of the recipient for either the |
| | | | | request or response transaction. This field |
| | | | | is used in conjunction with UIB- |
| | | | | 070-02 Level One Code Qualifier, which |
| | | | | qualifies which ID was used. |
| | | | | For request transactions this will contain a |
| | | | | Payer/PBM ID assigned by Surescripts. |
| | | | | For response transactions this will |
| | | | | contain the Prescriber/Participant ID |
| | | | | assigned by Surescripts. |
| M | UIB-070-02 | Level One ID Code Qualifier | an . . . 4 | Value: |
| | | | | ZZZ = Mutually Defined (Participant ID) |
| C | UIB-070-03 | Recipient ID - Level Two | an . . . 35 | Not used by Surescripts. |
| C | UIB-070-04 | Recipient ID - Level Three | an . . . 35 | Not used by Surescripts. |
| M | UIB-080 | DATE/TIME OF INITIATION | | The local date and time the message was |
| | | | | sent. |
| M | UIB-080-01 | Date | n8 | Current Date format is - CCYYMMDD |
| M | UIB-080-02 | Event Time | n8 | Current Time format is - HHMMSS, S. |
| | | | | Seconds must be included, but |
| | | | | fractional seconds are not required. |
| X | UIB-080-03 | Time Offset | | |
| X | UIB-090 | DUPLICATOR INDICATOR | | |
| C | UIB-100 | Test Indicator | n1 | Must match platform that message is |
| | | | | being sent to. |
| | | | | Values: |
| | | | | 1 = Test |
| | | | | All other values = Live (Production) |
| | | | | If this field is not sent then the default is |
| | | | | production. |

5.3 UIH—Interactive Message Header Segment

Designates the type of message. Also indicates trace numbers at the message level.

Interactive Message Header Segment Table

| | Element | | Data | |
|---|---|---|---|---|
| M/C | Number | Element Name | Type | Comments |
| M | UIH-000 | SEGMENT TAG | | |
| M | UIH-000-01 | Segment Code | a3 | Segment ID |
| | | | | Value: UIH |
| M | UIH-010 | INTERACTIVE MESSAGE | | |
| | | IDENTIFIER | | |
| M | UIH-010-01 | Message Type | an . . . 6 | Values: |
| | | | | BENCON |
| | | | | SCRIPT - Used only for ERROR and |
| | | | | STATUS messages |
| M | UIH-010-02 | Message Version Number | an . . . 3 | Values: |
| | | | | 001 = BENCON Version Number |
| | | | | 008, or 010 = SCRIPT Version Number |
| | | | | (Used only for ERROR and |
| | | | | STATUS messages) |
| M | UIH-010-03 | Message Release Number | an . . . 3 | Values: |
| | | | | 001 = BENCON Release Number |
| | | | | 001, or 006 = SCRIPT Release Number |
| | | | | (Used only for ERROR and |
| | | | | STATUS messages) |
| M | UIH-010-04 | Message Function | an . . . 6 | Values: |
| | | | | BENREQ |
| | | | | BENRES |
| | | | | STATUS |
| | | | | ERROR |
| X | UIH-010-05 | Controlling Agency, Coded | | |
| C | UIH-010-06 | Association Assigned Code | an . . . 6 | Not used for RTBC. |
| C | UIH-020 | MESSAGE REFERENCE | an . . . 35 | Not used for RTBC. |
| | | NUMBER | | |
| D | UIH-030 | DIALOGUE REFERENCE | | |
| D | UIH-030-01 | Initiator Control Reference | an . . . 35 | For BENRES this field is mandatory and |
| | | | | used to link the original message (value in |
| | | | | UIB-030-01) to the response. |
| | | | | For STATUS and ERROR if the version |
| | | | | setup is for 8.1 then this field is mandatory |
| | | | | and used to link the original message (value |
| | | | | in UIB-030-01) to the response. If the |
| | | | | version setup is for 10.6 then use the UIB- |
| | | | | 030-02 instead. |
| X | UIH-040 | STATUS OF TRANSFER INTERACTIVE | | |
| C | UIH-050 | DATE/TIME OF INITIATION | | Not used by Surescripts. |
| X | UIH-060 | TEST INDICATOR | n1 | UIB-100 Test Indicator is utilized to |
| | | | | indicate test and prod. |

5.4 REQ—Request Segment

The REQ segment includes the 90 Days at Retail request.

Request Segment Table

| | Element | | Data | |
|---|---|---|---|---|
| M/C | Number | Element Name | Type | Comments |
| M | REQ-000 | SEGMENT TAG | | |
| M | REQ-000-001 | Segment Code | an3 | Segment ID |
| | | | | Value: REQ |
| M | REQ-010 | Message Function, coded | an . . . 3 | Value: |
| | | | | 90R = 90 Days at Retail Requested |
| X | REQ-020 | Code List Qualifier | an . . . 3 | |
| X | REQ-030 | Reference Number | an . . . 35 | |
| X | REQ-040 | Sender Identification - Level 2 | an . . . 35 | |
| X | REQ-050 | Sender Identification - Level 2 | an . . . 35 | |

5.5 RES—Response Segment

This segment allows the PBM to indicate to the prescriber system whether the request was successfully processed or denied.

Response Segment Table

| | Element | | Data | |
|---|---|---|---|---|
| M/C | Number | Element Name | Type | Comments |
| M | RES-000 | SEGMENT TAG | | |
| M | RES-000-01 | Segment Code | a3 | Segment ID |
| | | | | Value: RES |
| M | RES-010 | RESPONSE TYPE, CODED | an . . . 3 | Values: |
| | | | | P = Processed. Responder attempted to find |
| | | | | Alternatives. |
| | | | | PNA = Processed, No Alternatives. |
| | | | | Responder did not attempt to find |
| | | | | alternatives. |
| | | | | D = Denied |
| | | | | NF = Not Found |
| | | | | NP = Not Processed. Drug requested was |
| | | | | not processed. |
| X | RES-020 | Code List Qualifier | an . . . 3 | Not used for RTBC. |
| X | RES-030 | Reference Number | an . . . 35 | Not used for RTBC. |
| C | RES-040 | Free Text | an . . . 70 | Message for Requester. |

5.6 STS—Transaction Status

Transaction Status Table

| | Element | | Data | |
|---|---|---|---|---|
| M/C | Number | Element Name | Type | Comments |
| M | STS-000 | SEGMENT TAG | | |
| M | STS-000-01 | Segment Code | a3 | Segment ID |
| | | | | Value: STS |
| M | STS-010 | STATUS TYPE CODE | an . . . 3 | Status |
| | | | | 010 = Successfully accepted by ultimate |
| | | | | receiver |
| | | | | Error |
| | | | | Codes used to relay rejected |
| | | | | communications. |
| | | | | 600 = Communication problem - try |
| | | | | again later |
| | | | | 601 = Receiver unable to process - do not |
| | | | | retry |
| | | | | 602 = Receiver System Error - try again |
| | | | | later |
| | | | | 900 = Transaction rejected - do not retry |
| C | STS-020 | CODE LIST QUALIFIER | an . . . 3 | Repeats up to 10 times. |
| | | | | Reject Codes used by responder who takes |
| | | | | responsibility for the transaction. A complete |
| | | | | list can be found in the NCPDP External |
| | | | | Code List (X12 DE 1131 Reject Code STS |
| | | | | Segment). |
| | | | | Additional values (Error codes 343-475) |
| | | | | were added which are also in NCPDP |
| | | | | published schema. Refer to the newer |
| | | | | NCPDP External code list which will |
| | | | | provide definitions for these new codes. |
| C | STS-030 | FREE TEXT | 70 | Description of Error(s) |

5.7 PVD—Prescriber Segment

One loop is required for the prescriber.

Prescriber Segment Table

| | Element | | Data | |
|---|---|---|---|---|
| M/C | Number | Element Name | Type | Comments |
| M | PVD-000 | SEGMENT TAG | | |
| M | PVD-000-01 | Segment Code | a3 | Segment ID |
| | | | | Value: PVD |
| M | PVD-010 | PROVIDER CODE | an . . . 3 | Value: PC = Prescriber |
| M | PVD-020 | REFERENCE NUMBER | Repeats up to 3 times | |
| | | | M for BENREQ | |
| | | | C for BENRES | |
| | | | For the RTBC Request, at least one occurrence must | |
| | | | contain the individual (not organizational) NPI of the | |
| | | | prescriber. | |
| | | | When present, the NPI will be validated against the | |
| | | | check digit routine for the requesting physician. For | |
| | | | specific information see | |
| | | | http://www.cms.gov/NationalProvIdentStand/Downloads/NPIcheckdigit.pdf | |
| M | PVD-020-01 | Reference Number | an . . . 35 | Reference number for the prescriber. |
| M | PVD-020-02 | Reference Qualifier | an . . . 3 | Qualifier for reference number. A |
| | | | | complete list can be found in the NCPDP |
| | | | | External Code List (X12 DE 128). |
| X | PVD-030 | HEALTHCARE SERVICE LOCATION | | |
| C | PVD-040 | PROVIDER SPECIALTY | | |
| M | PVD-040-01 | Agency Qualifier, coded | an . . . 3 | Values: |
| | | | | AM = American Medical Association |
| | | | | DE = Drug Enforcement Agency |
| | | | | DR = National Wholesale Druggist |
| | | | | Association |
| | | | | HC = HCFA |
| M | PVD-040-02 | Provider Specialty, coded | an . . . 3 | If value of “AM” is used as the Agency |
| | | | | Qualifier, refer to NCPDP External Code |
| | | | | List (X12 DE 1222). |
| C | PVD-050 | NAME | Prescriber Name | |
| C | PVD-050-01 | Party Name | an . . . 35 | Last Name |
| C | PVD-050-02 | First Name | an . . . 35 | First Name |
| C | PVD-050-03 | Middle Name | an . . . 35 | Middle Name |
| C | PVD-050-04 | Suffix | an . . . 10 | Suffix |
| C | PVD-050-05 | Prefix | an . . . 10 | Prefix |
| X | PVD-060 | POSTCODE IDENTIFICATION | | |
| C | PVD-070 | PARTY NAME | an . . . 35 | Clinic Name |
| C | PVD-080 | ADDRESS | | |
| C | PVD-080-01 | Street and Number/PO Box | an . . . 35 | Address Line 1 |
| C | PVD-080-02 | City Name | an . . . 35 | |
| C | PVD-080-03 | State | an . . . 9 | |
| C | PVD-080-04 | Postal Code | an . . . 11 | |
| C | PVD-080-05 | Place/Location Qualifier | an . . . 3 | Agreement between trading partners |
| | | | | “AD2” should be used for address line 2. |
| C | PVD-080-06 | Place Location | an . . . 35 | Address Line 2 |
| C | PVD-090 | COMMUNICATION NUMBER | Repeats > 1 | |
| C | PVD-090-01 | Communication Number | an . . . 80 | |
| C | PVD-090-02 | Code List Qualifier | an . . . 3 | A complete list can be found in the |
| | | | | NCPDP External Code List (X12 DE |
| | | | | 365). |
| C | PVD-100 | NAME | This composite is used to identify the Designated | |
| | | | Agent - use for transmitter/submitter name. (If present, | |
| | | | first name and last name are recommended by | |
| | | | Surescripts). | |
| C | PVD-100-01 | Party Name | an . . . 35 | Last Name |
| C | PVD-100-02 | First Name | an . . . 35 | First Name |
| C | PVD-100-03 | Middle Name | an . . . 35 | Middle Name |
| C | PVD-100-04 | Suffix | an . . . 10 | Suffix |
| C | PVD-100-05 | Prefix | an . . . 10 | Prefix |

5.8 PVD—Pharmacy Segment

One loop will be sent for the pharmacy where the script is intended to be filled. One loop will be returned for the pharmacy where the script is intended to be filled.

Pharmacy Segment Table

| | Element | | Data | |
|---|---|---|---|---|
| M/C | Number | Element Name | Type | Comments |
| M | PVD-000 | SEGMENT TAG | | |
| M | PVD-000-01 | Segment Code | a3 | Segment ID |
| | | | | Value: PVD |
| M | PVD-010 | PROVIDER CODE | an . . . 3 | Value: P2 = Pharmacy |
| M | PVD-020 | REFERENCE NUMBER | Repeats up to 3 times. | |
| M | PVD-020-01 | Reference Number | an . . . 35 | NCPDP Provider ID and or NPI. |
| M | PVD-020-02 | Reference Qualifier | an . . . 3 | D3 - Recommended by Surescripts |
| | | | | (NCPDP Provider, formerly known as |
| | | | | NABP) |
| | | | | Qualifier for reference number. A complete |
| | | | | list can be found in the NCPDP External |
| | | | | Code List (X12 DE 128). |
| X | PVD-030 | HEALTHCARE SERVICE LOCATION | | |
| X | PVD-040 | PROVIDER SPECIALTY | | Not used for Pharmacy segment. |
| C | PVD-050 | NAME | Pharmacist Name | |
| C | PVD-050-01 | Party Name | an . . . 35 | Last Name |
| C | PVD-050-02 | First Name | an . . . 35 | First Name |
| C | PVD-050-03 | Middle Name | an . . . 35 | Middle Name |
| C | PVD-050-04 | Suffix | an . . . 10 | Suffix |
| C | PVD-050-05 | Prefix | an . . . 10 | Prefix |
| X | PVD-060 | POSTCODE IDENTIFICATION | | |
| C | PVD-070 | PARTY NAME | an . . . 35 | Pharmacy Name |
| C | PVD-080 | ADDRESS | | |
| C | PVD-080-01 | Street and Number/PO Box | an . . . 35 | Address Line 1 |
| C | PVD-080-02 | City Name | an . . . 35 | |
| C | PVD-080-03 | State | an . . . 9 | |
| C | PVD-080-04 | Postal Code | an . . . 11 | |
| C | PVD-080-05 | Place/Location Qualifier | an . . . 3 | Agreement between trading partners |
| | | | | “AD2” should be used for address line 2 |
| C | PVD-080-06 | Place Location | an . . . 35 | Address Line 2 |
| C | PVD-090 | COMMUNICATION NUMBER | Repeat s > 1 | |
| C | PVD-090-01 | Communication Number | an . . . 80 | |
| C | PVD-090-02 | Code List Qualifier | an . . . 3 | A complete list can be found in the |
| | | | | NCPDP External Code List (X12 DE |
| | | | | 365). |

| | | | |
|---|---|---|---|
| X | PVD-100 | NAME | Not used by NCPDP for Pharmacy segment. |

5.9 PTT—Patient Segment

Designates patient information.

Patient Segment Table

| | Element | | Data | |
|---|---|---|---|---|
| M/C | Number | Element Name | Type | Comments |
| M | PTT-000 | SEGMENT TAG | | |
| M | PTT-000-01 | Segment Code | a3 | Segment ID |
| | | | | Value: PTT |
| C | PTT-010 | RELATIONSHIP TO | an . . . 3 | Values: |
| | | CARDHOLDER | | 1 = Member |
| | | | | 2 = Spouse |
| | | | | 3 = Child/Dependent |
| | | | | 4 = Other |
| M | PTT-020 | DATE OF BIRTH | d8 | Birth date format is - CCYYMMDD. |
| M/ | Element | Element Name | Data | Comments |
| M | PTT-030 | NAME | Patient Name | |
| M | PTT-030-01 | Party Name | an . . . 35 | Last Name |
| M | PTT-030-02 | First Name | an . . . 35 | First Name |
| C | PTT-030-03 | Middle Name | an . . . 35 | Middle Name |
| C | PTT-030-04 | Suffix | an . . . 10 | Suffix |
| C | PTT-030-05 | Prefix | an . . . 10 | Prefix |
| M | PTT-040 | GENDER | an . . . 3 | Values: |
| | | | | M = Male |
| | | | | F = Female |
| | | | | U = Unknown |
| C | PTT-050 | REFERENCE NUMBER | Repeats 2 | |
| M | PTT-050-01 | Reference Number | an . . . 35 | Patient ID |
| C | PTT-050-02 | Reference Qualifier | an . . . 3 | A complete list can be found in the |
| | | | | NCPDP External Code List (X12 DE |
| | | | | 128). |
| C | PTT-060 | ADDRESS | | Postal Code and City Code |
| | | | | recommended by Surescripts |
| C | PTT-060-01 | Street and Number/PO Box | an . . . 35 | Address Line 1 |
| C | PTT-060-02 | City Name | an . . . 35 | |
| C | PTT-060-03 | State | an . . . 9 | Recommended by Surescripts - Used for |
| | | | | sales tax |
| C | PTT-060-04 | Postal Code | an . . . 11 | Recommended by Surescripts - Used for |
| | | | | sales tax |
| C | PTT-060-05 | Place/Location Qualifier | an . . . 3 | Trading partner defined value |
| | | | | “AD2” should be used for address line 2 |
| C | PTT-060-06 | Place Location | an . . . 35 | Address Line 2 |
| C | PTT-070 | COMMUNICATION NUMBER | Repeats > 1 | |
| C | PTT-070-01 | Communication Number | an . . . 80 | Patient telephone number |
| C | PTT-070-02 | Code List Qualifier | an . . . 3 | A complete list can be found in the |
| | | | | NCPDP External Code List (X12 DE |
| | | | | 128). |

5.10 COO—Coordination of Benefits Segment

Designates the patient's prescription coverage.

Coordination of Benefits Segment Table

| | Element | | Data | |
|---|---|---|---|---|
| M/C | Number | Element Name | Type | Comments |
| M | COO-000 | SEGMENT TAG | | |
| M | COO-000-01 | Segment Code | a3 | Segment ID |
| | | | | Value: COO |
| C | COO-010 | REFERENCE NUMBER | | |
| M | COO-010-01 | Reference Number | an . . . 35 | ISA13 value from the most recent 271 |
| | | | | eligibility response for the patient |
| C | COO-010-02 | Reference Qualifier | an . . . 3 | Qualifier identifying the Reference |
| | | | | Number. |
| | | | | Value: |
| | | | | ZZ = Specify Mutually Defined when |
| | | | | identifying the ISA13 value. |
| C | COO-020 | PARTY NAME | an . . . 35 | Payer Name |
| X | COO-030 | SERVICE TYPE CODE | | |
| C | COO-040 | REFERENCE NUMBER | | |
| M | COO-040-01 | Reference Number | an . . . 35 | Cardholder ID |
| X | COO-040-02 | Reference Qualifier | an . . . 3 | |
| C | COO-050 | NAME | an . . . 35 | Cardholder Name (Last Name, First |
| | | | | Name) |
| C | COO-060 | REFERENCE NUMBER | an . . . 35 | Group Number/Carrier |
| X | COO-070 | PARTY NAME | an . . . 35 | Group Name |
| X | COO-080 | ADDRESS | | |
| X | COO-090 | DATE | | |
| X | COO-100 | INSURANCE TYPE, CODED | | |
| X | COO-110 | ADDRESS | | |
| X | COO-120 | REFERENCE NUMBER | | |
| X | COO-130 | CONDITION/RESPONSE | an . . . 3 | Patient Consent Indicator |
| | | CODED | | |
| M | COO-140 | PATIENT IDENTIFIER | an . . . 80 | PBM unique member ID |
| | | | | (Required by Surescripts) |

5.11 DRU—Drug Segment

Only one drug allowed per request. Drug returned from request.

Drug Segment Table

| | Element | | Data | |
|---|---|---|---|---|
| M/C | Number | Element Name | Type | Comments |
| M | DRU-000 | SEGMENT TAG | | |
| M | DRU-000-01 | Segment Code | a3 | Segment ID |
| | | | | Value: DRU |
| M | DRU-010 | DRUG | | |
| M | DRU-010-01 | Item Description identification | an . . . 7 | Value: |
| | | | | R = Requested |
| M | DRU-010-02 | Item Description | an . . . 35 | Drug Name. |
| | | | | The self-contained full drug name, |
| | | | | strength, and form. |
| | | | | May be abbreviated to fit the |
| | | | | information in 35 or less bytes. |
| M | DRU-010-03 | Item Number | an . . . 35 | Drug number (11 Digit Representative |
| | | | | NDC) |
| M | DRU-010-04 | Code List Responsibility Agency | an . . . 3 | Value: |
| | | | | ND = NDC11 |
| C | DRU-010-05 | Code List Qualifier | an . . . 3 | Drug Form. |
| | | | | A complete list can be found in the |
| | | | | NCPDP External Code List (X12 DE |
| | | | | 1330). |
| C | DRU-010-06 | Free Text | an . . . 70 | Drug Strength - Measurement Value |
| C | DRU-010-07 | Code List Qualifier | an . . . 3 | Unit or Basis for Measurement Code. A |
| | | | | complete list can be found in the |
| | | | | NCPDP External Code List (X12 DE |
| | | | | 355). |
| C | DRU-010-08 | Reference Number | an . . . 35 | Drug Database Code |
| C | DRU-010-09 | Reference Qualifier | an . . . 3 | Code value to define the reference |
| | | | | number. |
| | | | | Values: |
| | | | | E = Medical Economic GFC |
| | | | | G = Medical Economic GM |
| | | | | FG = First DataBank GCN Seq # |
| | | | | FS = First DataBank SmartKey |
| | | | | MC = Multum Drug ID |
| | | | | MD = Medi-Span DDID |
| | | | | MG = Medi-Span GPI |
| | | | | MM = Multum MMDC |
| C | DRU-010-10 | Item Description | an . . . 35 | Drug name |
| | | | | If the full drug name, strength, form does |
| | | | | not fit in 010-02 without abbreviation, |
| | | | | level 10-12 are to be used for the full |
| | | | | name, strength, form. |
| C | DRU-010-11 | Item Description | an . . . 35 | Drug name |
| C | DRU-010-12 | Item Description | an . . . 35 | Drug name |
| M | DRU-020 | QUANTITY | | |
| M | DRU-020-01 | Quantity Qualifier | an . . . 3 | Unit or Basis for Measurement Code. A |
| | | | | complete list can be found in the NCPDP |
| | | | | External Code List (X12 DE |
| | | | | 355). |
| M | DRU-020-02 | Quantity | an . . . 35 | |
| M | DRU-020-03 | Code List Qualifier | an . . . 3 | Value: |
| | | | | 38 = Original Qty |
| C | DRU-030 | DIRECTIONS | | |
| X | DRU-030-01 | Dosage ID | | Future use. Has not been codified yet. |
| C | DRU-030-02 | Dosage | an . . . 70 | SIG instructions. Dosage - Free Text |
| C | DRU-030-03 | Dosage | an . . . 70 | SIG instructions. Dosage - Free Text |
| C | DRU-040 | DATE | Repeats up to 5 times. | |
| M | DRU-040-01 | Date/time period qualifier | an . . . 3 | Qualification of Date/Time field 2380. |
| | | | | X-12 DE 432. |
| | | | | 85 = Date Issued (Written Date) |
| | | | | 07 = Effective Date (Begin) |
| | | | | 36 = Expiration Date (End) |
| | | | | PE = Period End |
| | | | | LD = Last Demand (Last Fill) |
| | | | | ZDS = Days Supply (At least one |
| | | | | occurrence must be Days |
| | | | | Supply) |
| | | | | 35 = Delivered on This Date (Date |
| | | | | prescription received at facility) |
| | | | | BE = Validated (Date reviewed at |
| | | | | facility) |
| M | DRU-040-02 | Date or Quantity | an . . . 35 | Required if DRU-040-01 provided |
| M | DRU-040-03 | Date/Time Period format | an . . . 3 | Defines the date format used. |
| | | qualifier | | UN/EDIFACT element |
| | | | | Values: |
| | | | | 102 = Date CCYYMMDD |
| | | | | 203 = Date CCYYMMDDHHMM |
| | | | | 804 = Quantity of Days |
| C | DRU-050 | PRODUCT/SERVICE | an . . . 3 | Values: |
| | | SUBSTITUTION, CODED | | 0 = No product selection indicated |
| | | | | 1 = Substitution not allowed by |
| | | | | prescriber |
| | | | | 2 = Substitution allowed - patient |
| | | | | requested product dispensed |
| | | | | 3 = Substitution allowed - pharmacist |
| | | | | selected product dispensed |
| | | | | 4 = Substitution allowed - generic drug not |
| | | | | in stock |
| | | | | 5 = Substitution allowed - brand drug |
| | | | | dispensed as a generic |
| | | | | 7 = Substitution not allowed - brand |
| | | | | drug mandated by law |
| | | | | 8 = Substitution allowed - generic drug not |
| | | | | available in marketplace |
| | | | | (6 and 9 intentionally left off) |
| X | DRU-060 | QUANTITY | Repeats twice. | |
| C | DRU-070 | DIAGNOSIS | Repeats up to two times. | |
| M | DRU-070-01 | Clinical Information Qualifier | an . . . 3 | Values: |
| | | | | 1 = Prescriber |
| | | | | 2 = Pharmacy inferred |
| M | DRU-070-02 | Clinical Information - Primary | an . . . 17 | The prescriber supplied or pharmacy |
| | | | | inferred code for the diagnosis. |
| C | DRU-070-03 | Code List Qualifier | an . . . 3 | Qualifies the code list used for the |
| | | | | Diagnosis. |
| | | | | Values: |
| | | | | M = Medi-Span |
| | | | | F = First DataBank |
| | | | | E = Medical Economics |
| | | | | DX = ICD9 |
| | | | | ABF = ICD10 |
| C | DRU-070-04 | Clinical Information - Secondary | an . . . 17 | Diagnosis Code |
| C | DRU-070-05 | Code List Qualifier | an . . . 3 | Values: |
| | | | | DX = ICD9 |
| | | | | ABF = ICD10 |
| C | DRU-080 | REFERENCE NUMBER | | |
| M | DRU-080-01 | Reference Number | an . . . 35 | This number is used to store the |
| | | | | Prescription Number of the prescribing |
| | | | | system. |
| C | DRU-080-02 | Reference Qualifier | an . . . 3 | A complete list can be found in the |
| | | | | NCPDP External Code List (X12 DE |
| | | | | 128). |
| C | DRU-090 | FREE TEXT | an . . . 70 | Repeats up to 3 times. |
| | | | | Comments to Pharmacist. |
| C | DRU-100 | DRUG USE EVALUATION | Repeat up to 5 times. Conditional repeating | |
| | | | composite for further explanation, conflict, or | |
| | | | clarification of services related to drug use | |
| | | | evaluation. | |
| C | DRU-100-01 | DUE Reason for Service Code | an . . . 2 | Code identifying the type of conflict |
| | | | | detected. |
| | | | | When this composite is used, DUE |
| | | | | Reason For Service Code is |
| | | | | mandatory. |
| | | | | When the DUE Reason For Service Code |
| | | | | is sent from the prescriber to the |
| | | | | pharmacist, the DUE Result Of |
| | | | | ServiceCode is mandatory. |
| | | | | When the DUE Reason For Service Code is |
| | | | | sent from the pharmacist to the prescriber, |
| | | | | the DUE Result Of Service code is |
| | | | | conditional. |
| | | | | This field uses the appropriate values |
| | | | | from the Reason For Service Code in |
| | | | | NCPDP |
| | | | | Data Dictionary. See NCPDP Data |
| | | | | Dictionary for values. |
| C | DRU-100-02 | DUE Professional Service Code | an . . . 2 | Code identifying intervention performed |
| | | | | when a conflict has been detected. |
| | | | | This field uses the appropriate values |
| | | | | from the Professional Service Code in |
| | | | | NCPDP |
| | | | | Data Dictionary. See NCPDP Data |
| | | | | Dictionary for values. |
| C | DRU-100-03 | DUE Result of Service Code | an . . . 2 | Action taken in response to a conflict. |
| | | | | This field uses the appropriate values |
| | | | | from the Result of Service Code in the |
| | | | | NCPDP Data Dictionary. See NCPDP |
| | | | | Data Dictionary for values. |
| C | DRU-100-04 | DUE Co-Agent ID | an . . . 19 | Identifies the co-existing agent |
| | | | | contributing to the DUR event (drug or |
| | | | | disease) conflicting with the prescribed |
| | | | | drug. |
| | | | | When DUE Co-Agent ID is used, the |
| | | | | DUE Co-Agent ID Qualifier must be |
| | | | | present. |
| C | DRU-100-05 | DUE Co-Agent ID Qualifier | an . . . 2 | Code qualifying the value in DUE Co- |
| | | | | Agent ID. |
| | | | | When DUE Co-Agent ID Qualifier is |
| | | | | sent, the DUE Co-Agent ID must be |
| | | | | present. |
| | | | | This field uses the appropriate values from |
| | | | | the DUR Co-Agent Qualifier in the NCPDP |
| | | | | Data Dictionary. See NCPDP Data |
| | | | | Dictionary for values. |
| X | DRU-110 | DRUG COVERAGE STATUS | an2 | Not used for RTBC. |
| | | CODE | | |

5.12 FRM—Formulary Segment

Formulary and pricing information for the drug requested. One loop is required if response code is P for processed or PNA for Processed, No Alternatives. This FRM table is for both occurrences of the FRM segment and response.

Formulary Segment Table

| | Element | | Data | |
|---|---|---|---|---|
| M/C | Number | Element Name | Type | Comments |
| M | FRM-000 | SEGMENT TAG | | |
| M | FRM-000-01 | Segment Code | a3 | Segment ID |
| | | | | Value = FRM |
| M | FRM-010 | PHARMACY TYPE | an1 | Values: |
| | | | | M = Mail Order |
| | | | | R = Retail |
| | | | | 9 = Retail 90 Days |
| M | FRM-020 | DRUG STATUS CODE | an..2 | Values: |
| | | | | NC = Not Covered (Not Reimbursable) |
| | | | | Note: Not used for the FRM segment |
| | | | | following the ALN segment. |
| | | | | CR = Covered with Restrictions |
| | | | | CV = Covered |
| C | FRM-030 | COVERAGE | | Repeats up to five times. |
| | | | | Must be used if Coverage Status = CR |
| C | FRM-030-01 | Coverage Reference Code | an..2 | Must be used if Coverage Status = CR |
| | | | | Values: |
| | | | | AL = Age Limits |
| | | | | DE = Drug Exclusion |
| | | | | GL = Gender Limits |
| | | | | MN = Medical Necessity (for Formulary |
| | | | | 1.0 only) |
| | | | | PA = Prior Authorization |
| | | | | QL = Quantity Limits |
| | | | | RD = Resource Link—Drug-Specific Level |
| | | | | ST = Step Therapy |
| | | | | TM = Text Message |
| C | FRM-030-02 | Coverage Reference Text | an..200 | Instructions around the coverage |
| | | | | reference code FRM-030-01 |
| C | FRM-040 | FORMULARY STATUS | an..2 | Values: |
| | | | | U = Unknown |
| | | | | 0 = Not Reimbursable |
| | | | | 1 = Non Formulary |
| | | | | 2 = On Formulary (Not Preferred) |
| | | | | 3 = Preferred Level 1 |
| | | | | 4 = Preferred Level 2 |
| | | | | 5 = Preferred Level 3 |
| | | | | Preferred Levels up to 99 are allowed. |
| C | FRM-050 | COPAY | | This field is required if FRM-020 Drug |
| | | | | Status Code is CV for covered and FRM- |
| | | | | 060 Patient Pay Amount is blank. |
| | | | | If using the FRM-050 CoPay then one of |
| | | | | the following fields must be sent: FRM- |
| | | | | 050-01 & 02 CoPay Tier, FRM- |
| | | | | 050-03 Percent CoPay Rate, or FRM- |
| | | | | 050-04 Flat CoPay Amount. |
| C | FRM-050-01 | CoPay Tier | n..2 | This medication's Tier; an indication of |
| | | | | the cost to the patient. Lower values |
| | | | | represent lower cost to the patient (e.g., |
| | | | | Tier 1 is less costly to the patient than Tier 2) |
| | | | | This field is required if FRM-050-03 |
| | | | | Percent CoPay Rate and FRM-050-04 |
| | | | | Flat CoPay Amount are blank or if FRM- |
| | | | | 050-02 Maximum CoPay Tier is used. |
| C | FRM-050-02 | Maximum CoPay Tier | n..2 | Provides the range within which the |
| | | | | CoPay Tier is stated. The highest |
| | | | | CoPay tier within that range. |
| | | | | This field is required if FRM-050-03 |
| | | | | Percent CoPay Rate and FRM-050-04 |
| | | | | Flat CoPay Amount are blank or if |
| | | | | FRM-050-01 CoPay Tier is used. |
| C | FRM-050-03 | Percent CoPay Rate | n..10 | Percentage expressed as a decimal (e.g., |
| | | | | 0.0 through 1.0 represents 0% through 100%) |
| | | | | The length includes the decimal point. |
| | | | | This field is required if FRM-050-01 |
| | | | | CoPay Tier and FRM-050-04 Flat |
| | | | | CoPay Amount are blank |
| C | FRM-050-04 | Flat CoPay Amount | n..10 | No dollar sign. Decimal required if value |
| | | | | includes cents. Currency: USD |
| | | | | The length includes the decimal point. |
| | | | | This field is required if FRM-050-03 |
| | | | | Percent CoPay Rate and FRM-050-01 |
| | | | | CoPay Tier are blank |
| C | FRM-060 | PATIENT PAY AMOUNT | This field is required if FRM-020 Drug Status | |
| | | | Code is CV for Covered or CR for Covered with | |
| | | | Restrictions, and FRM-050 CoPay is blank. | |
| M | FRM-060-01 | Pay Amount | n..10 | Dollar amount |
| C | FRM-060-02 | Amount—Days supply | n..10 | This field is required if FRM-060-03 |
| | | | | Amount Quantity is blank. |
| C | FRM-060-03 | Amount—Quantity | n..10 | This field is required if FRM-060-02 |
| | | | | Amount Days Supply is blank. |

5.13 ALN—Alternative Drug Segment

An alternative drug for the drug requested. PBM/payers should send alternative drug requests back in the order in which they would like them displayed to the prescriber.

Alternative Drug Segment Table

| | Element | | Data | |
|---|---|---|---|---|
| M/C | Number | Element Name | Type | Comments |
| M | ALN-000 | SEGMENT TAG | | |
| M | ALN-000-01 | Segment Code | a3 | Segment ID |
| | | | | Value = ALN |
| M | ALN-010 | DRUG | | |
| X | ALN-010-01 | Item Description Identification | an..7 | |
| M | ALN-010-02 | Item Description | an..35 | Drug name |
| | | | | Is the self-contained full drug name, |
| | | | | strength, and form. May be abbreviated to |
| | | | | fit the information in 35 or less bytes. |
| M | ALN-010-03 | Item Number | an..35 | Drug number (11 Digit Representative NDC) |
| M | ALN-010-04 | Code List Responsibility Agency | an..3 | Value: |
| | | | | ND = NDC11 |
| C | ALN-010-05 | Code List Qualifier | an..3 | Drug Form. A complete list can be |
| | | | | found in the NCPDP External Code |
| | | | | List (X12 DE 1330). |
| C | ALN-010-06 | Free Text | an..70 | Drug Strength—Measurement Value |
| C | ALN-010-07 | Code List Qualifier | an..3 | Unit or Basis for Measurement Code. A |
| | | | | complete list can be found in the NCPDP |
| | | | | External Code List (X12 DE 355). |
| C | ALN-010-08 | Reference Number | an..35 | Drug Database Code |
| C | ALN-010-09 | Reference Qualifier | an..3 | Code value to define the reference number. |
| | | | | Values: |
| | | | | E = Medical Economic GFC |
| | | | | G = Medical Economic GM |
| | | | | FG = First DataBank GCN Seq # |
| | | | | FS = First DataBank SmartKey |
| | | | | MC = Multum Drug ID |
| | | | | MD = Medi-Span DDID |
| | | | | MG = Medi-Span GPI |
| | | | | MM = Multum MMDC |
| C | ALN-010-10 | Item Description | an..35 | Drug name |
| | | | | If the full drug name, strength, form does |
| | | | | not fit in 010-02 without abbreviation, |
| | | | | level 10-12 are to be used for the full |
| | | | | name, strength, form. |
| C | ALN-010-11 | Item Description | an..35 | Drug name |
| C | ALN-010-12 | Item Description | an..35 | Drug name |
| C | ALN-020 | Alternative Generic Name | an..35 | |

5.14 UIT—Interactive Message Trailer Segment

Designates the message trace number and number of segments in the message.

Interactive Message Trailer Segment Table

| | Element | | Data | |
|---|---|---|---|---|
| M/C | Number | Element Name | Type | Comments |
| M | UIT-000 | SEGMENT TAG | | |
| M | UIT-000-01 | Segment Code | a3 | Segment ID |
| | | | | Value: UIT |
| C | UIT-010 | MESSAGE | an..35 | Must be the same |
| | | REFERENCE | | as in UIH-020. |
| | | NUMBER | | |
| C | UIT-020 | NUMBER OF | n..10 | Count of the number |
| | | SEGMENTS IN | | of segments in mes- |
| | | MESSAGE | | sage, not including |
| | | | | UNA, UIB and UIZ |
| | | | | segments. |

5.15 UIZ—Interactive Interchange Trailer Segment

Designates the interchange trace number and number of messages in the transaction.

Interactive Interchange Trailer Segment Table

| | Element | | Data | |
|---|---|---|---|---|
| M/C | Number | Element Name | Type | Comments |
| M | UIZ-000 | SEGMENT TAG | | |
| M | UIZ-000-01 | Segment Code | a3 | Segment ID |
| | | | | Value: UIZ |
| X | UIZ-010 | DIALOGUE REFERENCE | | |
| C | UIZ-020 | INTERCHANGE | n..6 | Number of messages in |
| | | CONTROL | | the interchange (that is, |
| | | COUNT | | the number of UIH/UIT |
| | | | | pairs). |
| | | | | Value: Currently, the |
| | | | | value (if sent) must |
| | | | | always be 1. |
| | | | | Only 1 message is |
| | | | | allowed per envelope. |

| | | |
|---|---|---|
| X | UIZ-030 | DUPLICATE INDICATOR |

Section 6 Real Time Benefit Check Examples

6.1 Real Time Benefit Check Example

This is an example of a prescriber system that wants to inquire a PBM about the formulary status for a drug for a particular patient. The PBM needs the unique ID for the patient and the drug to make the check. Note: In the examples, line breaks are used at the end of the segments for display purposes—live messages should not contain line breaks.

Examples Table

| Message | Segment Sets |
|---|---|
| Benefit Request | UNA, UIB, UIH(BENREQ), REQ, PVD, PVD, PTT, |
| (from Prescriber) | COO, DRU UIT, UIZ |
| Benefit Response | UNA, UIB, UIH(BENRES), RES, PVD, PVD, PTT, |
| (from PBM) | COO, DRU, FRM, ALN, FRM, UIT, UIZ |

6.1.1 Real Time Benefit Check Request (from the Prescriber System to Surescripts)

UNA:+./*′

UIB+UNOA:0++991+++POCID:ZZZ:PASSWORD+PBM123:ZZZ+20071001:081 32

2′ UIH+BENCON:001:001:BENREQ′ REQ+90R′

PVD+PC+123456789:HPI+++JONSON:TIM++++6518659191:TE′

PVD+P2+NCPDPID:D3+++++MCMOHR/'S CORNER PHARMACY+123 THIRD ST:ST PAUL:MN:55123+6518952323:TE′

PTT+1+19440605+JAMES:TINA+F+666886666:SY′

COO+123456789:ZZ+AMERICARE INSURANCE++MEMBERID+JAMES, TINA

+GROUPNUMBER++++++++PBM11356′

DRU+R:REGLAN 10 MG TABLETS:22123346763:ND::10:ME+EA:30:38+:TAKE 1 TABLET TWICE DAILY+ZDS:30:804′

UIT++8′

UIZ++1′

6.1.1 Examples Table

| Segment | Value | Note |
|---|---|---|
| UIB | UNOA:0 | “UNOA:0” is the syntax identifier. |
| UIB | 991 | “991” is the Control Number assigned by the prescriber |
| | | system/clinic system. |
| UIB | POCID:ZZZ:PASSWORD | “POCID” is the Participant ID of the sender; “ZZZ” is a |
| | | mutually defined Participant ID; “PASSWORD” is the |
| | | password of the prescriber system. |
| UIB | PBM123:ZZZ | “PBM123” is the Participant ID of the PBM. |
| | | “ZZZ” is a mutually defined Participant ID. |
| UIB | 20071001:081322 | Date and time message was sent. “20071001” is the |
| | | date, Oct. 1, 2002; “081322” is 08:13:22 A.M. |
| UIH | BENCON:001 :001 | “BENCON” defines the message type; “001” represents |
| | | the version; “001” indicates the release to be used in |
| | | decoding this message. All messages in this set use these |
| | | default values. |
| UIH | BENREQ | “BENREQ” is the message function: RTBC Request. |
| REQ | 90R | “90R” indicates the PBM needs to return information |
| | | related to the patient's benefit for 90 Days at Retail. |
| PVD PC | PC | “PC” identifies this PVD segment as information |
| | | about a prescriber. |
| PVD PC | 123456789:HPI | The reference number of the doctor is “123456789”. |
| | | “HPI” is the qualifier indicates that it is the NPI. |
| PVD PC | JONSON:TIM | “JONSON:TIM” is the prescriber's name, Tim Jonson. |
| PVD PC | 6518659191:TE | “6518659191” is the prescriber's communication |
| | | number, (651) 865-9191. “TE” is the qualifier |
| | | indicating the communication number is for the telephone. |
| PVD P2 | P2 | “P2” identifies this PVD segment as referring to pharmacy. |
| PVD P2 | NCPDPID:D3 | “NCPDPID” is the NABP Number of the pharmacy. |
| | | “D3” is the qualifier. |
| PVD P2 | MCMOHR/'S CORNER | “MCMOHRPS CORNER PHARMACY” is the name of |
| | PHARMACY | Pharmacy, McMohr's Corner Pharmacy. |
| PVD P2 | 123 THIRD ST:ST | “123 THIRD ST” is the street and number. “ST PAUL” is |
| | PAUL:MN:55123 | the city name. “MN” is the state name, Minnesota. “55123” |
| | | is the zip code. |
| PVD P2 | 6518952323:TE | “6518952323” is the phone number of the pharmacy, |
| | | (651) 895-2323. “TE” is the qualifier. |
| PTT | 1 | Relationship to cardholder. “1” indicates the patient is |
| | | the member. |
| PTT | 19440605 | “19440605” is the patient's date of birth Jun. 5, 1944. |
| PTT | JAMES:TINA | “JAMES:TINA” is the patient's name: Tina James. |
| PTT | F | “F” indicates that the patient is female. |
| PTT | 666886666:SY | “666886666” is the patient's Reference Number; “SY” is |
| | | the qualifier that indicated the reference number is the |
| | | social security number. |
| COO | 123456789:ZZ | “123456789” is the ISA13 value.; “ZZ” specifies |
| | | mutually defined. |
| COO | AMERICARE INSURANCE | “AMERICARE INSURANCE” is the name of Payer. |
| COO | MEMBER ID | “MEMBER ID” is the Cardholder ID. |
| COO | JAMES, TINA | “JAMES, TINA” is the Cardholder Name. |
| COO | GROUPNUMBER | “GROUPNUMBER” is the Reference Number that is the |
| | | Group ID Number or Carrier Number. |
| COO | PBM11356 | “PBM11356” is the patient's PBM Unique Identifier. |
| DRU | R:REGLAN 10 MG | “R” the Item Description Identification that means |
| | TABLETS:22123346763 | requested. Drug requested is “REGLAN 10 Mg |
| | | Tablets”; NDC (drug) number is “22123346763” |
| DRU | ND | “ND” equals NDC11. |
| DRU | 10:ME | “10” is the drug strength; “ME” is the Code List Qualifier |
| | | that means milligram; therefore the prescription is for |
| | | 10 mg tablets. |
| DRU | EA:30:38 | “EA” is the Quantity Qualifier that means each; “30” is the |
| | | quantity; “38” is the code list qualifier that means Original |
| | | Qty. |
| DRU | TAKE 1 TABLET TWICE | “TAKE 1 TABLET TWICE DAILY” is the SIG dosage |
| | DAILY | instruction. |
| DRU | ZDS:30:804 | “ZDS” is the qualifier for Days Supply; |
| | | “30” is the Number of Days Supply; |
| | | “804” is the Quantity of Days. |
| UIT | 8 | “8” is the number of segments between the UIH and the |
| | | UIT segment and including those segments. |
| UIZ | 1 | “1” is the number of messages in this transaction. |

6.1.2 Real Time Benefit Check Request (from Surescripts to the PBM)

UNA:+./*′

UIB+UNOA:0++991+++POCID:ZZZ:PWPBMIN+PBM123:ZZZ+20071001:0813 22′

The rest of the message is the same as the previous message RTBC Request (from the prescriber system to Surescripts).

6.1.2 Examples Table

| Segment | Value | Note |
|---|---|---|
| UIB | UNOA:0 | “UNOA:0” is the syntax identifier. |
| UIB9 | 91 | “991” is the Control Number assigned |
| | | by the prescriber system/clinic. |
| UIB | POCID:ZZZ: PWPBMIN | “POCID” is the Participant ID of the |
| | | sender; |
| UIB | PBM123:ZZZ | “PBM123” is the Participant ID of |
| | | the PBM. “ZZZ” is a |
| UIB | 20071001:081322 | Date and time message was sent. |
| | | “20071001” is the |

6.1.3 Real Time Benefit Check Response (from the PBM to Surescripts)

UNA:+./*′

UIB+UNOA:0++123+++PBM123:ZZZ:PASSWORD+POCID:ZZZ+20071001:081 34

2′ UIH+BENCON:001:001:BENRES++991′ RES+P′

PVD+PC+123456789:HPI+++JONSON:TIM++++6518659191:TE′

PVD+P2+NCPDPID:D3+++++MCMOHR/'S CORNER PHARMACY+123 THIRD ST:ST PAUL:MN:55123+6518952323:TE′

PTT+1+19440605+JAMES:TINA+F+666886666:SY*PBM11356:2U′

COO+123456789:ZZ+AMERICARE INSURANCE++MEMBERID+JAMES, TINA

+GROUPNUMBER++++++++PBM11356′
DRU+R:REGLAN 10 MG TABLETS:00031670163:ND::10:ME+EA:30:38+:TAKE 1 TABLET TWICE DAILY+ZDS:30:804′

FRM+R+CR+PA:PRIOR AUTH*QL:QUANTITY LIMITS+2++30:30′

FRM+M+CR+PA:PRIOR AUTH*QL:QUANTITY LIMITS+2++25:90′

FRM+9+CR+PA:PRIOR AUTH*QL:QUANTITY LIMITS+2++25:90′

ALN+:ALN DRUG NAME:12345678901:ND+ALN GENERIC NAME′

FRM+R+CV++3++25:30′

FRM+M+CV++3++20:90′ FRM+9+CV++3++20:90′

ALN+:ALN DRUG NAME2:34343678901:ND′

FRM+R+CR+PA:ASK THE DOCTOR+2++25:30′

FRM+M+CR+PA:ASK THE DOCTOR+2++20:90′

FRM+9+CR+PA:ASK THE DOCTOR+2++20:90′

UIT++19′

UIZ++1′

6.1.3 Examples Table

| Segment | Value | Note |
|---|---|---|
| UIB | UNOA:0 | “UNOA:0” is the syntax identifier. |
| UIB | 123 | “123” is the Control Number assigned by the responding |
| | | system. |
| UIB | PBM123:ZZZ:PASSWORD | “PBM123” is the Participant ID of the PBM; “ZZZ” is a |
| | | mutually defined Participant ID; “PASSWORD” is the |
| | | password for the PBM accessing Surescripts. |
| UIB | POCID:ZZZ: | “POCID” is the Participant ID of the receiver; “ZZZ” is a |
| | | mutually defined Participant ID. |
| UIB | 20071001:081342 | Date and time message was sent. “20071001” is the |
| | | date, Oct. 1, 2007; “081342” is 08:13:42 A.M. |
| UIH | BENCON:001:001 | “BENCON” defines the message type; “001” is the version; |
| | | “001”indicates the release to be used in decoding this |
| | | message. All messages in this set use these default values. |
| UIH | BENRES | “BENRES” is the message function: RTBC Response. |
| UIH | 991 | “991” is the Control Number of the original message. |
| RES P | P | “P” is the response code, P = Processed |
| PVD PC | PC | “PC” identifies this PVD segment as information about |
| | | a prescriber. |
| PVD PC | 123456789:HPI | The reference number of the doctor is “123456789”. The |
| | | “HPI” is the qualifier indicates that it is the NPI. |
| PVD PC | JONSON:TIM | “JONSON:TIM” is the prescriber's name, Tim Jonson. |
| PVD PC | 6518659191:TE | “6518659191” is the doctor's Communication Number, |
| | | (651) 865-9191. “TE” is the qualifier indicating the |
| | | Communication Number is for the telephone. |
| PVD P2 | P2 | “P2” identifies this PVD segment as referring to pharmacy. |
| PVD P2 | NCPDPID:D3 | “NCPDPID” is the NABP Number of pharmacy. “D3” |
| | | is the qualifier. |
| PVD P2 | MCMOHR/'S CORNER | “MCMOHR/'S CORNER PHARMACY” is the name of |
| | PHARMACY | Pharmacy, McMohr's Corner Pharmacy. |
| PVD P2 | 123 THIRD ST:ST | “123 THIRD ST” is the street and number. |
| | PAUL:MN:55123 | “ST PAUL” is the city name. |
| | | “MN” is the state name, Minnesota. |
| | | “55123” is the zip code. |
| PVD P2 | 6518952323:TE | “6518952323” is the Phone Number of the pharmacy, |
| | | (651) 895-2323. “TE” is the qualifier. |
| PTT | 1 | Relationship to Cardholder. “1” indicates the patient is the |
| | | member. |
| PTT | 19440605 | “19440605” is the patient's date of birth, Jun. 5, 1944. |
| PTT | JAMES:TINA | “JAMES:TINA ” is the patient's name, Tina James. |
| PTT | F | “F” indicates the gender is female. |
| PTT | 666886666:SY | “666886666” is the patient's Reference Number; “SY” is |
| | | the qualifier that indicated the reference number is the |
| | | social security number. |
| PTT | PBM11356:2U | “PBM11356” is the patient's PBM Unique ID is PBM11356. |
| | | “2U” is the qualifier. |
| COO | 123456789 | “123456789” is the ISA13 value. |
| COO | ZZ | “ZZ” specifies mutually defined.. |
| COO | AMERICARE INSURANCE | “AMERICARE INSURANCE ” is the name of the payer. |
| COO | MEMBERID | “MEMBERID” is the Cardholder ID. |
| COO | JAMES, TINA | “JAMES, TINA” is the Cardholder Name. |
| COO | GROUPNUMBER | Group ID. |
| COO | PBM11356 | Patient's PBM Unique Identifier is “PBM11356”. |
| DRU | R:REGLAN 10 MG TABLETS: | “R” the Item Description Number that means requested. |
| | 00031670163:ND | Drug requested is “REGLAN 10 Mg Tablets”. |
| | | “00031670163” is the NDC Number. |
| | | “ND” equals NDC11. |
| DRU | 10:ME | “10” is the drug strength; “ME” is the Code List Qualifier |
| | | that means milligram; therefore the prescription is for |
| | | 10 mg tablets. |
| DRU | EA:30:38 | “EA” is the Quantity Qualifier that means each; “30” is |
| | | the quantity; “38” is the code list qualifier that means |
| | | Original Qty. |
| DRU | TAKE 1 TABLET TWICE | “TAKE 1 TABLET TWICE DAILY” is the SIG dosage |
| | DAILY | instructions. |
| DRU | ZDS:30:804 | “ZDS” is the qualifier for Days Supply; |
| | | “30” is the Number of Days Supply; |
| | | “804” is the Quantity of Days. |
| FRM | R | “R” indicates this segment is for Retail Pharmacy. |
| FRM | CR | “CR” indicates this is covered with restrictions. |
| FRM | PA | Coverage Reference Code “PA” means prior authorization |
| | | is required. |
| FRM | PRIOR AUTH | Coverage Reference Text “PRIOR AUTH” contains special |
| | | instructions for the prescriber system. |
| FRM | QL | Coverage Reference Code “QL” |
| | | means quantity limits are required. |
| FRM | QUALITY LIMITS | Coverage Reference Text “QUALITY LIMITS” contains |
| | | special instructions for the prescriber system. |
| FRM | 2 | Formulary Status “2” which means On Formulary. |
| FRM | 30:30 | “30” indicates the cost is $30. “30” indicates 30 days supply. |

Second FRM

| | | |
|---|---|---|
| FRM-2 | M | “M” indicates this segment is for Mail Order Pharmacy. |
| FRM-2 | CR | “CR” indicates this is covered with restrictions. |
| FRM-2 | PA | Coverage Reference Code “PA” means prior authorization |
| | | is required. |
| FRM-2 | PRIOR AUTH | Coverage Reference Text “PRIOR AUTH” contains special |
| | | instructions for the prescriber system. |
| FRM-2 | QL | Coverage Reference Code “QL” means quantity limits |
| | | are required. |
| FRM-2 | QUALITY LIMITS | Coverage Reference Text “QUALITY LIMITS” contains |
| | | special instructions for the prescriber system. |
| FRM-2 | 2 | Formulary Status “2” which means On Formulary. |
| FRM-2 | 25:90 | “25” indicates the cost is $25. “90” indicates 90 days supply. |

Third FRM

| | | |
|---|---|---|
| FRM-3 | 9 | “9” indicates this segment is for Retail 90 days |
| FRM-3 | CR | “CR” indicates this is covered with restrictions. |
| FRM-3 | PA | Coverage Reference Code “PA” means prior authorization |
| | | is required. |
| FRM-3 | PRIOR AUTH | Coverage Reference Text “PRIOR AUTH” contains |
| | | special instructions for the prescriber system. |
| FRM-3 | QL | Coverage Reference Code “QL” means quantity limits |
| | | are required. |
| FRM-3 | QUALITY LIMITS | Coverage Reference Text “QUALITY LIMITS” contains |
| | | special instructions for the prescriber system. |
| FRM-3 | 2 | Formulary Status “2” which means On Formulary. |
| FRM-3 | 25:90 | “25” indicates the cost is $25. “90” indicates 90 days supply. |
| ALN | ALN DRUG | “ALN DRUG NAME ”indicates the Alternative Drug Name; |
| | NAME:12345678901:ND+ALN | “12345678901” is the Drug Number; |
| | GENERIC NAME’ | “ND” indicates this is NDC11. |
| | | “ALN GENERIC NAME” is the Alternative NDC |
| | | Alternative Generic Name. |
| FRM | R | “R” indicates this segment is for Retail Pharmacy. |
| FRM | CV | “CV” indicates this is covered. |
| FRM | 3 | Formulary Status “3” which means Preferred level 1. |
| FRM | 25:30 | “25” indicates the cost is $25. “30” indicates 30 days supply. |

Second FRM

| | | |
|---|---|---|
| FRM-2 | M | “M” indicates this segment is for Mail Order Pharmacy |
| FRM-2 | CV | “CV” indicates that this is covered. |
| FRM-2 | 3 | Formulary Status “3” which means Preferred level 1. |
| FRM-2 | 20:90 | “20 indicates the cost is $20. “90” indicates 90 days supply. |

Third FRM

| | | |
|---|---|---|
| FRM-3 | 9 | “9” indicates this segment is for 90 Days at Retail Pharmacy |
| FRM-3 | CV | “CV” indicates that it is covered. |
| FRM-3 | 3 | Formulary Status “3” which means Preferred level 1. |
| FRM-3 | 20:90 | “20” indicates the cost is $20. “90” indicates 90 days supply. |
| ALN | ALN DRUG | “ALN DRUG NAME2” indicates the Alternative Drug |
| | NAME2:34343678901:ND | Name; “ 34343678901” is the Drug Number; “ND” indicates |
| | | this is NDC11. |
| FRM | R | “R” indicates this segment is for Retail Pharmacy. |
| FRM | CR | “CR” indicates that this is covered with restrictions. |
| FRM | PA:ASK THE DOCTOR | “PA” indicates that this is a Prior Authorization. “ASK THE |
| | | DOCTOR” is the Coverage Reference Text. |
| FRM | 2 | Formulary Status “2” which means On Formulary. |
| FRM | 25:30 | “25” indicates the cost is $25. “30” indicates 30 days supply. |

Second FRM

| | | |
|---|---|---|
| FRM-2 | M | “M” indicates this segment is for Mail Order Pharmacy. |
| FRM-2 | CR | “CR” indicates that this is covered with restrictions. |
| FRM-2 | PA:ASK THE DOCTOR | “PA” indicates that this is a Prior Authorization. “ASK THE |
| | | DOCTOR” is the Coverage Reference Text. |
| FRM-2 | 2 | Formulary Status “2” which means On Formulary. |
| FRM-2 | 20:90 | “20” indicates the cost is $20. “90” indicates 90 days supply. |

Third FRM

| | | |
|---|---|---|
| FRM-3 | 9 | “9” indicates that this segment is for Retail Order Pharmacy. |
| FRM-3 | CR | “CR” indicates that this is covered with restrictions. |
| FRM-3 | PA:ASK THE DOCTOR | “PA” indicates that this is a Prior Authorization. “ASK |
| | | THE DOCTOR” is the Coverage Reference Text. |
| FRM-3 | 2 | Formulary Status “2” which means On Formulary. |
| FRM-3 | 20:90 | “20 indicates the cost is $20. “90” indicates 90 days supply. |
| UIT | 19 | “19” is the number of segments between the UIH and |
| | | the UIT segment and including those segments. |
| UIZ | 1 | “1” is the number of messages in this transaction. |

6.1.4 Real Time Benefit Check Response (from Surescripts to the Prescriber System)

UNA:+./*′

UIB+UNOA:0++123+++PBM123:ZZZ:PASSWORD+POCID:ZZZ+20071001:081 342′

The rest of this message is the same the previous message RTBC Response (from the PBM to Surescripts).

6.1.4 Examples Table

| Segment | Value | Note |
|---|---|---|
| UIB | UNOA:0 | “UNOA:0” is the syntax identifier. |
| UIB | 123 | “123” is the Control Number assigned |
| | | by the responding system. |
| UIB | PBM123:ZZZ: | “PBM123” is the Participant ID of the |
| | PASSWORD | PBM; “ZZZ” is a mutually defined |
| | | Participant ID; “PASSWORD” is the |
| | | password for the PBM accessing |
| | | Surescripts. |
| UIB | POCID:ZZZ | “POCID” is the Participant ID of the |
| | | receiver; “ZZZ” is a mutually defined |
| | | Participant ID. |
| UIB | 20071001:081342 | Date and time message was sent. |
| | | “20071001” is the date, Oct. 1, 2007; |
| | | “081342” is 08:13:42 A.M. |

Section 7 Real Time Benefit Check Error Processing

The Responder Participant will return an error whenever the transaction request has failed validation during processing of a formulary coverage status request. The error will be in the form of the NCPDP Error Message (STS segment). For some errors the RES segment can be utilized in the BENRES message. The table lists a subset of the errors a Requester Participant may expect.

7—Error Processing Table

| | STS-10/RES-010 | | STS-030/RES- | |
|---|---|---|---|---|
| Event | Status Type Code | STS-020 Code | 040 Free Text | Note |
| Poorly formatted | STS-010 = 900- | Appropriate | Appropriate | Responder Participant |
| Message | Transaction | Error | Error | will identify any problems |
| | Rejected | | | they have with the physical |
| | | | | structure of the message. |
| Drug not Found | RES-010 = NF- | N/A | DRUG NOT | Responder Participant |
| | Not found | | FOUND | will respond with this |
| | | | | error when the drug is |
| | | | | not identified properly, |
| | | | | cannot be found. |
| Cannot find patient | RES-010 = NF- | N/A | Patient Not | Responder Participant |
| identified | Not found | | Found | utilizes value in the |
| | | | | COO-140 Patient |
| | | | | Identifier Field to |
| | | | | validate if it is missing, |
| | | | | not found, or is invalid. |
| Patient not eligible | RES-010 = NF- | N/A | Patient Not | Responder Participant |
| | Not found | | Eligible | verifies that the patient |
| | | | | is still eligible for |
| | | | | pharmacy benefits. |
| System | RES-010 = NP- | N/A | SYSTEM | This code is used when |
| Unavailable | Not | | UNAVAILIBLE | some system components |
| | Processed | | | are not available. |
| | | | | Depending on your |
| | | | | system configuration you |
| | | | | may or may not have a |
| | | | | case to use this code. |

7.1 EDIFACT Error Messages

The following list (not all inclusive) is the possible errors that can be received by

EDIFACT users.

HEADER TOO SHORT (if length of message is less than 12)

UNA-010 COMPONENT DELIMITER INVALID

UNA-020 ELEMENT DELIMITER INVALID

UNA-040 RELEASE DELIMITER INVALID

UNA-050 REPEAT DELIMITER INVALID

UNA-060 SEGMENT TERMINATOR INVALID

UNA DELIMITERS MUST BE UNIQUE

UNKNOWN SEGMENT (SEGMENT NAME)

FOUND SEGMENT (SEGMENT NAME), EXPECTING SEGMENT NAME SEGMENT

(SEGMENT NAME) SEGMENT MISSING OR IN WRONG POSITION

(SEGMENT NAME) MISSING

(SEGMENT NAME) SEGMENT, INVALID

(SEGMENT NAME+COMPOSITE NAME) MISSING

(SEGMENT NAME+COMPOSITE NAME) SHOULD NOT BE USED

(SEGMENT NAME+COMPOSITE NAME+ELEMENT) MISSING

(SEGMENT NAME) HAS TOO MANY ELEMENTS

(SEGMENT NAME COMPOSITE) HAS TOO MANY ELEMENTS

(SEGMENT NAME) (COMPONENT NAME) REPEATS TOO MANY TIMES

(SEGMENT NAME ELEMENT NAME) REPEATS TOO MANY TIMES

(SEGMENT NAME) HAS TOO MANY ELEMENTS

(SEGMENT NAME-XXX-XX) EXCEEDS MAX LENGTH OF (MAX)

(SEGMENT NAME-XXX-XX) LESS THAN MIN LENGTH OF (MIN)

(SEGMENT NAME-XXX-XX) INVALID VALUE (VALUE)

(SEGMENT NAME-XXX-XX) INVALID DATE (DATE)

(SEGMENT NAME-XXX-XX) INVALID TIME (TIME)

(SEGMENT NAME-XXX-XX) DATA NOT ALPHA-NUMERIC (DATA)

(SEGMENT NAME-XXX-XX) DATA NOT NUMERIC (DATA)

UIT-010 MESSAGE REFERENCE NUMBER DOES NOT MATCH UIH-002

UIT-020 NUMBER OF SEGMENTS IN MESSAGE NOT CORRECT, FOUND

(NUMBER)

UIZ SEGMENT TERMINATOR MISSING

Section 8 Transaction Processing Summary

This section explains the transaction processing that will take place for transactions exchanged between a transaction sender and a transaction receiver. These transactions are initiated in the form of a request and a response is returned. The sender stays connected until a response is given. Depending on connectivity, the actual transaction vehicle may vary.

The system (Surescripts) will store round trip messages until the receiver responds to the message or until the specified time has elapsed. If the timeout elapses before the message is processed, an error message will be returned to the sender as the reply (explained below). If the sender has timed out, the message is discarded.

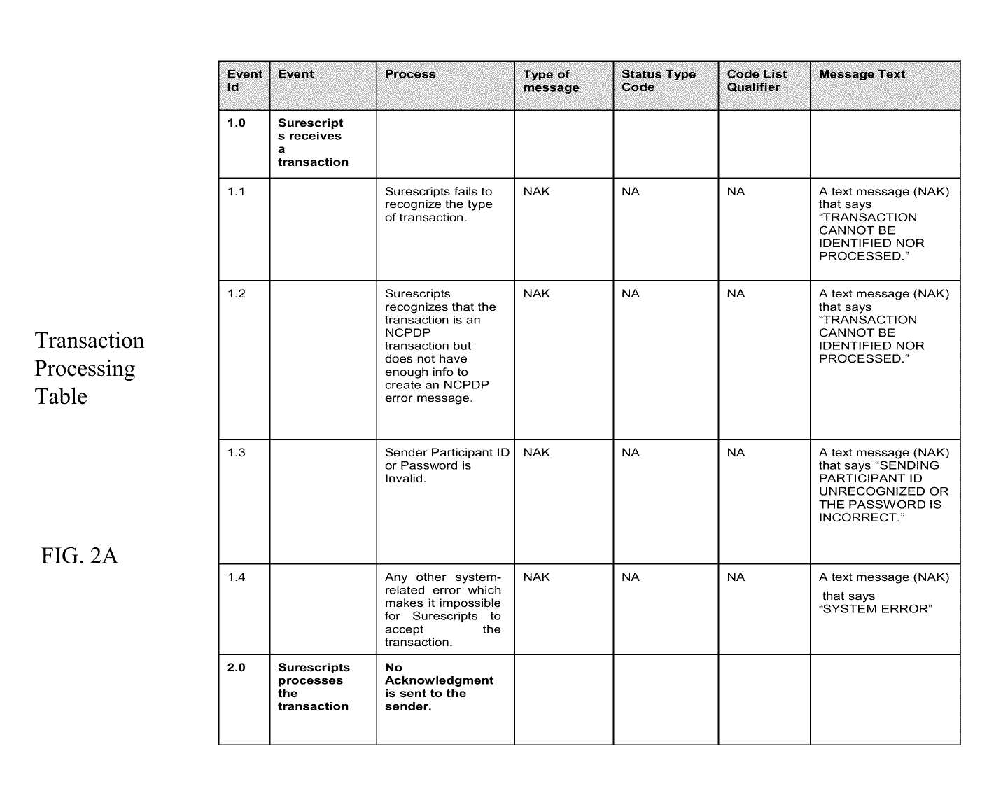

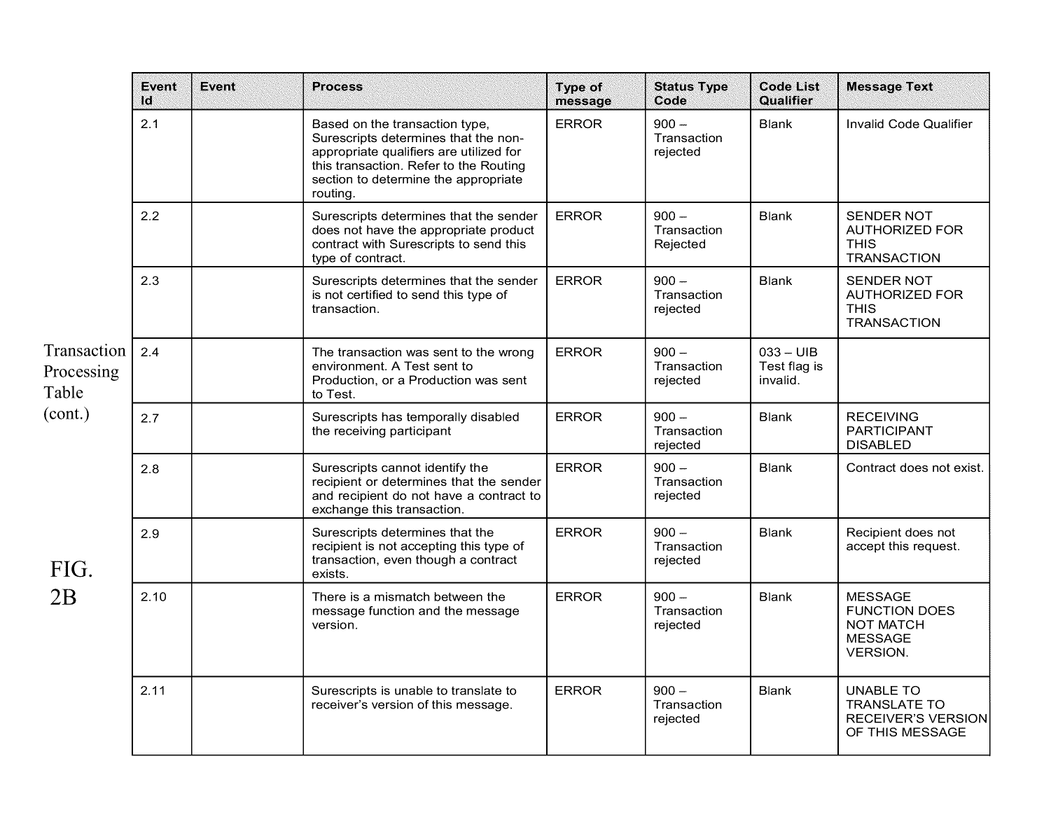

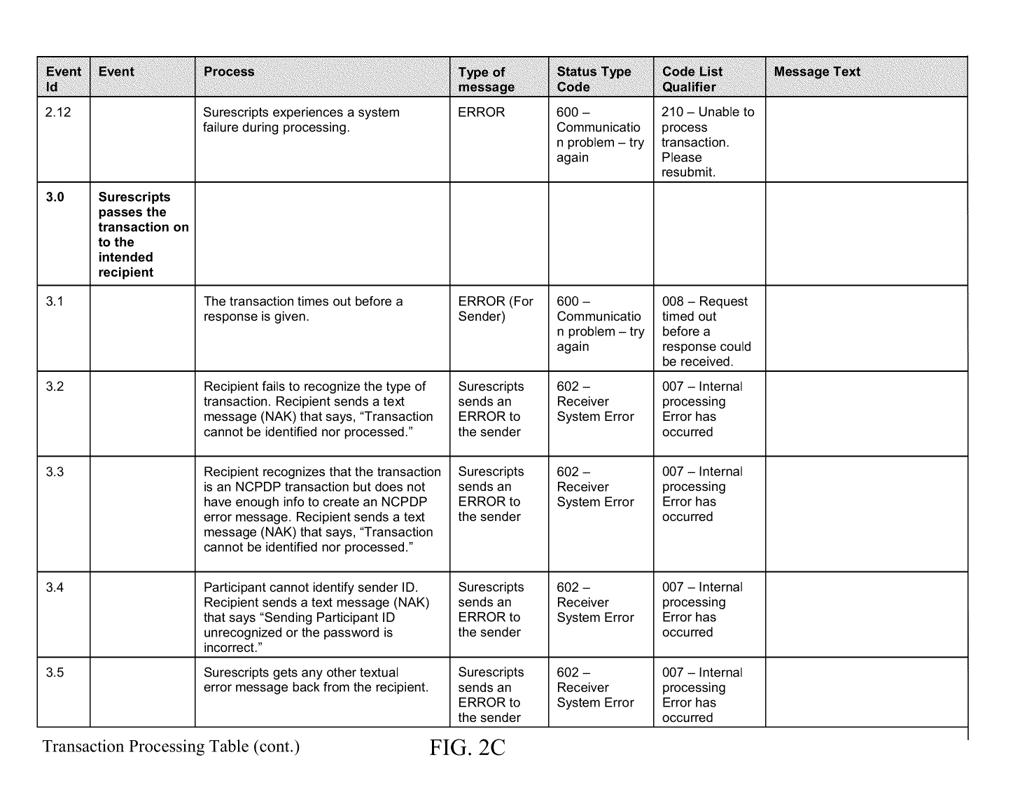

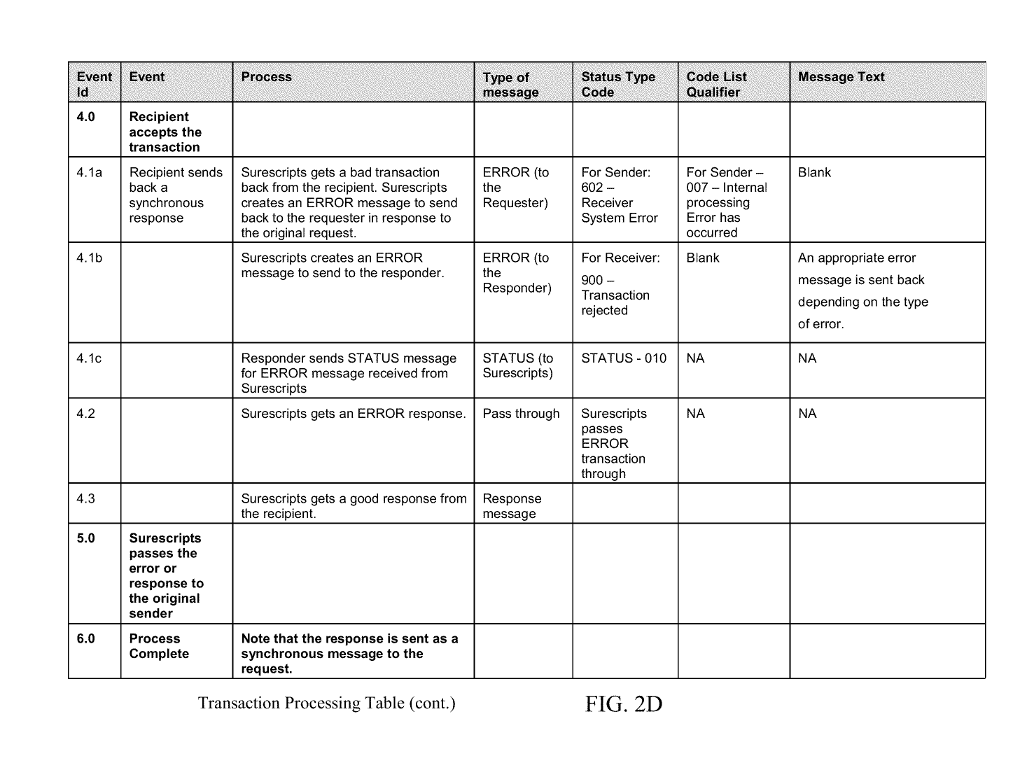

See Transaction Processing Tables in FIGS. 2A-2D.

8.1 Round-Trip Processing (NAKS)

The transaction processing summary explains the exchange of messages between participants and the potential errors that could occur. In some situations, the receiving participant does not have enough information to create a standard error transaction. This will occur if the receiving party encounters one of the following problems: cannot validate the sender's Participant ID and/or password, cannot identify the transaction, a system error occurs before the transaction is being processed.

Surescripts is utilizing a small XML file to transmit the error in this situation. The error is transmitted via the same connection level protocol that the request came in on, using information at the connection level to know how to get it to the original sender.

The following process flow tables display the conditions where a participant can expect an error (NAK). Round-trip transactions are made up of a request and a response. The following scenarios can exist for these types of transactions.

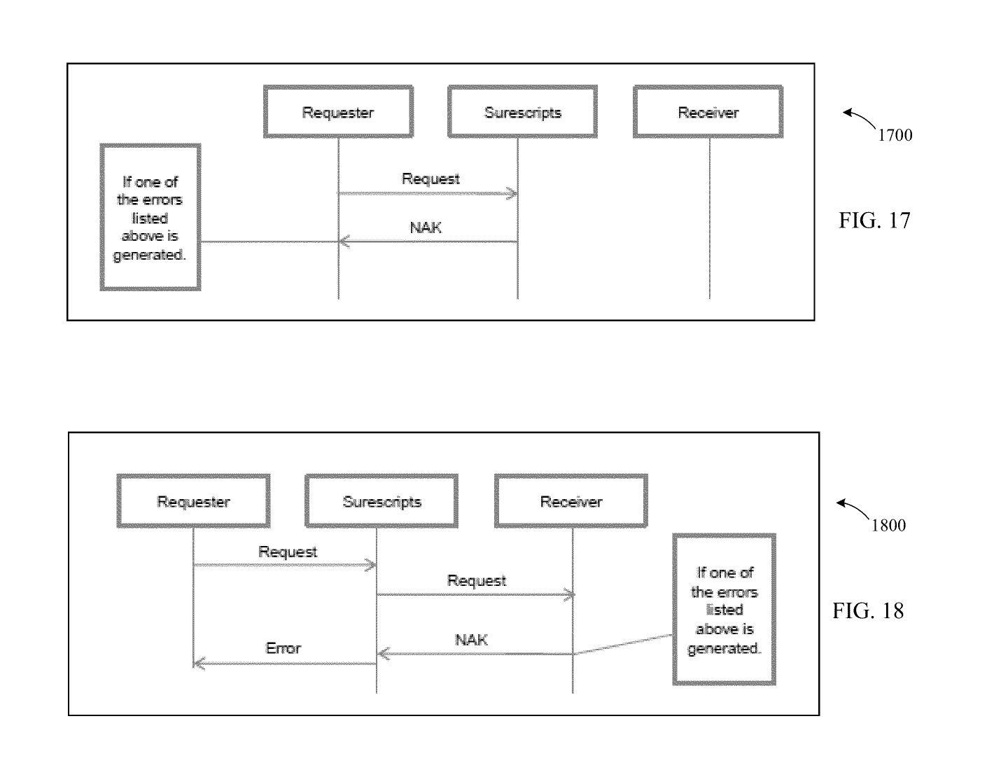

Scenario A: Failure at Surescripts on incoming request. See scenario flow 1700 of FIG. 17.

Scenario B: Failure of request at receiver after Surescripts transmitted the request.

See scenario flow 1800 of FIG. 18. Note: Surescripts transmits an error transaction back to the original requester.

The physical format of a NAK is a small XML string in place of a transaction: Error (NAK).

<nak status=“n”>Text Message</nak>

NAK Table

| Message Type | Status | Error | Message |
|---|---|---|---|
| NAK | 1 | Invalid | TRANSACTION CANNOT BE |
| | | Syntax | IDENTIFIED NOR PROCESSED |
| NAK | 2 | Security | SENDING PARTICIPANT ID |
| | | Violation | UNRECOGNIZED OR THE |
| | | | PASSWORD IS INCORRECT |
| NAK | 3 | Transaction | TRANSACTION TIMEOUT |
| | | Timeout | |
| NAK | 4 | System Error | SYSTEM ERROR |

An Example of a nak:

<nak status=“2”> Sending Participant ID unrecognized or the password is incorrect.

### Example Delimiters

This section contains an example list of characters that are acceptable for use as delimiters.

Dynamic Delimiter Table

| Char | Dec | Oct | Hex |
|---|---|---|---|
| (bel) | 7 | 0007 | 0x07 |
| (ht) | 9 | 0011 | 0x09 |
| (nl) | 10 | 0012 | 0x0a |
| (vt) | 11 | 0013 | 0x0b |
| (cr) | 13 | 0015 | 0x0d |
| (np) | 12 | 0014 | 0x0c |
| (fs) | 28 | 0034 | 0x1c |
| (gs) | 29 | 0035 | 0x1d |
| (rs) | 30 | 0036 | 0x1e |
| (us) | 31 | 0037 | 0x1f |
| ! | 33 | 0041 | 0x21 |
| ″ | 34 | 0042 | 0x22 |
| % | 37 | 0045 | 0x25 |
| & | 38 | 0046 | 0x26 |
| ′ | 39 | 0047 | 0x27 |
| ( | 40 | 0050 | 0x28 |
| ) | 41 | 0051 | 0x29 |
| * | 42 | 0052 | 0x2a |
| + | 43 | 0053 | 0x2b |
| , | 44 | 0054 | 0x2c |
| − | 45 | 0055 | 0x2d |
| . | 46 | 0056 | 0x2e |
| / | 47 | 0057 | 0x2f |
| : | 58 | 0072 | 0x3a |
| ; | 59 | 0073 | 0x3b |
| < | 60 | 0074 | 0x3c |
| = | 61 | 0075 | 0x3d |
| > | 62 | 0076 | 0x3e |
| ? | 63 | 0077 | 0x3f |
| @ | 64 | 0100 | 0x40 |
| [ | 91 | 0133 | 0xSb |
| \ | 92 | 0134 | 0x5c |
| ] | 93 | 0135 | 0x5d |
| \hat{ } | 94 | 0136 | 0x5e |
| _ | 95 | 0137 | 0x5f |
| ' | 96 | 0140 | 0x60 |
| { | 123 | 0173 | 0x7b |
| \| | 124 | 0174 | 0x7c |
| } | 125 | 0175 | 0x7d |
| ~ | 126 | 0176 | 0x7e |

Exemplary PBM Certification Template for RTBC. RTBC Member:

Columns: “Patient #”, Data Setup, Unique Member Coverage ID, First Name, Last Name, Middle Name, Suffix, Prefix, Address 1, Address 2, City, State, Zip, Birthdate, Gender, Effective Date, Termination Date, Formulary ID, Plan Name, Group ID, Group Name, Member ID, Person Code, Relationship to Sub, Plan ID, Plan/Client Name, BIN, etc.

Rows: 1—Member setup active for mail and retail benefit; 2—Member setup active for mail and retail benefit; 3—Member setup active for retail benefit only; 4—Member setup active for retail benefit only; 5—Member setup active for mail benefit only; 6—Member setup active for mail benefit only; 7—Member setup active for mail, retail, with 90 day at retail available; 8—Member setup active for mail, retail, with 90 day at retail available; 9—Member setup inactive/terminated.

RTBC Drug. Drugs and associated status, coverage and pricing—within each plan and across all covered pharmacy types. This includes, but is not limited to: Drugs covered, Drugs not covered, Drugs covered with restrictions, Varied formulary status for requested drug as well as alternatives, Varied coverage factors for requested drug as well as alternatives, and Varied pricing for requested drug as well as alternatives.

Exemplary PBM certification template for RTBC Table

| Formulary | Plan | | Group | | Plan/Client |
|---|---|---|---|---|---|
| ID | Name | Group ID | Name | Plan ID | Name |
| Drug Name | NDC | Formulary | Coverage | Copay | Pay |
| | | Status | Factors | | Amount |
| Alternative | Alternative | Alternative | Alternative | Alternative | Alternative |
| Drug Name | Drug NDC | Drug | Drug | Drug | Drug Pay |
| | | Formulary | Coverage | Copay | Amount |
| | | Status | Factors | | |

PBM Certification Test Scenarios. Questions:

1. Which benefit coverages do you support (i.e., retail, mail, etc.)?

2. In what combinations do you provide benefit coverages? For example, if covered, will all supported types be active or can some be active while others inactive?

3. Do you support 90 Day at Retail?

4. Will you send Drug Status Code CR? If so, which Coverage Reference Codes will you support for RTBC? AL, DE, GL, MN, PA, QL, RD, ST, TM

5. Which pricing scenarios do you support within RTBC?

Copay: Tier, % Rate, Flat $

Patient Pay Amount: Pay Amt, Days Supply, Qty

6. Do you support returning of alternatives within RTBC?

7. Will you send Drug Status Code CR within the alternatives?

8. Do you support the Detailed RTBC Error Transaction Workflow as outlined in section 3.5 of the Real Time Benefit Check IG?

9. What situations would result in a Denied response (RES-010)?

10. What situations would result in a Not Processed response (RES-010)?

See PBM Cert. Test Tables in FIGS. 3A-3D.

NOTES ON ABBREVIATIONS. FS: Formulary Status. GE: Greater than/equal to.

Patient Test Scenarios

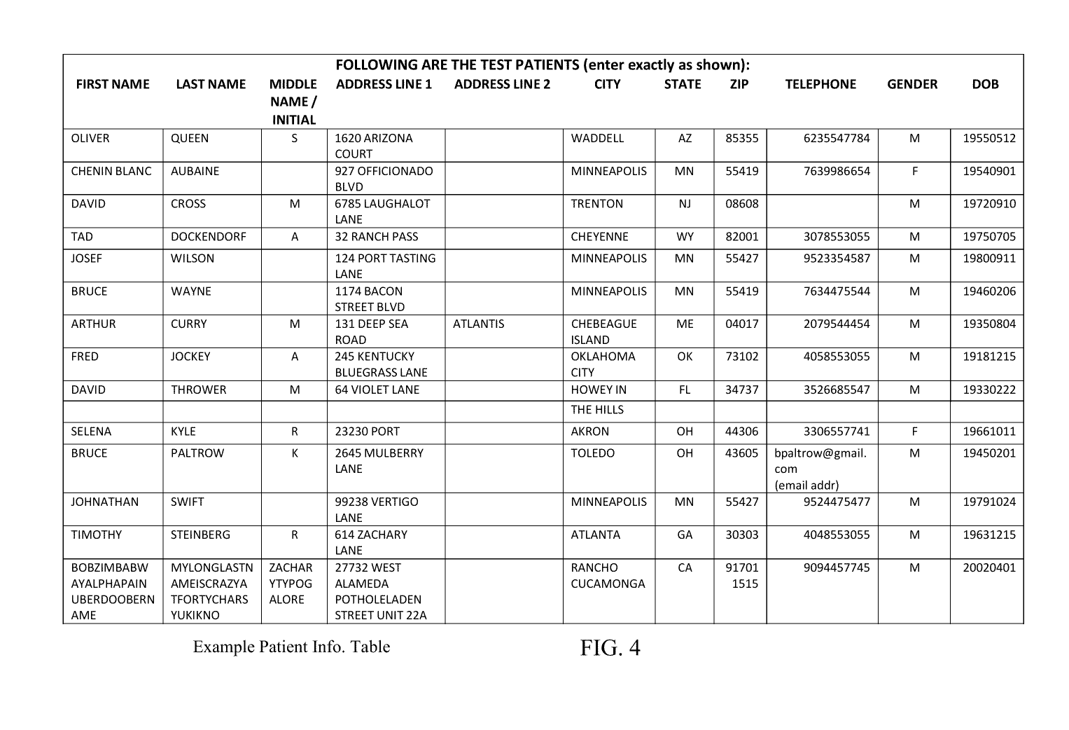

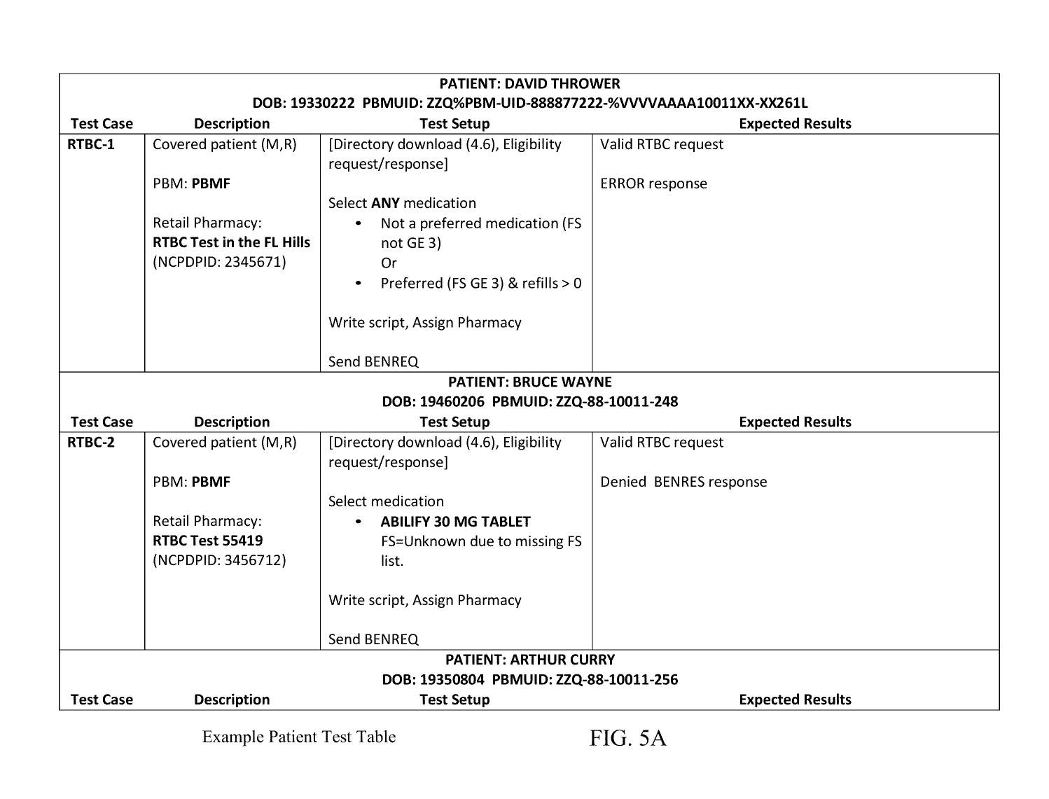

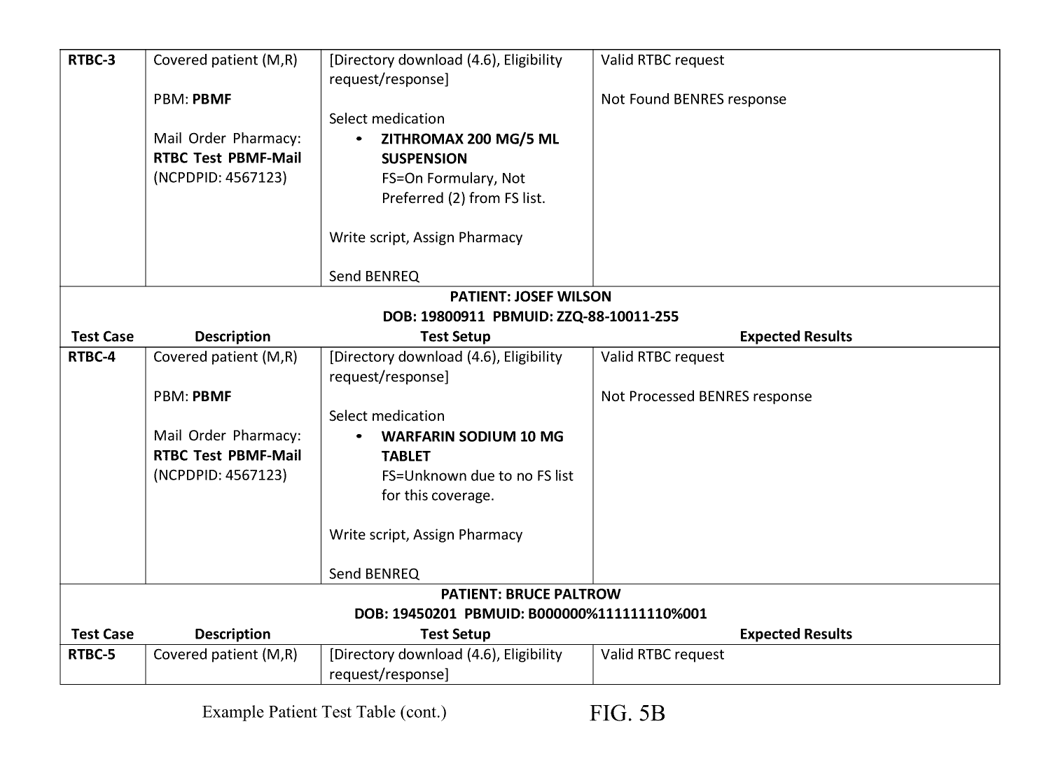

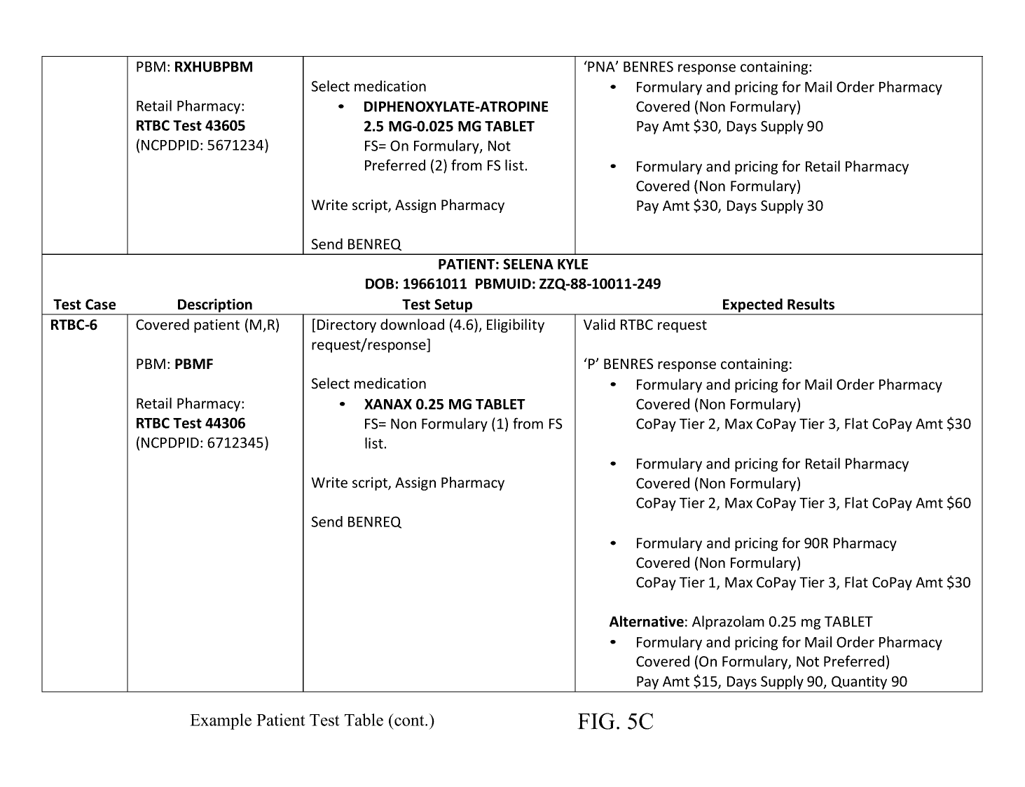

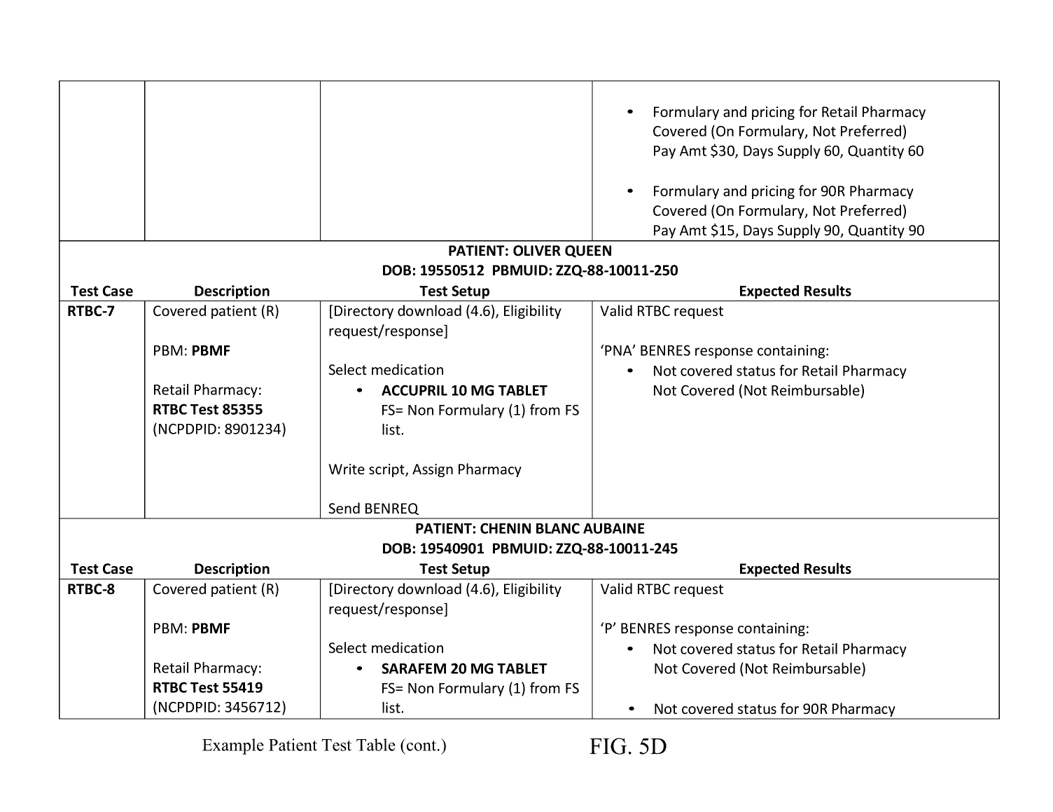

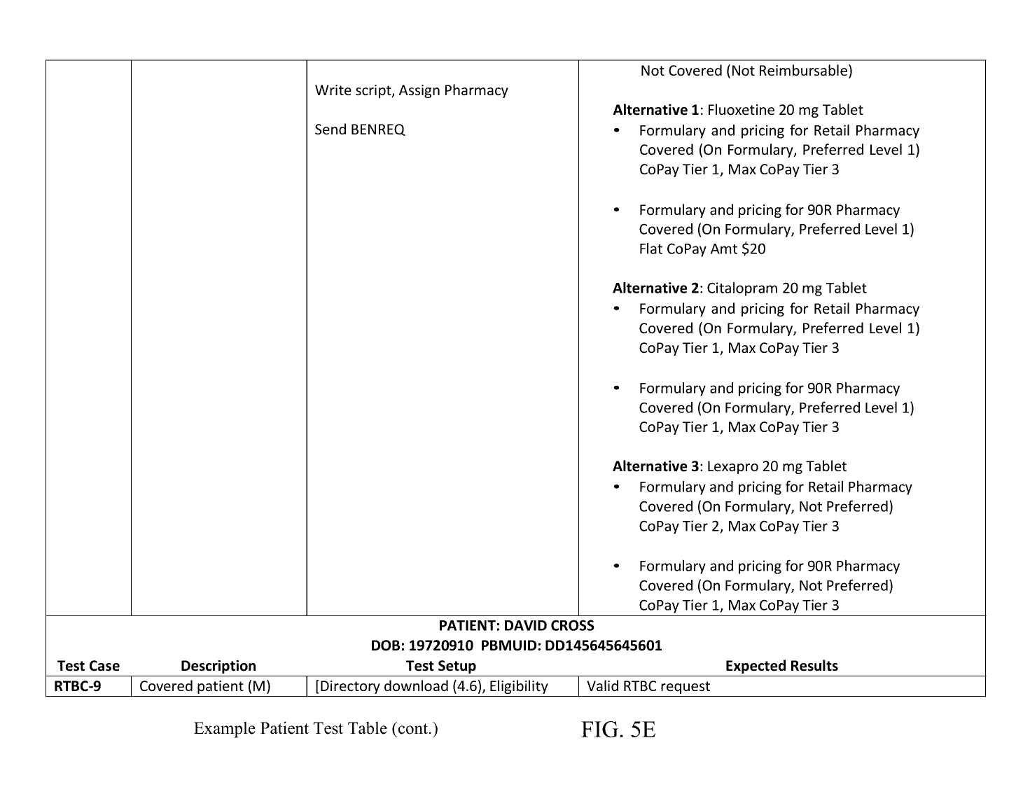

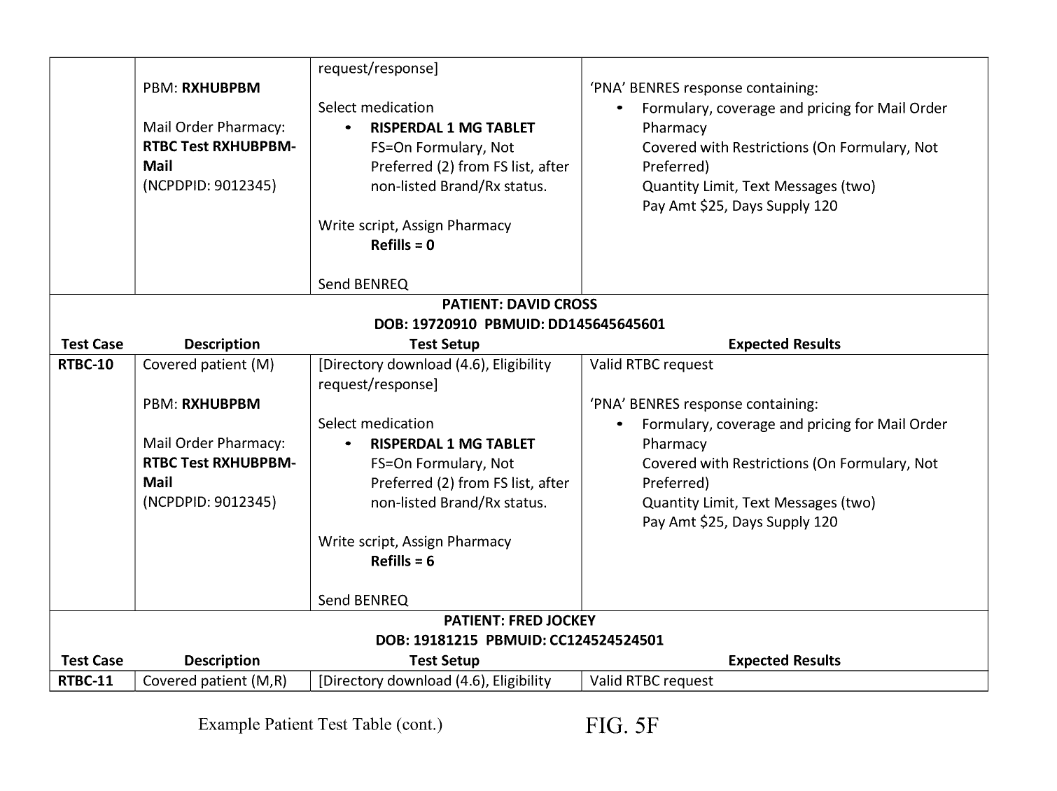

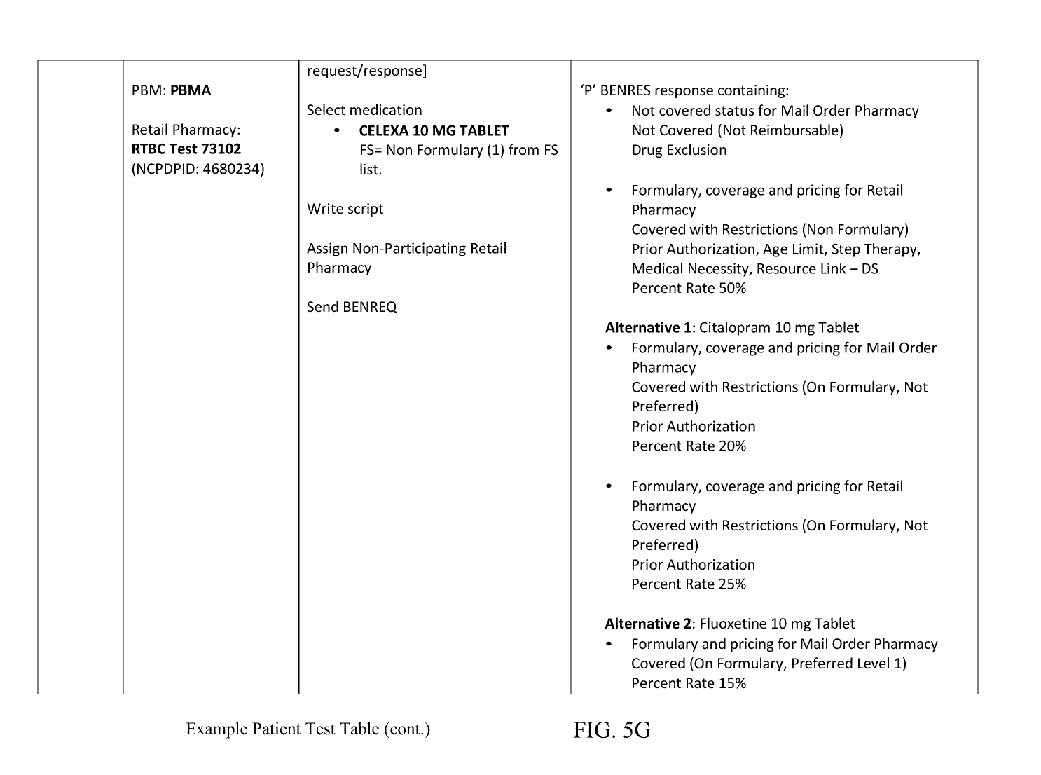

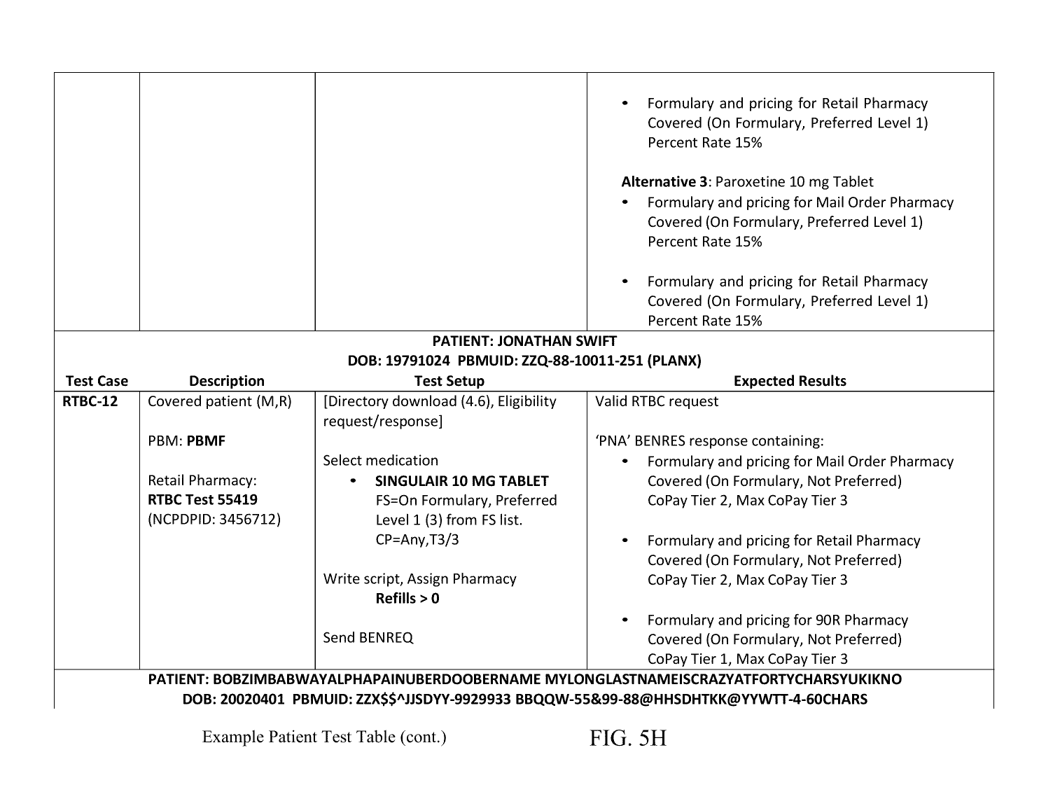

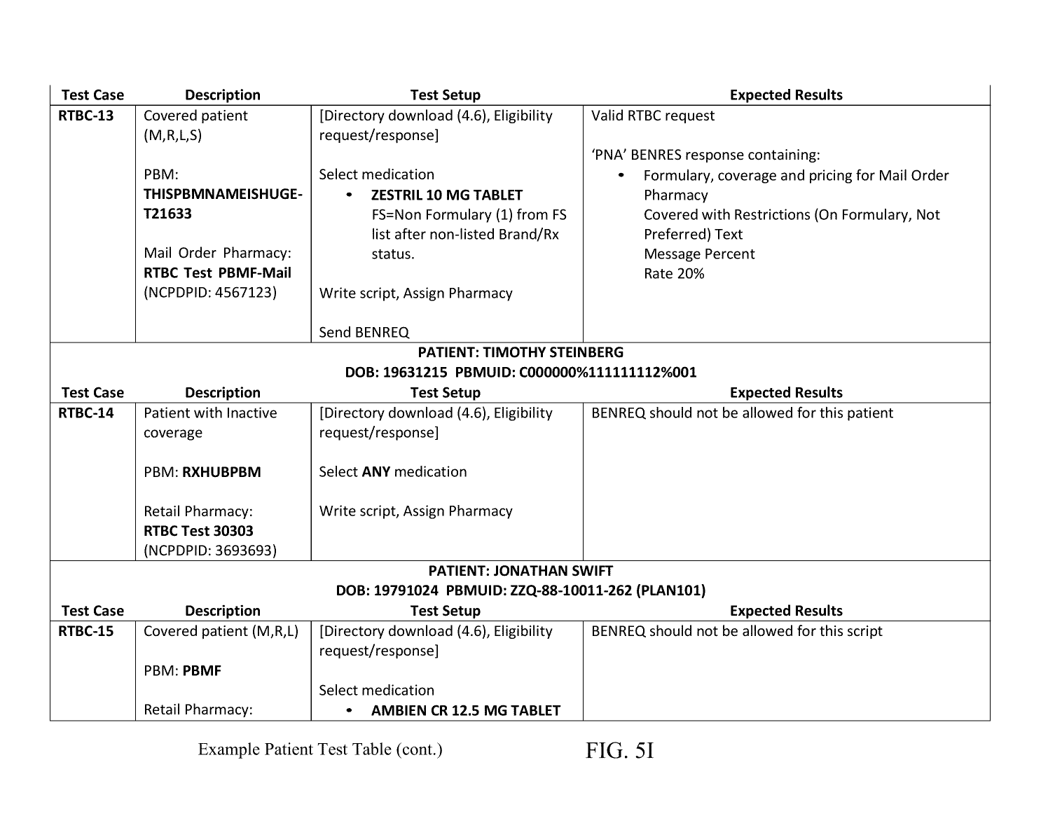

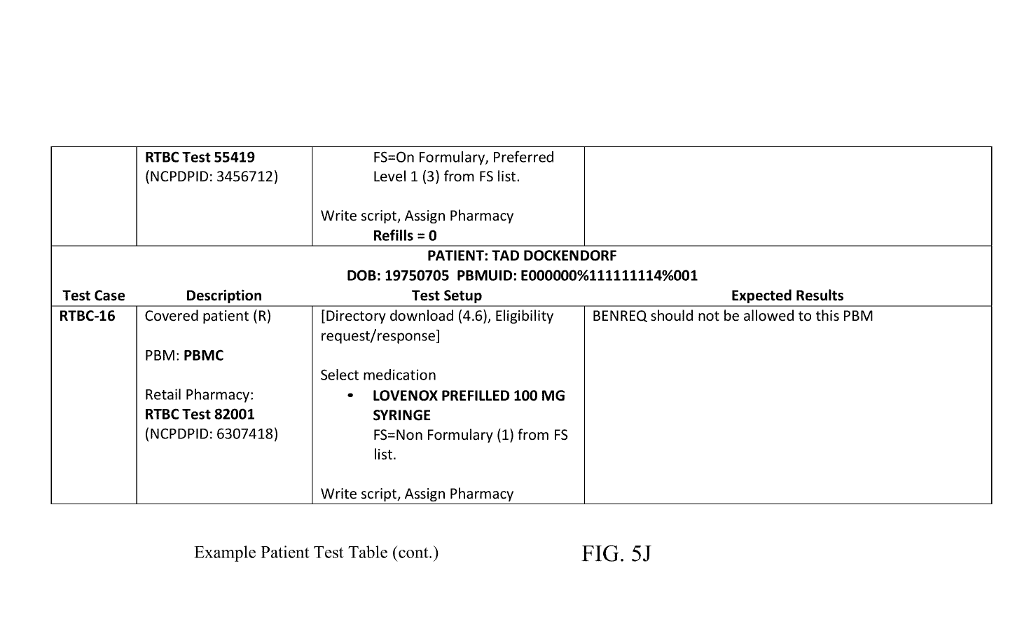

FIG. 4 shows a Patient Information Table, according to an example embodiment. FIGS. 5A-5J show Patient Test Tables, according to an example embodiment.

### Further Example Embodiments

A device, as defined herein, is a machine or manufacture as defined by 35 U.S.C. §101. Devices may be digital, analog or a combination thereof. Devices may include integrated circuits (ICs), one or more processors (e.g., central processing units (CPUs), microprocessors, digital signal processors (DSPs), etc.) and/or may be implemented with any semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

Techniques and embodiments, including methods, described herein may be implemented in hardware (digital and/or analog) or a combination of hardware and software and/or firmware. Techniques described herein may be implemented in one or more components. Embodiments may comprise computer program products comprising logic (e.g., in the form of program code or instructions as well as firmware) stored on any computer useable storage medium, which may be integrated in or separate from other components. Such program code, when executed in one or more processors, causes a device to operate as described herein. Devices in which embodiments may be implemented may include storage, such as storage drives, memory devices, and further types of computer-readable media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps and functions therein and/or further embodiments described herein.

Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The RTBC embodiments and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

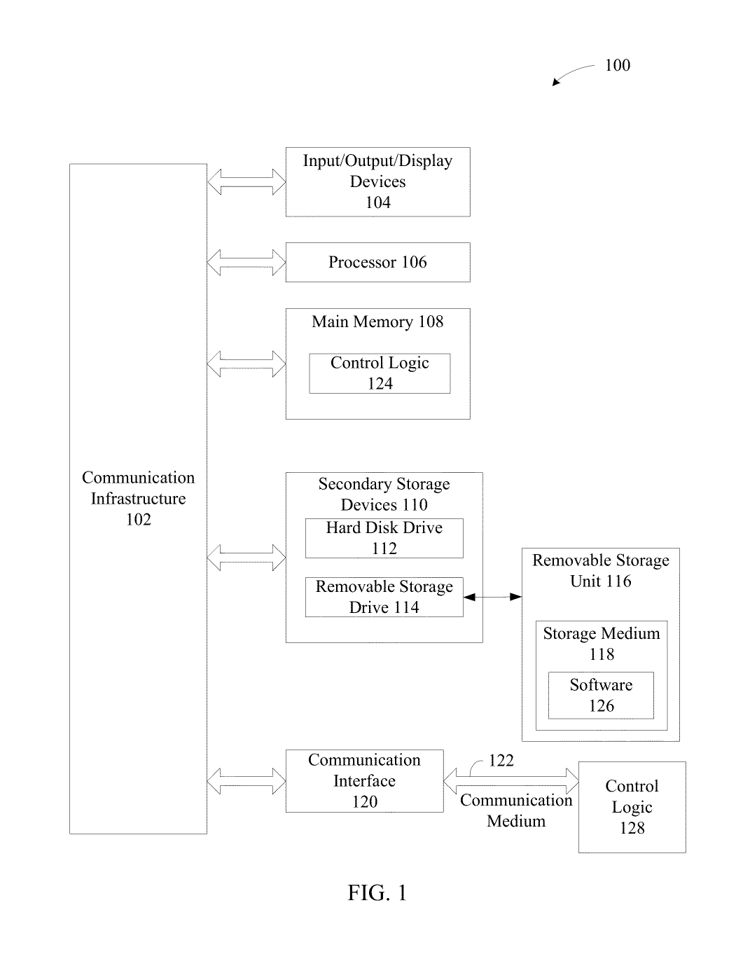

The embodiments described herein, including systems, methods/processes, devices and/or apparatuses, may be implemented using well known processing devices, telephones (smart phones and/or mobile phones), servers, and/or, computers (e.g., laptops, desktops, tablets, handhelds, etc.), such as a computer 100 shown in FIG. 1. It should be noted that computer 100 may represent communication devices, processing devices, servers, and/or traditional computers in one or more embodiments. For example, the RTBC embodiments, and any of the sub-systems or components respectively contained therein, may be implemented using one or more computers 100.

Computer 100 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 100 may be any type of computer, including a desktop computer, a server, etc.

Computer 100 includes one or more processors (also called central processing units, or CPUs), such as a processor 106. Processor 106 is connected to a communication infrastructure 102, such as a communication bus. In some embodiments, processor 106 can simultaneously operate multiple computing threads.

Computer 100 also includes a primary or main memory 108, such as random access memory (RAM). Main memory 108 has stored therein control logic 124 (computer software), and data.

Computer 100 also includes one or more secondary storage devices 110. Secondary storage devices 110 include, for example, a hard disk drive 112 and/or a removable storage device or drive 114, as well as other types of storage devices, such as memory cards and memory sticks. For instance, computer 100 may include an industry standard interface, such a universal serial bus (USB) interface for interfacing with devices such as a memory stick. Removable storage drive 114 represents a floppy disk drive, a magnetic tape drive, a compact disk drive, an optical storage device, tape backup, etc.

Removable storage drive 114 interacts with a removable storage unit 116.

Removable storage unit 116 includes a computer useable or readable storage medium 118 having stored therein computer software 126 (control logic) and/or data. Removable storage unit 116 represents a floppy disk, magnetic tape, compact disk, DVD, optical storage disk, or any other computer data storage device. Removable storage drive 114 reads from and/or writes to removable storage unit 116 in a well-known manner.

Computer 100 also includes input/output/display devices 104, such as touchscreens, LED and LCD displays, monitors, keyboards, pointing devices, etc.

Computer 100 further includes a communication or network interface 118. Communication interface 120 enables computer 100 to communicate with remote devices. For example, communication interface 120 allows computer 100 to communicate over communication networks or mediums 122 (representing a form of a computer useable or readable medium), such as LANs, WANs, the Internet, etc. Network interface 120 may interface with remote sites or networks via wired or wireless connections.

Control logic 128 may be transmitted to and from computer 100 via the communication medium 122.

Any apparatus or manufacture comprising a computer useable or readable medium having control logic (software) stored therein is referred to herein as a computer program product or program storage device. This includes, but is not limited to, computer 100, main memory 108, secondary storage devices 110, and removable storage unit 116. Such computer program products, having control logic stored therein that, when executed by one or more data processing devices, cause such data processing devices to operate as described herein, represent embodiments.

Embodiments may be implemented as systems of interconnected components and/or systems over one or more networks. Example implementations, according to embodiment, may be connected to a network via one or more network connections. Networks may be LANs, WANs, the Internet, etc.

The techniques and embodiments described herein may be implemented as, or in, various types of devices. For instance, embodiments may be included, without limitation, in processing devices (e.g., illustrated in FIG. 1) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. §101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 106 of FIG. 1), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method for performing a real time benefit check.

2. The method of claim 1, performed in accordance with one or more embodiments described herein.

3. A computer-readable storage medium having computer program instructions encoded thereon that, when executed by a processing device, perform a method for a real time benefit check.

4. The computer-readable storage medium of claim 3, wherein the method is performed in accordance with one or more embodiments described herein.

5. A system or device configured to perform a real time benefit check.

6. The system or device of claim 5, being configured to perform in accordance with one or more embodiments described herein.
